(19) United States
(12) Patent Application Publication
(10) Pub. No.: US 2002/0123365 A1
(43) Pub. Date: Sep. 5, 2002

(54) Scalable base station architecture

(76) Inventors: Walter R. Thorson, Calgary (CA); Roman N. Nemish, Calgary (CA); Steve Kos, Calgary (CA); Niall J. Sexton, Calgary (CA); David J. Westergaard, Calgary (CA); Alan P. Westfall, Calgary (CA); Marin Sampaleanu, Calgary (CA); Fred Volk, Calgary (CA); Trevor G. Zapach, Calgary (CA); Kent E. Fisher, Rowlett, TX (US)

Correspondence Address: SCHWEGMAN, LUNDBERG, WOESSNER & KLUTH, P.A., P.O. Box 2938, Minneapolis, MN, 55402, US

(21) Appl. No.: 09/752,096

(22) Filed: Dec. 31, 2000

(51) Int. Cl. H04B 7/00

(52) U.S. Cl. 455/524; 455/561

(57) ABSTRACT

A highly flexible base station architecture provides extremely flexible sectorization and capacity expansion capabilities. A base transceiver station (BTS) appliance can be interfaced with similar modules to form a higher capacity, sectorized configuration. Each BTS appliance can function as a standalone cell. In addition, multiple BTS appliances can be connected together to create a multi-sector base station in which the BTS appliances share baseband data, facilitating softer handoff. A backhaul interface module concentrates the backhaul and supports distribution and routing of packets from the network to co-located BTS appliances.

### FIELD OF THE INVENTION

The invention relates generally to wireless communications. More particularly, the invention relates to systems architectures for wireless communication networks.

### BACKGROUND

Cellular based wireless communication systems are well known in the art. In the operation and management of a cellular communication system, a large number of mobile terminals, typically being battery-powered, operate wirelessly throughout the system. Such systems typically include a number of mobile switching centers (MSCs) that provide high level management of a relatively large service area. In addition to providing management functions, each MSC also typically provides an interface between the wireless communication system and the public switched telephone network (PSTN). In most applications, a number of base system controllers (BSCs) are in communication with each MSC. The BSCs are also in communication with base transceiver stations (BTSs), each of which establishes a respective cell and facilitates wireless communications within the respective cell. Together, the BSC and associated BTSs form a base station subsystem (BSS).

A BSS has a base station controller (BSC) and several base transceiver subsystems (BTSs). The BSC locates mobile units to the cell with the highest signal strength and is responsible for call setup, call supervision, and call termination. A BTS provides radio frequency (RF) transmission and reception with any of a number of channel access mechanisms, such as frequency division multiple access (FDMA), time division multiple access (TDMA), or code division multiple access (CDMA). The BTS also provides voice and data transmission interfaces between itself and the BSC. A BTS usually consists of several receive and transmit antennas, an RF distributor, modulators and demodulators, and T1/E1 trunk line interfaces for voice and data traffic.

Wireless systems use a network of base stations and antennas to cover a large area. Viewed on a diagram, the small territory covered by each base station appears like a cell in a honeycomb. Cell sizes range from sixth tenths of a mile to thirty miles in radius for cellular (1 km to 50 km), smaller for GSM and PCS.

Each cell site's radio base station uses a transceiver with an antenna to provide coverage. Each base station uses carefully chosen frequencies to reduce interference with neighboring cells. Narrowly directed sites cover tunnels, subways and specific roadways. The area served depends on topography, population, and traffic. Some PCS and GSM systems use a base station hierarchy to provide coverage. In such systems, pico cells cover building interiors, microcells cover selected outdoor areas, and macrocells provide more extensive coverage to wider areas.

Conventional wireless networks are typically based on macro base stations, as they have a lower cost of implementation for low user density. Increased demand for wireless voice services, however, has led to exponentially increasing user density. Further, the evolution and adoption of the Internet has created a new generation of data users, creating even further demand for wireless access and ambiguous services.

With the evolution of the Internet and increased demand for wireless data services, bandwidth efficiency is becoming a significant design consideration. As bandwidth availability costs increase, cell splitting will become an increasingly economical solution for many service providers.

Moreover, to support higher data rate wireless applications, standards are implementing more complex modulation schemes that require a higher signal-to-noise (S/N) ratio for a given frame erasure rate (FER). For example, if for voice applications a 1% FER does not appreciably affect voice quality, for data applications, the FER must be at least ten times better—that is, 0.1% or less—thus further increasing the required S/N ratio and its availability to reduce the number of re-transmit trials. Maintaining such a high S/N ratio requires that the RF channel undergo very low loss and fading.

In order to support greater user density, it is highly desirable to reduce the cell size in a wireless network. Prior infrastructures have been primarily designed to support maximally configured systems. When only a small system is desired, however, some of the components of the infrastructure provide little value, but significantly increase cost. For cost-effectiveness, a wireless network should be scalable so as to support both minimally and maximally configured systems. Such a network should also have a flexible architecture that can support a wide range of applications without requiring a large hardware infrastructure to support scalability.

### SUMMARY OF THE INVENTION

These and other issues are addressed by the present invention. In various embodiments, a highly flexible base station architecture provides extremely flexible sectorization and capacity expansion capabilities. A base transceiver station (BTS) appliance, according to a particular embodiment of the present invention, is a hardware module that can be interfaced with similar modules to form a higher capacity, sectorized configuration. Each individual BTS appliance can function as a standalone cell. In addition, multiple BTS appliances can be connected together to create a multi-sector base station. In this type of configuration, the BTS appliances can share baseband data, facilitating softer handoff. A backhaul interface module concentrates the backhaul and supports distribution and routing of packets from the network to co-located BTS appliances. Optionally, adjunct RF power amplifiers can be added to enhance the RF coverage of the BTS appliances, allowing the system to scale from pico cell coverage to micro cell, macro cell, or boomer cell coverage.

The BTS appliance realizes low cost, flexible deployment, simple installation and operation, and high reliability for UMTS and CDMA applications. Low cost is realized by maintaining low transmit power and a single FRU design. Low transmission power is well suited for micro-cell high density voice and data applications where RF channel loss is lower in comparison with the macro-cell environment. Furthermore, the low transmission power allows the BTS appliance to be manufactured at a small size, and enhances efficiency and deployment flexibility in comparison with the macro base station. The network architecture supports a number of options that are required for UMTS and CDMA wireless networks and associated market needs.

In a particular embodiment of the present invention, a wireless communication system includes base station transceiver modules that are communicatively coupled to one another via a high speed serial link (HSSL). Each base station transceiver module can as a standalone single-sector base station transceiver. A backhaul interface module in communication with the base station transceiver modules distributes received data to the plurality of base station transceiver modules.

Another embodiment is directed to a method for conducting wireless communications. This method includes communicatively coupling base station transceiver modules to one another via a high speed serial link (HSSL). Each base station transceiver module can operate as a standalone single-sector base station transceiver. The base station transceiver modules are coupled to a backhaul interface module, which is used to distribute received data to the base station transceiver modules.

Still another embodiment is a base station transceiver module that includes a digital module that is configured to interface with a network. An analog module is operatively coupled to the digital module and is configured to perform RF signal processing. The base station transceiver module further includes a duplex arrangement, a power amplifier arrangement, and a power supply arrangement that is operatively coupled to the power amplifier.

In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 depicts an example BTS appliance according to a particular embodiment of the present invention.

FIG. 2 depicts another example BTS appliance according to another embodiment of the present invention.

FIG. 3 depicts an example arrangement in which two BTS appliances of FIG. 1 or FIG. 2 are connected to implement a UMTS two-sector or two-carrier configuration.

FIG. 4 depicts an example arrangement in which three BTS appliances of FIG. 1 or FIG. 2 are connected to implement a CDMA three-sector three-carrier mode of operation.

FIG. 5 depicts an example arrangement implementing a CDMA twelve-carrier configuration.

FIG. 6 illustrates data flow in a single BTS appliance operating in a UMTS configuration, according to an embodiment of the present invention.

FIG. 7 illustrates data flow in a single BTS appliance operating in a CDMA configuration, according to another embodiment of the present invention.

FIG. 8 illustrates an example BTS appliance modular architecture, according to another particular embodiment of the present invention.

FIG. 9 depicts an example BTS appliance block and level architecture, according to an embodiment of the present invention.

FIG. 10 depicts an example digital board block and level architecture.

FIG. 11 illustrates an example analog board block and level architecture.

FIG. 12 illustrates an example GPS module, according to an implementation of the present invention.

FIG. 13 illustrates an example GPS smart antenna, according to another implementation of the present invention.

FIG. 14 depicts an example power supply module for use with the BTS appliance, according to another embodiment of the present invention.

FIG. 15 illustrates example external interfaces of the BTS appliance unit.

FIG. 16 illustrates an example CDMA SIU hardware architecture.

FIG. 17 illustrates an example implementation of the SIU of FIG. 16.

FIG. 18 depicts an example implementation of the power supply module of FIG. 16.

FIG. 19 illustrates example external interfaces of the SIU.

FIG. 20 depicts data flow in a multi-sector UMTS BTS appliance without an SIU, according to an embodiment of the present invention.

FIG. 21 depicts data flow in a multi-sector CDMA BTS appliance with an SIU, according to an embodiment of the present invention.

FIG. 22 depicts an example connection scheme for connecting a PC to a network.

FIG. 23 illustrates an example platform-centric software architecture for use in a BTS appliance, according to an embodiment of the present invention.

FIG. 24 depicts another example software architecture for use in a BTS appliance.

FIG. 25 illustrates an example base platform architecture for use in a BTS appliance, according to another embodiment of the present invention.

FIG. 26 depicts an example platform OA&M architecture for use in a BTS appliance, according to another embodiment of the present invention.

FIG. 27 depicts an example download component architecture for use in a BTS appliance, according to another embodiment of the present invention.

FIG. 28 illustrates an example TIL communication architecture for interfacing between a TIL and a BTS appliance, according to another embodiment of the present invention.

FIG. 29 depicts an example test server, according to another embodiment of the present invention.

FIG. 30 depicts an example arrangement of TIL application layers.

FIG. 31 illustrates an example physical OA&M module.

FIG. 32 illustrates an example logical OA&M module.

FIG. 33 depicts an example Node-B protocol stack architecture.

FIG. 34 illustrates the topology of ATM switching elements in a particular embodiment of the present invention.

FIG. 35 illustrates the topology of ATM switching elements in another particular embodiment of the present invention.

FIG. 36 illustrates the topology of ATM switching elements in still another particular embodiment of the present invention.

FIG. 37 depicts a first protocol stack for transporting data over a backhaul network, according to an embodiment of the present invention.

FIG. 38 illustrates a second protocol stack for transporting data over a backhaul network, according to an embodiment of the present invention.

FIG. 39 depicts a third protocol stack for transporting data over a backhaul network, according to an embodiment of the present invention.

FIG. 40 illustrates the topology of BCN routing elements in a particular embodiment of the present invention.

FIG. 41 illustrates the topology of BCN routing elements in another embodiment of the present invention.

FIG. 42 illustrates the topology of BCN routing elements in still another embodiment of the present invention.

FIG. 43 illustrates the topology of IP routing elements in an embodiment of the present invention.

FIG. 44 illustrates the topology of IP routing elements in another embodiment of the present invention.

FIG. 45 illustrates the topology of IP routing elements in still another embodiment of the present invention.

FIG. 46 depicts a first IP protocol stack for transporting call processing data over a backhaul network, according to an embodiment of the present invention.

FIG. 47 illustrates a second IP protocol stack for transporting OA&M data over a backhaul network, according to an embodiment of the present invention.

FIG. 48 depicts a third IP protocol stack for transporting user plane traffic over a backhaul network, according to an embodiment of the present invention.

FIG. 49 depicts the topology of Ethernet switching elements in an embodiment of the present invention.

FIG. 50 depicts a first Ethernet protocol stack for transporting OA&M and call processing data over a backhaul network, according to an embodiment of the present invention.

FIG. 51 illustrates a second Ethernet protocol stack for transporting user plane traffic over a backhaul network, according to an embodiment of the present invention.

FIG. 52 depicts a standalone BTS appliance, as in FIG. 1, arranged in a UMTS one-sector, one-carrier configuration.

FIG. 53 illustrates a standalone BTS appliance, as in FIG. 2, arranged in a UMTS one-sector, one-carrier configuration.

FIG. 54 shows two BTS appliances, each as in FIG. 1, arranged in a UMTS two-sector, one-carrier configuration.

FIG. 55 shows two BTS appliances, each as in FIG. 1, arranged in a UMTS one-sector, two-carrier configuration.

FIG. 56 depicts two BTS appliances, each as in FIG. 1, arranged in a UMTS one-sector, two-carrier configuration without Tx diversity.

FIG. 57 illustrates a standalone BTS appliance, as in FIG. 1, arranged in a CDMA one-sector, three-carrier configuration.

FIG. 58 illustrates a standalone BTS appliance, as in FIG. 2, arranged in a CDMA one-sector, three-carrier configuration.

FIG. 59 shows two BTS appliances, as in FIG. 1, and an SIU arranged in a CDMA two-sector, three-carrier configuration.

FIG. 60 shows three BTS appliances, as in FIG. 1, and an SIU arranged in a CDMA three-sector, three-carrier configuration.

FIG. 61 shows a standalone BTS appliance, as in FIG. 1, arranged in a CDMA one-sector, three-carrier configuration.

FIG. 62 depicts two BTS appliances, as in FIG. 1, and an SIU arranged in a CDMA one-sector, six-carrier configuration.

FIG. 63 illustrates two BTS appliances, as in FIG. 1, and an SIU arranged in a CDMA one-sector, six-carrier configuration without Tx diversity.

FIG. 64 shows three BTS appliances, as in FIG. 1, and an SIU arranged in a CDMA one-sector, nine-carrier configuration.

FIG. 65 depicts three BTS appliances, as in FIG. 1, and an SIU arranged in a CDMA one-sector, nine-carrier configuration without Tx diversity.

FIG. 66 illustrates four BTS appliances, as in FIG. 1, and an SIU arranged in a CDMA one-sector, twelve-carrier configuration.

FIG. 67 illustrates four BTS appliances, as in FIG. 1, and an SIU arranged in a CDMA one-sector, twelve-carrier configuration without Tx diversity.

FIG. 68 shows four BTS appliances, as in FIG. 2, and an SIU arranged in a CDMA one-sector, twelve-carrier configuration.

FIG. 69 shows six BTS appliances, as in FIG. 1, and two SIUs arranged in a CDMA three-sector, six-carrier configuration without Tx diversity.

FIG. 70 shows six BTS appliances, as in FIG. 1, and two SIUs arranged in a CDMA three-sector, six-carrier configuration.

### DETAILED DESCRIPTION

To address the above-described issues and offer other advantages, a highly flexible base station architecture provides extremely flexible sectorization and capacity expansion capabilities. A base transceiver station (BTS) appliance, according to a particular embodiment of the present invention, is a hardware module that can be interfaced with similar modules via conventional cables, such as copper and twin-axial cables, to form a higher capacity, sectorized configuration. Each BTS appliance contains its own AC/DC power supply, a single sector three-carrier RF transceiver chain, and a digital processing module that includes channel element modems, a control processor, memory, and backhaul network interfaces.

Each individual appliance can function as a standalone pico cell covering, for example, a single building's interior. In addition, multiple BTS appliances can be connected together to create a multi-sector base station. In this type of configuration, a high speed serial link between the boxes enables sharing of baseband data such that channel elements in any individual module can access its own RF transceiver chain, as well as the RF transceiver chain of any module to which it is connected. Softer handoff is thereby facilitated. A backhaul interface module concentrates the backhaul and supports distribution and routing of packets from the network to co-located BTS appliances. Optionally, adjunct RF power amplifiers can be added to enhance the RF coverage of the BTS appliances, allowing the system to scale from pico cell coverage to micro cell, macro cell, or boomer cell coverage.

The BTS appliance realizes low cost, flexible deployment, simple installation and operation, and high reliability for UMTS and CDMA applications. Low cost is realized by maintaining low transmit power and a single FRU design. Low transmission power is well suited for micro-cell high density voice and data applications where RF channel loss is lower in comparison with the macro-cell environment. Furthermore, the low transmission power allows the BTS appliance to be manufactured at a small size, and enhances efficiency and deployment flexibility in comparison with the macro base station. The network architecture supports a number of options that are required for UMTS and CDMA wireless networks and associated market needs.

### UMTS and CDMA Single BTS Appliance

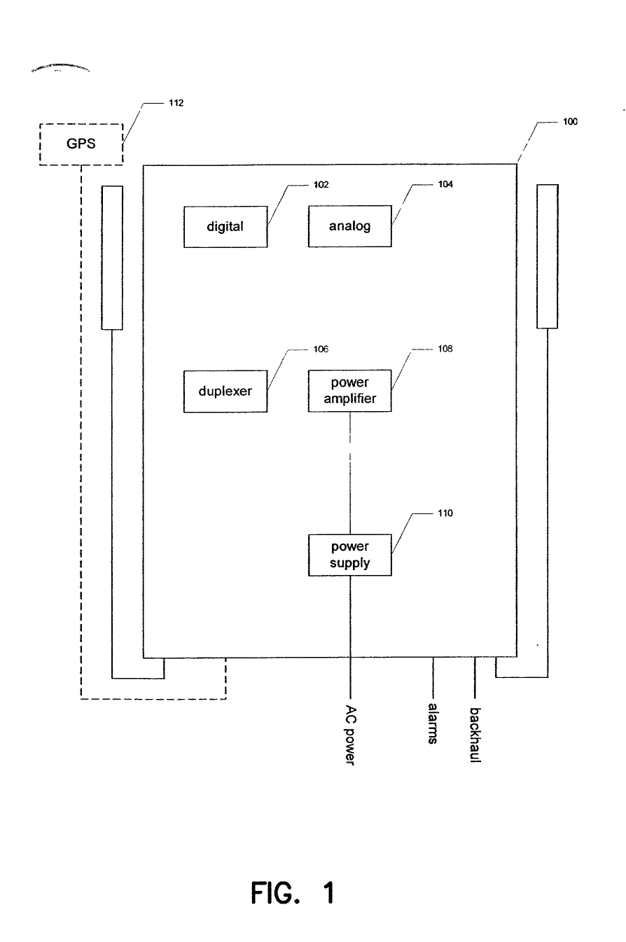

Referring now to the drawings, FIG. 1 depicts an example BTS appliance 100 according to a particular embodiment of the present invention. The BTS appliance 100 implements a single FRU design that includes a digital module 102, an analog module 104, a duplexer 106, a power amplifier 108, and a power supply module 110. For certain applications, an optional GPS module 112 is also included. The GPS module, however, is not required for UMTS applications.

The digital module 102 is air-interface specific and performs network interface, system time synchronization, and channel processing functions. The analog module 104 is both frequency- and air-interface specific, and performs frequency synthesis, receive and transmit signal channelizing, baseband signal processing, and IF and RF signal processing. The duplexer 106 and the power amplifier 108 are frequency specific only.

According to a particular embodiment of the present invention, the BTS appliance architecture supports a variety of standards. For example, the digital board 102, via the modem-dependent digital board, supports the UMTS, 1xRTT and 1xEV standards. In an alternative embodiment, an analog board variant is used and is UMTS, CDMA, 1xRTT, and 1xEV dependent. As another alternative, a common digital board for CDMA, 1xRTT, and 1xEV can be used.

The BTS appliance analog board 104 supports UMTS, 1xRTT, and 1xEV standards with only minimal change between UMTS and CDMA, and no change between CDMA, 1xRTT, and 1xEV when designed for the same frequency band. Analog board variants are UMTS, CDMA, and frequency dependent.

The BTS appliance power amplifier module 108 supports one UMTS carrier or three CDMA, 1xRTT, or three 1xEV carriers. Power amplifier module variants are frequency and power level dependent.

The BTS appliance duplexer module 106 supports UMTS, CDMA, 1xRTT, or 1xEV air interface standards. Duplexer module variants are frequency band and power level dependent.

The BTS appliance power supply module 110 is common for UMTS and CDMA applications. The power supply module is CDMA RF power level dependent.

The BTS appliance architecture supports one-sector, one-UMTS carrier for UMTS applications and one-sector, three-1xRTT carriers for CDMA applications. On the network level, the architecture supports two E1/T1 physical interfaces and ATM and BCN network interfaces for UMTS and CDMA networks, respectively. The BTS appliance 100 also provides 100BaseT physical interface future support for Internet Protocol (IP) networks.

The BTS appliance power supply 110 is designed for use with a wide range of AC input power levels. In a particular embodiment, an uninterrupted power supply (UPS) is used as a backup power supply. Additionally, an optional local short-term battery backup can also be used as a cost-efficient, easily deployed, and easily maintained backup power supply.

The BTS appliance 100 supports a standard GPS antenna interface and a Smart GPS Antenna interface for CDMA and UMTS applications, respectively. In addition, for UMTS applications, the system time is derived from an E1/T1 clock. As depicted in FIG. 1, the BTS appliance 100 also provides an interface for two configurable external alarms and a Craft I/F port and High Speed Serial Link (HSSL) for multi-sector and multi-carrier deployment configurations. The BTS appliance and system interface unit (SIU) incorporate two configurable external alarms (open/closed input) and one controlled alarm (output). The BTS appliance and SIU incorporate a 10/100 BaseT Craft I/F port for factory and field configuration, diagnostics, and maintenance procedures. This interface preferably incorporates primary protection. The HSSL interface is used for interfacing with another BTS appliance for UMTS operation or with an SIU for CDMA operation. The SIU incorporates four HSSL interfaces for interface with BTS appliance units or with another SIU for CDMA operation.

The BTS appliance 100 supports system time synchronization of the optional GPS module 112, GPS Smart Antenna, T1/E1 clock recovery, and HSSL clock recovery. For UMTS applications, the BTS appliance 100 also supports an asynchronous mode of operation. The optional GPS module 112 and GPS Smart Antenna are preferably selected to support standard interfaces such as 1 PPS, 10 MHz, and RS-422.

The optional GPS module 112 incorporates a minimum eight hour holdover time to maintain system time reference within 10 microseconds of GPS time in case of GPS antenna failure or GPS signal failure at the GPS receiver.

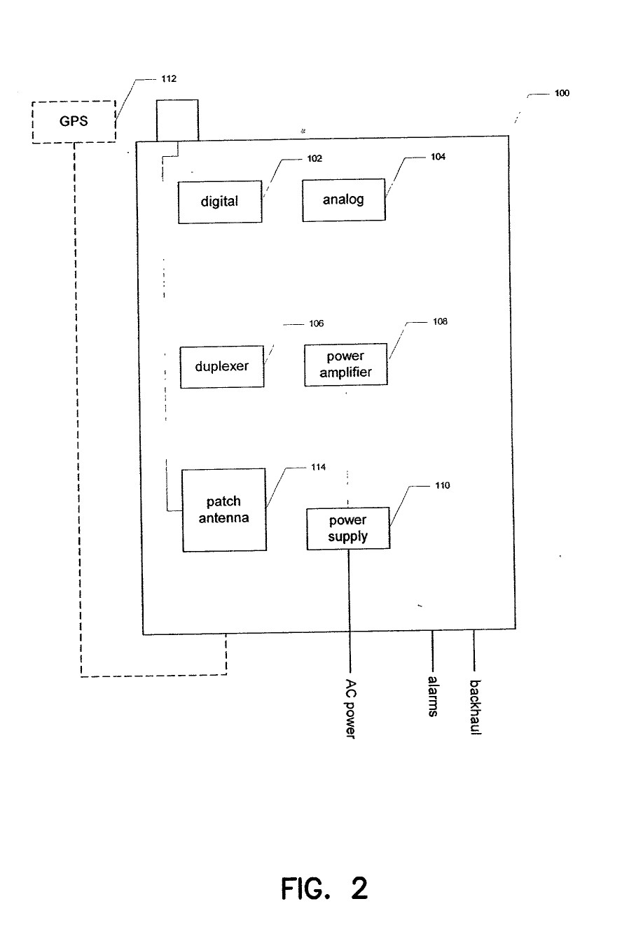

For inbuilding and high density applications such as downtown core applications, a low cost cross-polarized patch antenna 114 of FIG. 2 is optionally integrated within the BTS appliance 100. This patch antenna 114 allows further flexibility of deployment, reducing the cost of the BTS appliance, as well as the cost of deployment. The cross-polarized patch antenna 114, however, does not provide the same diversity performance as spatial diversity antennas for general RF environments. For inbuilding and high density applications in which the delay spread is expected to be on the order of 0.1 microseconds, however, the polarized patch antenna 114 performs well and provides sufficient diversity reception. In such applications, the GPS antenna 112 may have to be positioned away from the base stations, and a Smart GPS Antenna is used for ease of deployment.

### Compliance Standards

The BTS appliance unit meets minimum base station performance requirements as specified in XXXX for UMTS operation and IS-97D for CDMA IS-95 and 1xRTT multi-carrier operation.

### CDMA Radio Configuration

The BTS appliance unit supports IS-95 and 1xRTT radio configurations that are given in Table 1 on the Forward Link and in Table 2 on the Reverse Link.

TABLE 1
CDMA Forward Link Radio Configuration

| Radio Configuration | Standard | Radio Configuration Description |
|---|---|---|
| RC1 | IS-95 | Based on Rate Set 1, 9.6 kbps |
| RC2 | IS-95 | Based on Rate Set 2, 14.4 kbps |
| RC3 | 1 × RTT | 9.6 kbps base rate, ¼ coding rate |
| RC4 | 1 × RTT | 9.6 kbps base rate, ½ coding rate |
| RC5 | 1 × RTT | 14.4 kbps base rate, ¼ coding rate |

TABLE 2
CDMA Reverse Link Radio Configuration

| Radio Configuration | Standard | Radio Configuration Description |
|---|---|---|
| RC1 | IS-95 | Based on Rate Set 1, 9.6 kbps |
| RC2 | IS-95 | Based on Rate Set 2, 14.4 kbps |
| RC3 | 1 × RTT | 9.6 kbps base rate |
| RC4 | 1 × RTT | 14.4 kbps base rate |

### Frequency Bands

The BTS appliance analog board 104, duplexer 106, and power amplifier 108 support Band Classes 0, 1, 3, 6, and 7. Each band involves a separate design analog board 104, duplexer 106, and power amplifier 108 that are frequency specific. A list of frequency bands is given in Table 3.

TABLE 3
Frequency Band Class

| Band Class | Band Description | Rx Frequency | Tx Frequency |
|---|---|---|---|
| 0 | NA Cellular Band | 824.0 to 849.0 | 869.0 to 894.0 |
| 1 | NA PCS Band | 1850.0 to 1910.0 | 1930.0 to 1990.0 |
| 2 | TACS Band | 872.0 to 915.0 | 917.0 to 960.0 |
| 3 | JTACS Band | 887.0 to 925.0 | 832.0 to 870.0 |
| 4 | Korean PCS Band | 1750.0 to 1780.0 | 1840.0 to 1870.0 |
| 5 | NMT-450 Band | Too confusing | Too confusing |
| 6 | IMT-2000 Band | 1920.0 to 1980.0 | 2110.0 to 2170.0 |
| 7 | NA 700 MHz | 776.0 to 794.0 | 746.0 to 764.0 |
| | Cellular Band | | |

### Channel Resources

The UMTS digital board architecture supports 64 UMTS channel resources based on two DSP-ASIC pairs with a PowerQUICC-II microprocessor. The CDMA digital board architecture supports 192 1xRTT channel resources based on three DSP-ASIC pairs with the PowerQUICC-II microprocessor. For the CDMA mode of operation, each NCM DSP-ASIC pair is assigned for one particular RF carrier. In the case of one NCM DPS-ASIC failure, other NCM channel elements are shared among all RF carriers, thus providing soft-fail redundancy.

The BTS appliance maximum number of users supported per carrier-sector is not a direct function of channel element resources, but rather a function of microprocessor and system loading, RF resources, RF link budget, and network parameters, as well as other factors. It is expected that CDMA system pole capacity will never approach channel element count within CDMA BTS appliance for most mobile system conditions and channel element count is a function of marketing drive.

Rx and Tx Diversity

The BTS appliance architecture supports receive diversity and preferably supports optional transmit diversity. For 1xRTT, CDMA, OTD, and STS are supported modes of transmit diversity. For UMTS, closed loop mode one, closed loop mode two, TSTD, and STTD transmit diversity modes are supported in one embodiment.

### Transmit Power

The BTS appliance architecture supports four options of total transmit RF power per sector:

5 W per sector without transmit diversity;

xx W per sector without transmit diversity;

5 W per sector with transmit diversity; and

yy W per sector with transmit diversity.

For the CDMA mode of operation, the total transmit RF power per sector can be assigned evenly or unevenly among CDMA three-1xRTT carriers. However, the total transmit RF power should not exceed the maximum level of the power amplifier. In addition, the maximum assigned power delta between any two 1xRTT carriers supported by the same BTS appliance should not exceed 6 dB. Furthermore, the minimum RF power is expected to be 15 dB below its maximum level.

The maximum required transmit RF power per 1xRTT carrier is to be derived and based on a link budget and capacity analysis. The BTS appliance unit addresses a high-density micro-cellular market where RF channel and fade margin have significantly lower loss in comparison with a low density macro-cellular market. PLM is required to supply design with the user density that is expected to be served with the BTS appliance unit.

### Rx and Tx Co-Existence Filtering

The BTS appliance architecture supports standard IS-2000, UMTS, and FCC requirements applicable for bands of operation. Additional filtering of the transmit signal or selectivity of the receive signal is preferably supported with a separate design duplexer that is a part of the BTS appliance. In case filtering requirements are so stringent that BTS appliance physical design cannot accommodate the duplexer within it, the BTS appliance physical design would be increased.

No external filtering is preferably supported as a part of BTS appliance architecture due to design implementation, cost, physical design constraint and flexibility.

### Antenna Interface and Rx Signal Sharing

The BTS appliance supports two duplexed RF receive-transmit interface ports. In addition, the BTS appliance provides optional two RF In/Out receive ports for receive signal sharing with another BTS appliance unit of the same sector.

In the standard mode of operation, the BTS appliance initializes and configures itself for two antennae per unit without receiver signal sharing. Receive signal sharing involves manual setup where the installer configures each BTS appliance receiver port depending on receive signal flow. Preferably, all RF interfaces incorporate N-type connectors. However, DIN connectors are preferably also supported.

### Backhaul Interface

The BTS appliance design supports two T1/E1 physical interfaces with drop-and-insert for the network interface. In addition, the BTS appliance supports one 100BaseT physical interface for future IP network interface. The SIU supports up to six T1/E1physical interfaces with drop-and-insert for the network interface. The SIU also supports one 100BaseT physical interface for future IP network interface.

When T1/E1 are used for backhaul interface, T1/E1 configuration might have to be performed manually at the site. Furthermore, T1/E1 verification might also have to be performed manually with the external standard equipment.

Heat Exchange

The BTS appliance preferably supports natural free convection cooling for 5 W Tx RF power level over temperature ranges specified in Operating Environment. In order to support natural free convection cooling, BTS appliance installation should follow a set of requirements described in this document. A BTS appliance unit that exceeds xW Tx RF power level will implement forced air cooling.

### Physical Design

The BTS appliance consists of environmentally sealed modules. Each module has integrated thermal and humidity management features. The modules are mounted in a wall bracket that provides structural support and site grounding. A cosmetic shield will cover the wall bracket and modules, providing solar shielding and vandal resistance.

### Operating & Storage Environment

The BTS appliance and SIU meet operation temperatures from −40 C° to +52 C° and 5% to 100% relative humidity at up to 1800 m in altitude. In addition, the BTS appliance and SIU meet storage temperatures of 40 C° to +70 C° and any humidity.

### Cold Start-Up

Preferably, the BTS appliance meets all relevant specifications with cold start-up, from −30 C° to −40 C°, on power-up within 10 minutes.

### GPS Time Acquisition

The BTS appliance system software preferably supports all installation and commission procedures, including test calls to a mobile unit, on receiving a valid 1 PPS and/or 10 MHz reference signals from the GPS receiver or GPS Smart Antenna.

### BTS Appliance and SIU Software Functionality

### OMC-B and BSM Support

BTS appliance Operations, Administration, and Management (OA&M) are supported in existing UMTS and CDMA networks with current OMC-B and OMC-R and BSM, respectively. For green-field applications, BTS appliance OA&M preferably implements more user-friendly features.

### Carrier and Sector Increase

Increasing or decreasing the number of RF carriers within a BTS appliance is preferably supported without any service interruption, drop of active calls or calls in progress. As an example, enabling second and third RF carriers should be performed without losing active calls or calls in progress on the first carrier. Increasing or decreasing the number of sectors supported by the BTS appliance digital board is preferably supported without any service interruption, drop of active calls or calls in progress. As an example, a failure of BTS appliance analog module in one sector should isolated to this particular sector only, and not cause any failures in other two sectors.

### SOC Functionality

The BTS appliance supports a number of software configurable options, including but not limited to:

Number of channel elements per RF carrier-sector

Number of RF carriers per sector

Percentage of RF power allocated per carrier

Transmit diversity

Transmit power de-rating as a function of temperature

Receive signal sharing between two BTS appliance units

Receive noise figure versus linearity trade-off

IS-95 and 1xRTT mode of operation with CDMA NCM

System time synchronization from GPS module or T1/E1

### Number of Sectors and RF Carriers

The BTS appliance architecture supports one-sector, one UMTS carrier and one-sector, three-1xRTT carrier modes of operation.

Two BTS appliance units can interface via HSSL in order to support UMTS two-sector (without softer hand-off) or two-carrier modes of operation.

Three BTS appliance units can interface with a System Interface Unit (SIU) to support a CDMA three-sector, three-1xRTT carrier mode of operation. Softer hand-off is supported for the CDMA three-sector mode of operation. No channel element pooling is supported across carriers within the same BTS appliance unit.

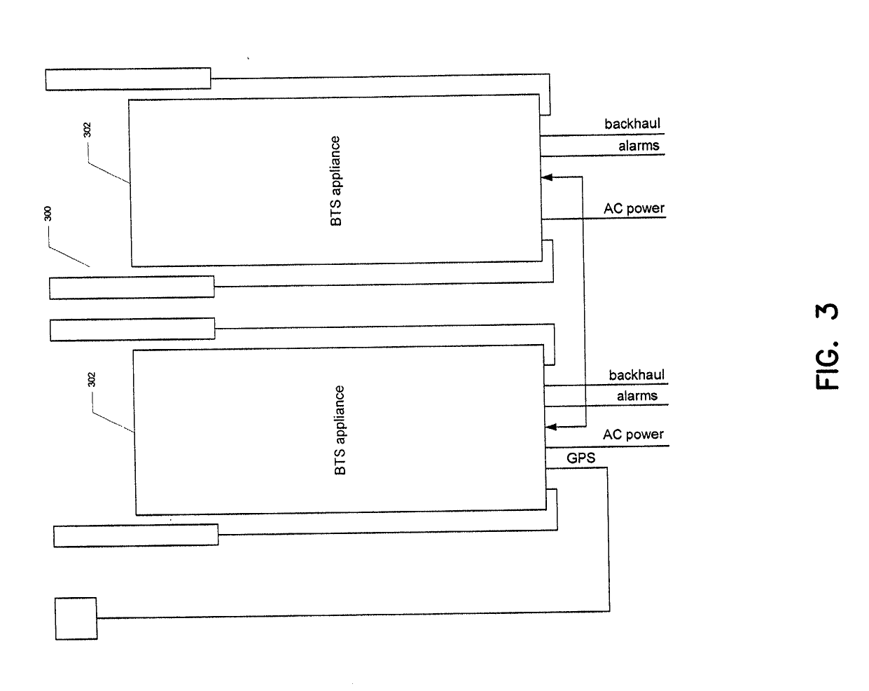

Four BTS appliance units could be interfaced with an SIU to support a CDMA one-sector, twelve-1xRTT carrier mode of operation. No channel element pooling is supported across BTS appliance units for this mode of operation. These configurations are discussed in further detail in connection with FIGS. 3-5.

Further, the BTS appliance architecture supports a CDMA three-sector, six-1xRTT carrier mode of operation. This configuration requires six BTS appliance units and a six-HSSL SIU design where backhaul bandwidth is pooled across all BTS appliance units. Alternatively, two SIUs can be interfaced via HSSL to support the CDMA three-sector, six-1xRTT carrier mode of operation.

Similar to the previous case, the BTS appliance architecture also allows future support of a CDMA six-sector, three-1xRTT carrier mode of operation. This configuration would require six BTS appliance units and the six-HSSL SIU design where backhaul bandwidth is pooled across all BTS appliance units. Alternatively, two SIUs can be interfaced via HSSL to support the CDMA six-sector, three-1xRTT carrier mode of operation.

### UMTS Two-Sector or Two-Carrier Configuration

In addition to standalone functionality, the BTS appliance 100 can interface with another BTS appliance to support a UMTS two-sector or two-carrier mode of operation. This mode of operation is UMTS-specific and is supported without a System Interface Unit (SIU) needed for backhaul pooling, baseband data routing, system time synchronization, and some paging and call processing functionality. Clearly, the benefit of this configuration is operation without the SIU that adds cost and some installation complexity. The drawbacks for this configuration are unavailability of softer hand-off between two sectors, increased CPU size within BTS appliances for call processing and paging functionality, and master-slave software complexity. FIG. 3 depicts an example arrangement 300 in which two BTS appliances 302 are connected to implement a UMTS two-sector or two-carrier configuration. Each BTS appliance can be implemented as depicted in FIG. 1 or FIG. 2.

As in the standalone BTS appliance configuration of FIGS. 1 and 2, each BTS appliance 302 is AC powered and provides two E1/T1 physical interfaces and one 100 BaseT interface for backhaul and two configurable external alarms. In addition, the HSSL interface is used between the two BTS appliance units 302 for OA&M management and control from the OMC-B and system time synchronization when a GPS Smart Antenna is used for system time reference. For most configurations, both BTS appliance units 302 are closely collocated, for example, within 5-10 meters, and an HSSL physical link can be implemented with controlled impedance media. If the BTS appliance units 302 are separated by more than 10 meters, an optical interface is used between the two units.

### CDMA Three Sector Configuration

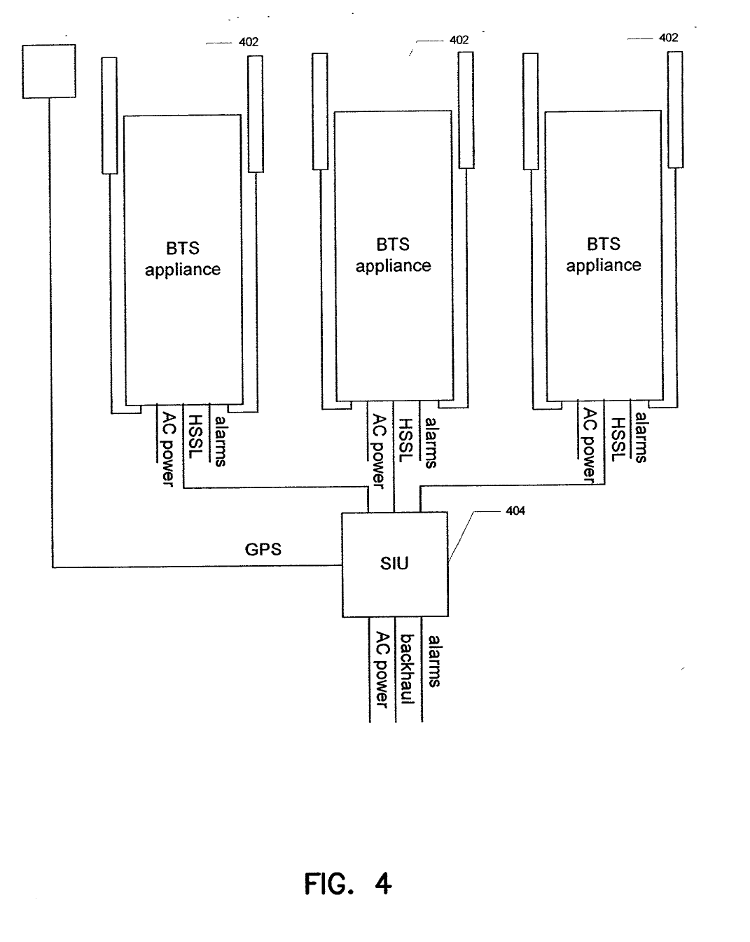

In another embodiment depicted in FIG. 4, three BTS appliances 402 interface with a System Interface Unit (SIU) 404 to support a CDMA three-sector three-carrier mode of operation. This mode of operation is CDMA-specific and is supported with the SIU 404, which is used for backhaul pooling, baseband data routing, system time synchronization with the GPS, and some paging and call processing functionality. Baseband data routing, implemented within the SIU 404, supports softer hand-off for multi-sector operation. This functionality is essential for CDMA applications as it provides significant gain, i.e., system capacity increase, and increased backhaul efficiency in sectorized configurations.

As in the standalone BTS appliance configuration of FIGS. 1 and 2, each BTS appliance 402 is AC powered and provides two configurable external alarms. However, the backhaul interface and GPS interface are not terminated at the BTS appliance but rather at the SIU 404. Each BTS appliance 402 is interfaced with the SIU 404 via the HSSL interface, which is used for packet routing, baseband data routing, OA&M management, some call processing functionality, system time synchronization and control information. The SIU 404 supports four HSSL interfaces for interface with up to four BTS appliance units 402 or three BTS appliance units 402 and another SIU 404 for increased capacity.

On the network level, the SIU 404 supports six to eight E1/T1 physical interfaces and BCN network interfaces for CDMA network and also provides a 100BaseT physical interface for support of IP networks. In another particular embodiment, the SIU 404 is configured to support other physical interfaces, such as T3 and OC-3 interfaces.

Similar to the BTS appliance architecture, the SIU 404 is designed for use with a wide range of AC input power levels. An uninterrupted power supply (UPS) or local short-term battery backup can optionally be used as a backup power supply. Also like the BTS appliance architecture, the SIU 404 supports a standard GPS antenna interface and a Smart GPS Antenna interface for CDMA applications. It also provides an interface for two to four configurable external alarms and a Craft I/F port.

Similar to the UMTS two-sector case, for applications where the BTS appliance units 402 and the SIU 404 will be closely collocated, for example, within 5-10 meters, the HSSL physical link can be implemented with controlled impedance media. If the BTS appliance units 402 and the SIU 404 are separated by more than 10 meters, however, an optical interface is used between the two units.

Similar to a standalone BTS appliance this particular configuration can be supported with the integrated cross-polarized antenna to reduce the cost of BTS appliance and deployment cost, and to reduce installation complexity. Typical deployment scenarios include, for example, street corners and intersections, railway stations, stadiums, and building floors.

### CDMA Twelve-Carrier Configuration

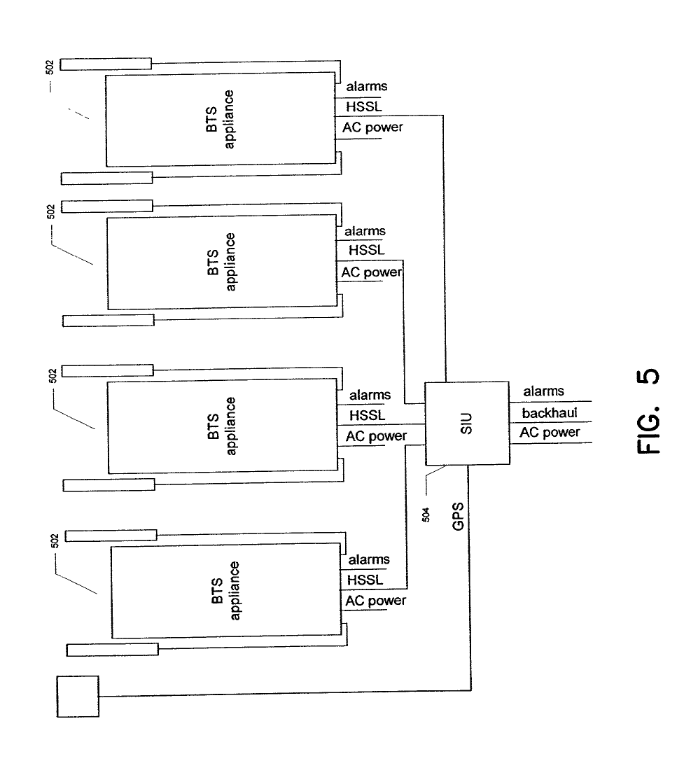

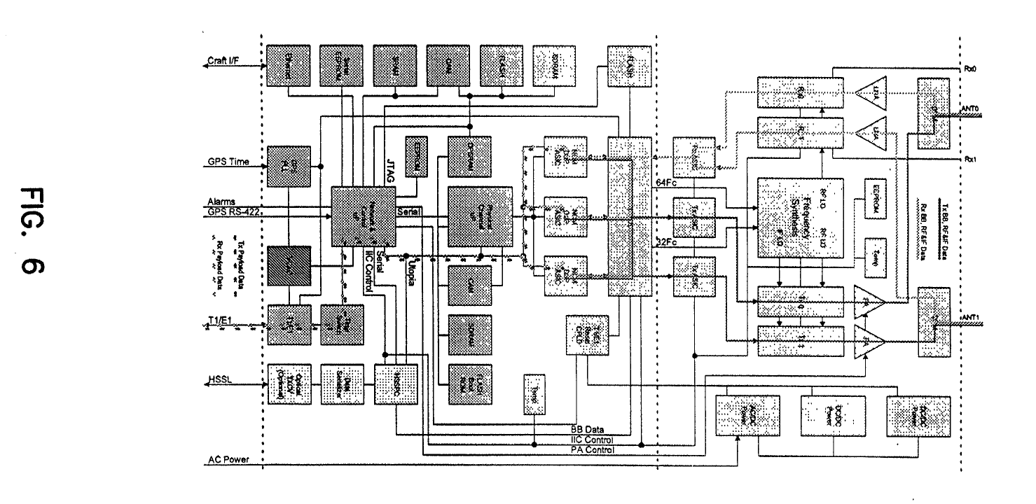

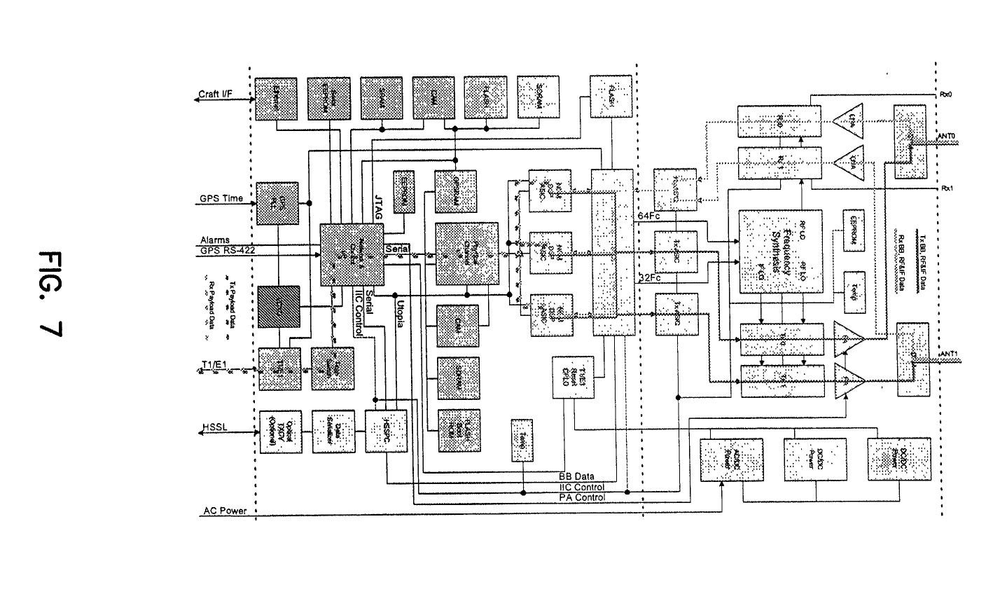

In another embodiment depicted in FIG. 5, BTS appliances 502, each implemented using the arrangement of FIG. 1 or FIG. 2, interface with an SIU 504 to support CDMA one-sector, twelve-carrier mode of operation. Similar to the CDMA three-sector mode of operation, this configuration is supported with a System Interface Unit (SIU) 504 that is used for backhaul pooling, system time synchronization with the GPS, and some paging and call processing functionality. No baseband data routing is required to support softer hand-off for multi-sector operation.

As in the other configurations, each BTS appliance 502 is AC powered and provides two configurable external alarms. The BTS appliances 502 interface with the SIU 504 via an HSSL interface that is used for packet routing, OA&M management and control, some call processing functionality, and system time synchronization. The SIU 504 supports four HSSL interfaces for interface with up to four BTS appliance units 502 for this particular application. The SIU 504 supports the same interfaces as in the CDMA three-sector, three-carrier mode of operation.

As previously discussed for the CDMA three-sector three-carrier configuration, this configuration can also be supported with an integrated cross-polarized antenna (i.e., using the BTS appliance arrangement of FIG. 2) to reduce the cost of BTS appliance and deployment cost and to reduce installation complexity. Typical deployment scenarios include, for example, street corners and intersections, railway stations, stadiums, and building interiors.

### BTS Appliance Software Architecture

The BTS appliance software functionality is divided into the following domains:

Platform

At a high level, the Platform domain is the functionality required by the BTS appliance/SIU software itself to perform the functionality in the other two domains.

OA&M

The Operations, Administration, and Maintenance software allows control and monitoring by the craftsperson of the software, equipment, and configuration information that supports call processing.

Call Processing

The application that generates revenue for the customer—software that is directly involved in setting up, maintaining, and tearing down individual cellular calls between the BTS and the mobile station.

These aspects of the BTS appliance software are described more fully below.

### Platform

This domain gathers all services required/used by applications to run (OA&M and Call Processing).

### Base Operating System

One service provided by the platform is a Base Operating System. The Base Operating System provides the usual Real-Time Operating System (RTOS) services plus other proprietary services. All of these services are abstracted so that the RTOS is not accessed directly by any other software. These services include, for example, multitasking task scheduling, callback timers, watchdog, semaphores, mailboxes, events, delays, memory management, queues, a state machine, hardware interruption management, logical interruption, exception and error handling, and TTY management.

### Board Management

Another service provided by the platform is board management. This function includes a board support package and a bootstrap mechanism. The bootstrap mechanism is responsible for starting the board and executing the built in self-tests (BISTs).

### Linker

The platform also provides linker services, including incremental (gates) and dynamic linker services.

### Debug suites

The platform also provides debug suites, including operating system (OS) traces of mailboxes, ITL, watchdog messages, queues, robots, and memory. The debug suites also provide free traces, allowing the user to define trace points and to perform ASCII or hexadecimal traces. The user can also perform forced traces and use a 32-bit mask filter. The debug suites are also responsible for trace scheduling, including tracing of the task context switch. The traces are stored into a RAM circular buffer, both on the flight upload and on command upload. The debug suites also provide a post mortem fault log and crash dump in the event of a system crash.

The debug suites include a debug shell and built in self-tests (BISTs). In addition, the debug suites provide logging functions. Logging includes the recording of log entries by the various software functions, as well as the management of the logs by the craftsperson via the HMI. Several log types are supported, including, for example, flight recorder logs, debug logs, and software error logs.

### Non-Volatile Storage (NVS)

The BTS appliance provides non-volatile storage for commissioning parameters, hardware configuration, software loads, and other operational information. This must be managed to prevent loss of data in the event of a fault, and to allow automatic updating of the information at the appropriate times.

### Communication Layers

The BTS appliance supports a number of communication layers. For example, a number of communication drivers are supported, including HDLC, UART, QMC, RAW, SPI, ATM, and 12C. A variety of Internet protocols are also supported, including IP, TCP, UDP, MPLS, HTTP, FTP, DHCP, DNS, DiffServ, RSVP, PPP, RTP, BOOTP, and others. The BTS appliance also supports a variety of ATM protocols, such as ATM, AAL2, AAL0, AAL5, SAAL, QSAAL, IPoA, SSCOP, and SSCF. Various CDMA and UMTS protocols are supported, including, for CDMA, #BCN and CAN, and for UMTS, NBAP and SE/PE with ASN. 1 encoding. Application protocols are also supported. These include CMSG, in which a messaging layer hides the protocols used for communication between the different boards. This service provides services in connected mode and datagram mode. Another application protocol that is supported is OK3, which provides a presentation layer for CMSG, TCP/IP, LapD, Ethernet, and Utopia.

### Network Interfaces

Network interfaces connect the BTS appliance unit to the RNC/OMC-B/BSC/etc. and carry control, voice, and data traffic. Functions related to the network interfaces include T1/E1 timeswitch management functions, including drop and insert, loopback, auto-configuration, and other related functions. Another function related to the network interfaces is T1/E1 link utilization. This feature enables the customer to measure the bandwidth utilization of T1/E1 links terminated by the BTSI as well as the quality of those links. Other network interface-related functions include, for example, switch/router administrative and status monitoring, fault monitoring in the IP Switch, BCN Router, and ATM Switch, BCN Packet Routing, ATM cell switching, ATM AAL2 packet switching, Internet Protocol (IP) packet switching and routing, and ATM packet segmentation and reassembly.

The BTS appliance also supports other types of protocol interfaces, including, for example, interfaces with RNC (Iub) and OMC-B in UMTS applications and interfaces with BSC and BSM in CDMA applications. Radio interfaces are supported in both UMTS and CDMA applications.

### Operations, Administration, and Maintenance (OA&M)

As discussed above, the Operations, Administration, and Maintenance software allows control and monitoring by the craftsperson of the software, equipment, and configuration information that supports call processing.

### System Initialization

One function provided by the OA&M software is system initialization. This function brings the BTS appliance to an initialized state (i.e., application software running). System initialization does not include commissioning done by the craftsperson only automatic commissioning/configuration steps based on stored commissioning information or default values. The system initialization function is responsible for initializing communications with other network nodes, for example, HSSPC, ATM, IPOA, and CMSG. System initialization also initializes communications with the RNC/OMC-B/BSC, e.g., a set IP address or ATM (Vp, Vc). In addition, system initialization is responsible for FPGA download and starting other tasks in the test server, loader, and/or call processing modules. Alternatively, some of these functions can be done directly in the BSP using a command file.

### Link Termination and Management

The OA&M software also provides link termination and management functions for both UMTS and CDMA applications. For UMTS applications, this includes management of the Iub interface and an implementation-specific O&M interface. Link termination and management includes not only initial link establishment, but also the ongoing monitoring of link health, link recovery following a fault, and load sharing and distribution. The OA&M software also monitors layer 1/2/3 link performance and status, which are reported back to the RNC/management system as necessary via the appropriate interface, optionally first being processed by a performance monitoring module.

In connection with link termination and management functionality, the OA&M software controls any ATM switching, i.e., to cascaded equipment, and packetization/de-packetization of the incoming data from the Iub or Implementation Specific O&M logical interfaces. The OA&M software further manages the distribution of data internal to the Node B. The software also manages communications from an external interface management module to report on the status of any external link management equipment that may be used. It is important for the termination and management of the Iub to be supported in such a way as to allow the traffic handling to be optimized according to the link performance.

For CDMA applications, link termination and management includes the termination and management of the links and protocols over all interfaces external to the BTS appliance and SIU: the High Speed Serial Link (HSSL) between the BTS appliance and the SIU, the T1/E1 interface, the RS-485 and timing interfaces to the GPS, and the 10/100 Base-T Ethernet interfaces. Link termination and management includes not only initial link establishment (for synchronous interfaces), but also the ongoing monitoring of link health, link recovery following a fault, and load sharing and distribution. In connection with link termination and management functionality, the OA&M software also monitors layer 1/2/3 (physical, data link, and network layer) performance and status, and reports these back to the management system as necessary via the appropriate interface after being processed by the performance monitoring function. The OA&M software also controls any ATM, BCN, IP, or Ethernet switching within the BTS, and packetization/de-packetization of the incoming data. It is important for the termination and management of these links to be supported in such a way as to allow the traffic handling to be optimized according to the link performance.

### Performance Monitoring

The OA&M software also provides performance monitoring functionality. This OA&M software is responsible for all performance-related data collection and processing. All relevant aspects of the radio sites' performance that are not reported back to the RNC/management system implicitly during normal traffic handling, are incorporated into this functionality. Performance monitoring includes monitoring of interference measurements, local site events, periodic physical channel test results, and derived OM calculations, including, for example, system uptime and availability.

In connection with this function, the OA&M software also interfaces with other functions within the radio site to collate performance-related data, such as, for example, statistics relating to Iub link quality from the link termination and management module. Once processed, the resulting reports are preferably transmitted back to the RNC/management system as applicable via the appropriate logical interface. In other words, Operational Measurement (OM) encompasses data collection, averaging and statistical calculations, thresholding, and fault generation.

The impact of performance statistics can be divided into two categories. First, a number of performance statistics/measurements can enable real time optimization of the traffic environment. These are termed ‘real time’ and include, for example, Node B DL transmission power and uplink interference. Secondly, some performance statistics are not immediately required for traffic optimization, such as those requiring pre-processing or trend analysis to be useful. These are termed ‘non-real time’. The configuration of the real time and non-real time performance measurements and statistics may be different.

### Alarm and Resource Event Management

The OA&M software also provides alarm and resource event management. Each of the individual software modules is responsible for the generation of alarms and event notifications associated with its specific functional area. A centralized function is responsible for collating and processing these alarms and events and issuing them to the RNC/management system as applicable via the appropriate logical interface. The Node B/BTS radio site performs fault collection, fault correlation and filtering, alarm reporting, and fault recovery functions.

All alarms and events raised against logical resource capabilities are termed ‘resource events’. On the other hand, when alarms or events relate to implementation-specific aspects of the Node B/BTS they are known as ‘fault management alarms’. In the case where a fault management alarm also impacts on the logical resources, the Node B/BTS is configured to assess this impact and ensure the appropriate resource event is also issued to the RNC/management system.

### Maintenance and Diagnostics

The OA&M software also monitors and diagnoses faults in the Node B/BTS hardware. In connection with this functionality, the OA&M software manages the execution of diagnostics on the Node B/BTS hardware, interacting with the Implementation Specific Node B/BTS Configuration function as necessary. The OA&M software is also responsible for the ongoing health monitoring of the Node B/BTS and, via external interface management, its ancillary devices by means such as periodic polling, diagnostics, and automatic calibration of radio hardware.

The results of such diagnostics normally do not need to be reported back to the RNC/management system, unless problems are discovered which result in resource events or fault management alarms being generated. Any form of remote test equipment installed in the node B/BTS site shall be controlled by this function.

Where problems are identified by the maintenance and diagnostics functions, it should coordinate with the Alarm and Resource Management module to ensure the appropriate logical resource impact is notified accordingly. This should also include the circumstances where service capability is not totally lost but suffers reduced performance.

### Audits

The BTS appliance and SIU periodically verify the correct functioning of critical resources, including system software, such as drivers, RTOS task scheduling, OA&M tasks, and call processing tasks. Other resources that are periodically checked for correct functioning include network interfaces and internal interfaces, both of which are monitored using link audits. Other hardware audits are performed as well. The BTS appliance and SIU also periodically monitor the correct functioning of the call processing module, other BTS appliance sectors, and the interfaces between BTS appliances and between a BTS appliance and the SIU. Mastership/duplex resources are also periodically audited.

### Cell Configuration

The OA&M software also performs cell configuration, including managing all the relevant (logical) cell configuration information and coordinating the other controlling blocks, which implement these parameters physically. All the associated RF parameters, system information parameters, and channel configuration data are held and distributed by the OA&M software in connection with its cell configuration function.

In addition, the OA&M software interfaces with the Implementation Specific Node B/BTS Configuration function in order to ensure that high-level Node B/BTS capabilities, such as basic duplexing and antenna configuration information, are available to the management system. A number of Implementation Specific cell configuration parameters may exist in addition to those defined within the generic cell model.

### Dedicated Channel Management

The OA&M software is also responsible for activation and management of dedicated channel resources, including both dedicated traffic and control channels. The software is responsible for other related functionality, including monitoring of channel performance and generation of resource events and fault management alarms as necessary. Dedicated channel management is an integral part of the core traffic-handling function.

### Common Channel Management

The OA&M software is also responsible for activation and management of common channel resources, such as broadcast and paging channels. In connection with this function, it is also responsible for other related functionality, including re-paging (though this may be transparent to the RNC/management system), monitoring of channel performance, and generation of resource events and fault management alarms as necessary. Common channel management is an integral part of the core traffic-handling function.

### Synchronization and Timing

The Node B/BTS controller must be able to obtain accurate timing and synchronization information for use within the radio site and, for UMTS applications, over the Uu interface.

To facilitate this, the OA&M software provides synchronization and timing functions, including extraction of timing information from any desired source, including external timing equipment. The OA&M software also supports recovery of timing and temporary generation of clock information upon failure and subsequent re-establishment of the synchronization source. The OA&M software is also responsible for generation of timing-related resource events/fault management alarms and performance parameters for communication back to the RNC/management platform as applicable.

In order to achieve this, the OA&M software is responsible for PLL configuration, GPS configuration and maintenance, GPS holdover management, T1/E1synchronization recovery, even-second pulse and timestamp generation, time-of-day tracking and notification, and clock selection by internal ASICs and other devices.

The synchronization of the Node B/BTS site is critical to the successful handling of traffic, and it is therefore important that the synchronization and timing function interacts with the Alarm and Resource Event Management module to indicate any impact on the logical resources.

### Coding and Channelization

Furthermore, the OA&M software is responsible for coding and channelization, including physical coding and channelization of the Uu interface. A coding and channelization module of the OA&M software receives all the appropriate logical data from the dedicated channel and common channel management functions and manages all the required encoding and packaging for transmission by the radio hardware.

The coding and channelization module contains sufficient intelligence to identify any conflicts between the realizable physical channels and logical channel data. Any errors detected are preferably reported back to the RNC/management system as applicable via the appropriate interface. Coding and channelization is an integral part of the core traffic-handling function.

### Security and Access Control

The Node B/BTS radio site must be capable of controlling local access both physically (i.e., tamper alarms) and through communication interfaces. Password protection and security levels are preferably implemented for local interfaces. Further, the status of these operations can be reported back to the management system, for example, as fault management alarms. These alarms indicate of sessions established, door alarms triggered, operations performed locally, etc.

### Equipment Management

The OA&M software also performs equipment management functions, including managing the individual BTS modules, whether a single BTS appliance at a cell site or, for example, three BTS appliances and an SIU at a trisectored cell site.

The software is responsible for in-service/out-of-service (IS/OOS) and other module state administration and BTS appliance triplex management (mastership selection), if applicable.

### Implementation-Specific Node B/BTS Configuration

The OA&M software also provides an implementation-specific Node B/BTS configuration function. While this function is passive with regard to service provisioning, it is important from an operational perspective to have an accurate record of the physical configuration of the Node B/BTS radio site, combined with the ability to easily configure new hardware.

The implementation-specific Node B/BTS configuration module automatically performs detection and configuration of the Node B/BTS hardware. This is also called an inventory function. The module also manages a database capable of storing the software and hardware configuration information to serial number/version resolution, i.e., at the field replaceable unit level. The database can be queried from the management system.

### Determination of RF Parameters

During commissioning of the BTS at the cell site, the RF parameters required for the BTS to operate within the overall cellular network, e.g., channel settings, max power levels, and Cell ID, are provided to the BTS software. These parameters are stored both by other BTS appliance units at the same cell site (in a multi-sector configuration) and by the BSC/OMCR. These parameters should only be entered once by the customer, preferably at a central location and for all BTSs at once. Thereafter, during initialization the BTS appliance preferably restores the RF configuration by querying other BTS appliances at the cell site or the network management entity.

To the extent possible, the BTS appliance determines these settings automatically by, for example, querying the cell site inventory and deducing the sectorization. Alternatively, reasonable defaults may be provided. The operator will have the ability to change these default/automatic settings.

### Radio System Equipment Management

The OA&M software also incorporates a radio system equipment management module for controlling physical radio system hardware, performing operations such as transmitter tuning and power ramping. The cell configuration module shall perform the mapping of the physical channel information from the logical channels.

The radio system equipment management module also preferably performs other radio-related operations. For example, the module monitors the radio-related performance aspects of the hardware and reports the results to the performance monitoring module. Additionally, this module is preferably responsible for the redundancy of radio equipment, providing automatic reconfiguration as required.

The management of the radio system equipment is dependent on the particular hardware implementation contained in a Node B/BTS. However, the performance of the radio system is critical to traffic handling. The radio system equipment management module is therefore preferably capable of coordinating with the alarm and resource management and performance management modules to ensure the conditions where logical resources may be impacted are notified accordingly.

### Common Equipment Management

The OA&M software also includes a common equipment management module that controls the management of the non-radio hardware within the Node B/BTS. This equipment includes, for example, power supply units and OA&M/support modules. The common equipment management module is also responsible for BTS appliance internal temperature monitoring.

The Node B/BTS is configured to assess the impact on the logical resources of the loss/degradation of any such common equipment, and to generate an indication of such loss as necessary.

### External Interface Management

The Node B/BTS site preferably has the ability to interface with external ancillary devices, such as standalone power systems, repeaters, link equipment, adaptive antennas, and external power amplifiers. Support of such ancillary devices may impact on the Iub or Implementation Specific O&M logical interfaces, or both. Notably, where such equipment is critical to the provision or quality of service, any logical impact where a loss or degradation in the equipment is experiences is preferably indicated as necessary.

### Duplex Management

The OA&M software also preferably incorporates a duplex management module that is responsible for redundancy. The purpose of this module is to activate a redundant piece of equipment in case of failure of the active unit, for example, replacing an SIU with a redundant SIU.

### Download

The OA&M software also incorporates a download module whose purpose is to download and activate software on the BTS appliance. This can be done during first installation or while upgrading for both CDMA and UMTS software. Requests can come from many entities, including, for example, OMC-B, TIL, and BSM. The download module is also used to internally upgrade a card when software is locally available on the BTS appliance.

### Call Processing (UMTS)

For UMTS applications, call processing is mapped on the SIU and BTS appliance boards of the Node-B. The call processing software on the SIU is responsible for NBAP management, including setting up and deleting cell contexts and common transport channel contexts. The call processing software is also responsible for load balancing, ALCAP management, and providing a IuB ASN1 Coder/Decoder. Also, the call processing software handles the measurement management interface with the OA&M software.

The call processing software on the BTS appliance is responsible for NBAP protocol management, including managing cell protocols and protocols for common channels (BCCH, RACH, FACH, and PCH) and dedicated channels (DCH and DSCH), as well as user equipment (UE) for DCHs. The BTS appliance call processing software also incorporates an Iub ASN1 Encoder/Decoder. Further, the BTS appliance call processing software is responsible for producing measurement reports, power management, interfacing with the OA&M software, AR1 (concatenation and deconcatenation of L3 messages), low level (read/write) interfacing with DSP clusters, and providing a radio/channelizer/ASIC interface.

Since NPAP-c procedures are global to the Node-B whereas NBAP-d is dedicated to a UE context, the SIU is the terminating point for NBAP-c and the BTS appliance box is the terminating point for NBAP-d. An ATM switch inside the Node-B is used to route these message flows.

### Call Processing (CDMA)

For CDMA applications, call processing takes place almost entirely on the BTS appliance itself rather than the SIU. Call processing includes, for example, distributing the handling of incoming radio resource requests from the BSC/RNC evenly across the individual BTS appliance modules in a multi-sector BTS. Furthermore, the call processing also performs radio resource management and channel element pool allocation and management. Call processing in the CDMA context also includes forward power allocation, Walsh Code allocation and management, carrier selection, paging channel management, access channel management, traffic frame layer 2 sequence number management, user traffic relay to modem from the network interface, paging channel scheduling, quick paging channel management, and RF transmit power monitoring and control. RF transmit power monitoring and control includes monitoring and control of power amplifier coarse power settings, as well as automatic gain control gain adjustments. The call processing software also performs forward power reporting, including making average forward power values available to the forward power allocation module, allowing per-call forward power allocation.

For CDMA applications, the call processing software also provides UMTS BCCH generation, channel element/RF link switching and control, softer handoff channel element allocation, 1XRTT per-call signaling relay to mobile, and reverse channel power control. A channel element offload module re-allocates the overhead channels to a different BTS appliance channel element to keep the sector or sectors operational when the BTS appliance on which the overhead channels reside is shut down or taken out of service.

A multi-carrier traffic allocation (MCTA) module is triggered at the BSC to best select an optimum carrier to allocate the traffic resource of a call. The BTS appliance's role is to calculate the capacity estimate available for each carrier in the BTS for the BSC to make the selection. Typically, the MCTA module is only used when a coverage area is handled by multiple, co-located BTSs.

A carrier determination algorithm (CDS) module allows the BSC to permit the BTS appliance to select the best carrier within itself to allocate traffic resources for the call when a coverage area, i.e., cell, is handled by only one BTS appliance. A CRM component in the BTS appliance implements the CDA functionality to carry out such task.

An intelligent paging module increases call capacity (busy hour call attempt, or BHCA) in the BTS by intelligently reducing the excess amount of paging channel messages to the MS. This is done using zone paging (selected BTSs where the MS is likely located) and frequency-based paging (selected carrier in the BTS to which the MS is likely listening) techniques.

An intelligent voice service negotiation module enables the BTS to send IS-95B messages to query the MS capability for the system (MTX-BSC) to select the best possible vocoder in the Selector Bank to provide optimum voice quality for the users.

An access robustness package (IS-95B Support) reduces current MS access failure in the field from 5-7% down to 2.5%. This is done by implementing the IS-95B protocol where the MS is capable of reporting up to six pilot signals when it accesses the network. The BTS, under control of the MTX-BSC, allocates up to six traffic channels for the call in case the first link gets dropped due to a bad RF environment.

The call processing software also provides fixed wireless (FW) V5.2 support by allowing the customer to use the same NBSS platform to support FW users (Prox-C program) as well as existing Mobility users. Fixed wireless V5.2 support allows the operator to partition the number of carriers in the BTS appliance to support this mixture of users configuration.

A paging throttling mechanism ensures that the BTS appliance will never reset due to an overloading condition when paging traffic gets excessively high. When the alarm thresholds are met, paging messages are discarded in a configurable and controlled manner to keep the BTS appliance alive and allow as many important messages going through as possible to keep call setup failure down to the minimum.

The call processing software also provides carrier pooling support, allowing a single TCE on the BTS appliance to switch to a different carrier if the original carrier that it is assigned to is out of service. Further, the call processing software provides load balancing, 1XEV forward rate scheduling, 1XEV packet consolidation, and BSC 1xEV flow resynchronization after soft handoff.

### BTS Appliance Hardware Architecture

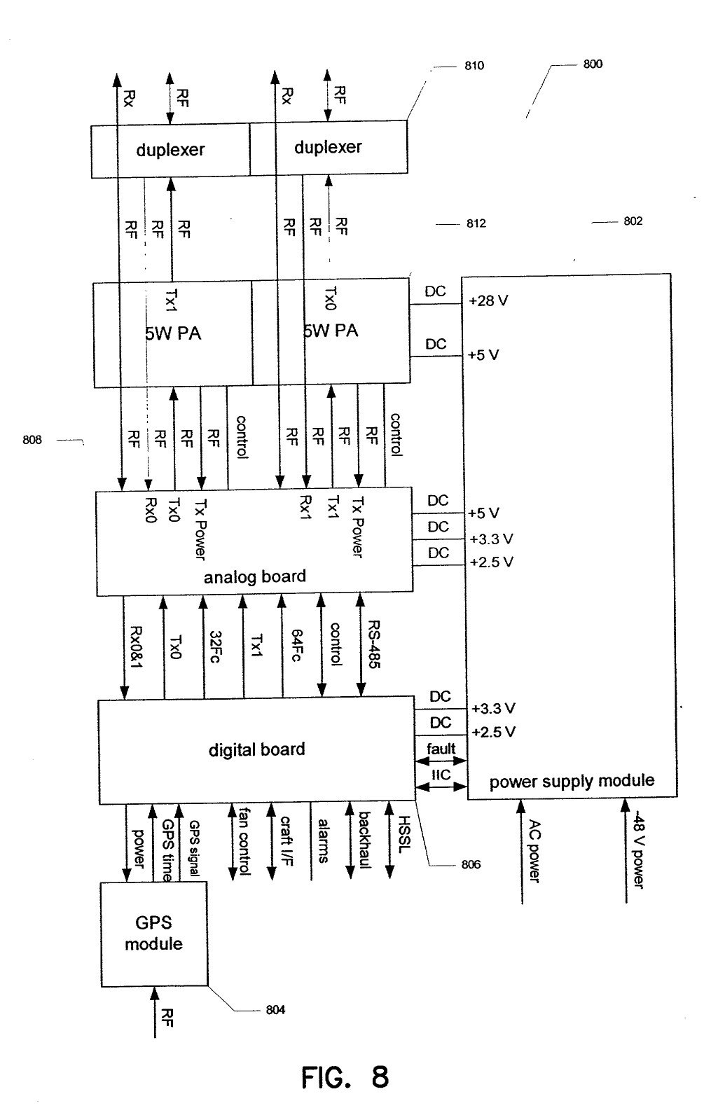

As discussed above in connection with FIGS. 1 and 2, the BTS appliance modular architecture consists of a digital board, an analog board, power amplifiers, duplexers, a power supply module, and, for CDMA applications, a GPS module. FIG. 8 depicts an example BTS appliance modular architecture 800, according to a particular embodiment of the present invention. Each component is described more fully below.

### Power Supply Module

The BTS appliance power supply module 802 supports a wide range of AC input power levels and internally rectifies and converts AC power to the DC power levels required within the BTS appliance. The power supply module incorporates DC charge and AC fault detection circuitry to provide early detection of AC power faults and extended operation of digital module with the DC charge. This function is implemented in order to protect the digital board network processor and the microprocessor from resetting in case of AC power transient faults. In addition, power supply module optionally also incorporates a -48V battery backup.

### GPS Module and GPS Smart Antenna

A GPS module 804 is specific for CDMA applications. It receives a GPS signal from a GPS antenna that also amplifies it in order to overcome RF cable loss. The GPS signal is processed within the GPS module 804 to derive GPS time. The GPS module 804 generates 1 PPS and 10 MHz reference signals that are closely synchronized and provides precise GPS time information for every 1 PPS it generates. In addition, the GPS module 804 incorporates hold over time (HOT) that is necessary for maintaining generated time with the global GPS system time within 10 microseconds in case of GPS system failure or GPS antenna failure. GPS HOT is supported with the TCXO that is fairly complex in design based on complex algorithms and as a result is expensive. The GPS module 804 is DC powered from the BTS appliance power supply module 802.

For UMTS applications, the BTS appliance is interfaced with the GPS Smart Antenna, and no GPS module needs to be supported. The GPS Smart Antenna contains the same functionality as a GPS antenna and the GPS module 804—it receives a GPS signal, amplifies it, processes it and generates a 1 PPS reference signal and provides precise GPS time information for every 1 PPS it generates. As the GPS Smart Antenna does not provide 10 MHz reference signal, the BTS appliance generates a system clock of 1 PPS reference signal received from the GPS Smart Antenna. The GPS Smart Antenna does not support HOT due to its complexity and environment conditions. The GPS Smart Antenna is DC powered from the BTS appliance power supply module 802.

For UMTS applications, a long time reference could also be derived from an E1/T1 clock and can be used in case of GPS system failure or GPS antenna failure. If the derived time of E1/T1 clock meets CDMA time accuracy requirements, it also can be supported for long time reference.

### Digital Board

The digital board 806 supports either UMTS or CDMA specific air-interface standards. It provides configuration, control, maintenance, and call processing functionality for the BTS appliance. The digital board 806 includes a network processor, a control processor, and a physical channel processor. The network processor is responsible for network protocol termination and packet routing. The control microprocessor is responsible for OA&M management, paging, call processing and BTS appliance control functionality. The physical channel microprocessor is responsible for frame conversion, scheduling, paging, radio resource management, and frame alignment.

The digital board 806 is also responsible for the CDMA multi-sector mode of operation where CE pooling across sectors is performed within FPGA. In addition, the digital board FPGA is responsible for transmit and receive frame alignment and data buffering, HSSL delay measurements and data buffering, some system fault detection and isolation, and system clock generation and distribution.

The digital board 806 includes UNTS Beta CEM and CDMA NCM DSP and ASIC pairs for chip and simple level processions. For UMTS applications, two pairs of DPS and ASIC are used for support of 64 12 kbps voice calls, and for CDMA applications, three pairs of DPS and ASIC are used for support of 192 9.6 kbps voice calls.

Optionally, the digital board also incorporates an MSM DSP type call processing verification module that is used to verify BTS appliance operating status while in service. This module, if implemented, allows any CSM CE to initiate a call and terminate it within the MSM DSP, or to originate a call at the MSM DSP and terminate it at any CSM CE.

On the network side, the digital board 806 terminates two E1/T1 backhaul interfaces for UMTS and CDMA applications when an SIU is not used. When an SIU is used for CDMA applications, the digital board 806 supports the HSSL interface. It also supports Craft I/F interface and 100BaseT for future IP network interfaces.

The digital board 806 also interfaces with the GPS module 804 or the Smart GPS Antenna to derive system time and synchronize with the GPS time. The digital board 806 also provides a fan interface for fan control and DC power that is required for forced air cooling of high power amplifiers. The digital board 806 also interfaces with an analog board 808 to receive Rx baseband data and transmit Tx baseband data, and to provide 32Fc and 64Fc system clock reference as well as IIC control for the analog board and RS-485 control for the power amplifier. The digital board 806 is interfaced with the power supply module 802 for DC power, control, and AC fault monitoring functionality.

### Analog Board

The analog board 808 supports UMTS or CDMA specific air-interface standards and frequency bands. The design of the analog board 808 for UMTS and CDMA applications is very similar, and the same for CDMA 1xRTT and 1xEV applications. All external interfaces of the analog board 808 are the same regardless of the air-interface standard or frequency band of operation.

The analog board 808 includes Tx and Rx channelizer application specific integrated circuits (ASICs), digital-to-analog converters (DACs) and analog-to-digital converters (ADCs), IF and RF sections, and a frequency synthesis section. The analog board provides Tx and Rx baseband signal processing and channelizing, digital-to-analog and analog-to-digital signal conversion, IF and RF signal conditioning and amplifications, as well as RF channel setting. In addition, it also provides fault detection of Tx signal path with the power detector functionality built at the output of the RF stage and calibration date stored in the EEPROM. On the Rx path, the receiver spectrum density at the antenna is also verified with the calibration data stored in the EEPROM.

The analog board supports receive and optional transmit diversity. In addition, adaptive pre-distortion (APD) reduces cost of power amplifiers for high power option. APD support involves the use of an FPGA between the Tx channelizer ASIC and the DAC's for each transmit diversity path.

The analog board 808 is interfaced with the digital board 806 to receive Tx baseband data and transmit Rx baseband data, receive 32Fc and 64Fc system clock reference as well as IIC control for the analog board and RS-485 control for the power amplifier.

The analog board 808 is interfaced with a duplexer module 810 for reception of Rx0 and Rx1 signals, a power amplifier 812 for transmission of Tx0 and Tx1 signals, and power amplifier control via an RS-485 interface. It is also interfaced with the power supply module 802 for DC power.

### Power Amplifier

The power amplifier 812 supports specific frequency bands and power levels. The same power amplifier is used for UMTS, CDMA 1xRTT and 1xEV applications if a specific air-interface standard is supported within the same frequency band and requires the same power level.

All external interfaces of the power amplifier 812 are the same regardless of the air-interface standard, frequency band of operation, or power level. It is interfaced with the analog board 808 to receive Tx signal and RS-485 control and with the duplexer module 812 to transmit Tx signal. It is also interfaced with the power supply module 802 for DC power.

### Duplexer

The duplexer 810, like the power amplifier 812, supports specific frequency bands and power levels. The same duplexer 810 is used for UMTS, CDMA, 1xRTT, and 1xEV applications if a specific air-interface standard is supported within the same frequency band and requires the same power level. The duplexer 810 is interfaced with the analog board 808 to transmit Rx signal and with the power amplifier module 802 to receive Tx signal.

### BTS Appliance Block and Level

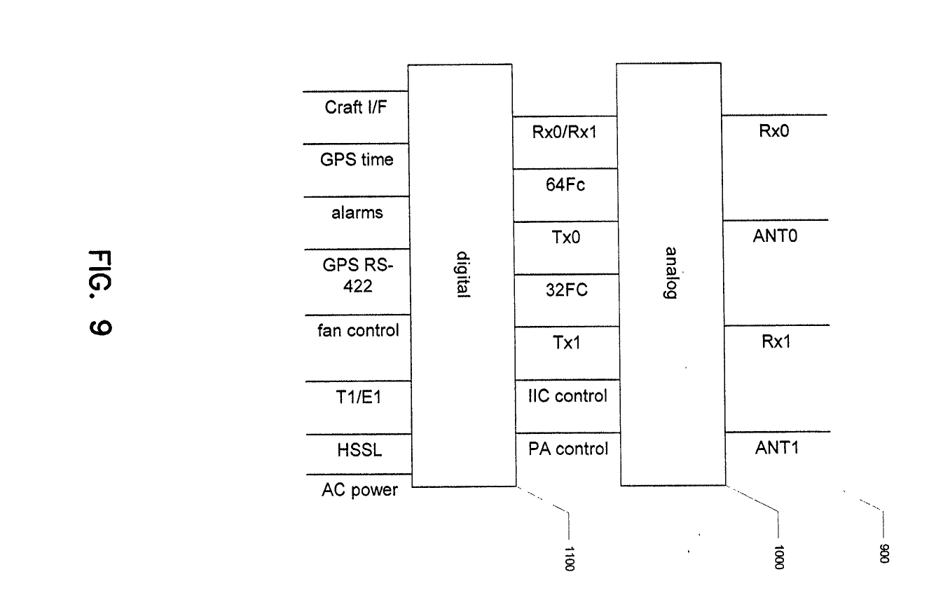

FIG. 9 depicts an example BTS appliance block and level architecture 900, according to an embodiment of the present invention. The BTS appliance FRU consists of a digital board 1000, an analog board 1100, a power amplifier module, a duplexer module and a power supply module. The analog module consists of an analog board, a power amplifier module and a duplexer module. The digital board and analog board block and level design and functionality are explained more fully in this section.

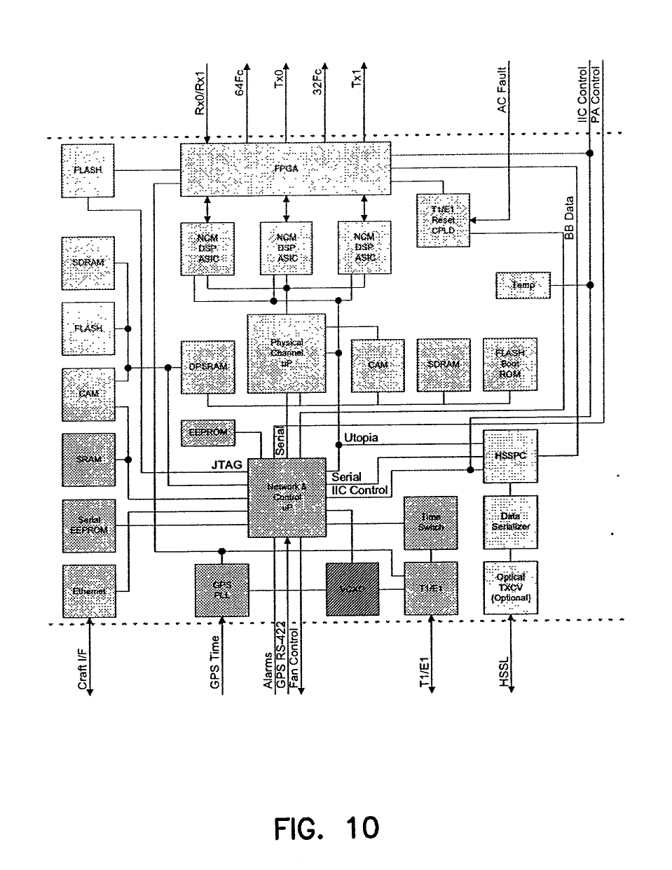

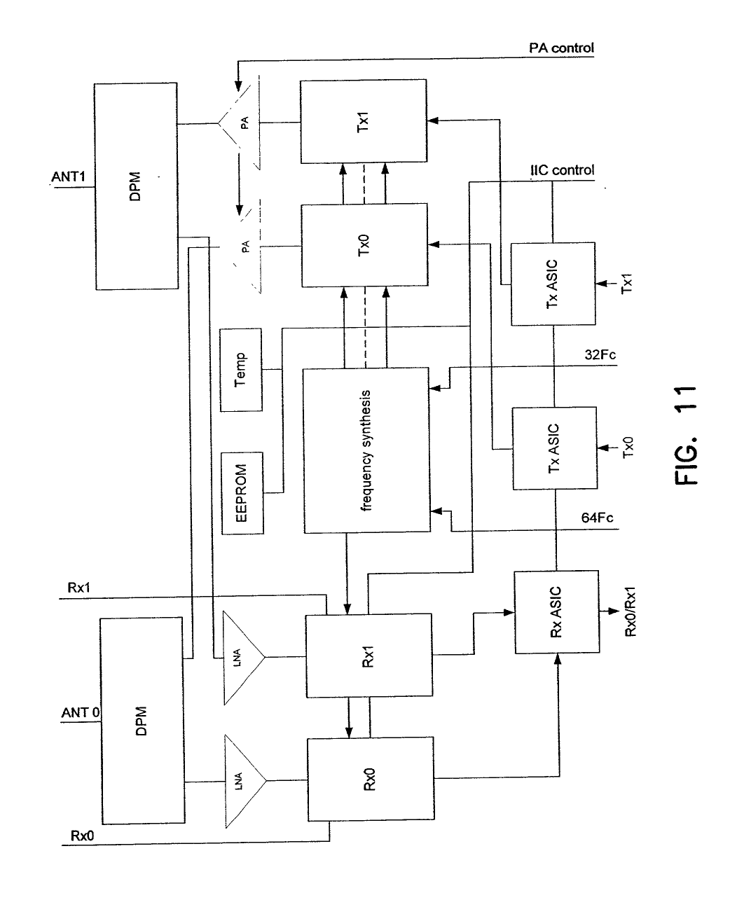

FIG. 10 depicts an example digital board block and level architecture. An example analog board block and level architecture is illustrated in FIG. 11. The analog board 1100 is interfaced with the digital board for reference frequency, IIC control, RS-485 control, and BB and RF signal processing on the forward and reverse links. An analog board transmitter is interfaced with two PA modules and a receiver is interfaced with two duplexers via RF cables. In addition, the analog board 1100 is interfaced with the power supply module for DC power.

The BTS appliance analog module 1100 is designed to meet UMTS XXXX requirements and CDMA IS-97D multi-carriers requirements. The power amplifier and duplexer modules are custom designed for low and high power UMTS and CDMA operation.

The BTS appliance design incorporates two independent receive and transmit signal paths for diversity reception and transmission. The BTS appliance design incorporates a common reference DDS with separate Rx PLL and Tx PLL to allow easy adoption and support of IMT-2000, cellular, PCS and other frequency bands of operation that are referenced in the IS-2000.

On the transmit path, a Tx ASIC receives BB digital data from the digital board, provides signal conditioning and outputs I&Q data to a pair of DACs that are sampled at 32Fc. The sampled I&Q data samples undergo anti-aliasing filtering prior to quadrature modulation. Once the signal is converted to RF frequency, additional amplification and wideband filtering are provided prior to amplification within the power amplifier module. A variable attenuator is preferably implemented for calibration, target gain adjustment, blossoming, and wilting functionality. RF signal power measurement is to be performed before the PA module and at the output of the PA module. Once the signal is amplified, it is filtered with the wideband duplexer that is designed to cover a full band of operation.

On the receive path, the analog board 1100 receives an analog signal from the duplexer module where it is bandpass filtered before it is amplified with the on-board wideband LNA. After the signal is amplified, it is split into two paths, where one path is forwarded to a set of two RF switches. A pair of RF switches are used to select the receive signal from the internal or external LNA, and also to output the receive signal that has been bandpass filtered and amplified to another receiver. A variable attenuator is preferably implemented for calibration and target gain adjustment, as well as noise figure versus linearity tradeoffs. Further amplification and filtering is applied before the receive signal is downconverted to the Intermediate Frequency (IF). The IF signal is SAW filtered and further amplified to obtain a target gain at the ADC to ensure that ADC quantization noise is a negligible factor of the receiver noise figure. A SAW filter is required to reject interfering tones as given in IS-97D before the Rx signal and the tones are present at the ADC input. After the signal is channel filtered with the appropriate bandwidth SAW filter, it is further amplified to reach the gain target at the ADC input. An ADC anti-aliasing filter is used at the input to the ADC to reduce the noise power within the IF frequency aliasing bands before the signal is sampled with the ADC at 32Fc. The ADC sampled receive data and clock signals are sent to the Rx ASIC, which is used to process the digital data further before the signal is sent to the digital board.

The digital board 1000 generates and provides the analog board 1100 with the 32Fc and 64Fc frequency reference signals. These signals are used on the analog board 1100 to generate a set of clock signals for the ADCs, DACs, Rx ASIC, and the Tx ASICs as well as to provide a DDS with the reference signal.

The analog board 1100 incorporates an IIC interface for configuration, control, and alarm functionality of the entire analog board 1100. In addition, the BTS appliance provides RS-485 communication bus for interface with the power amplifier module.

### GPS Module Block and Level

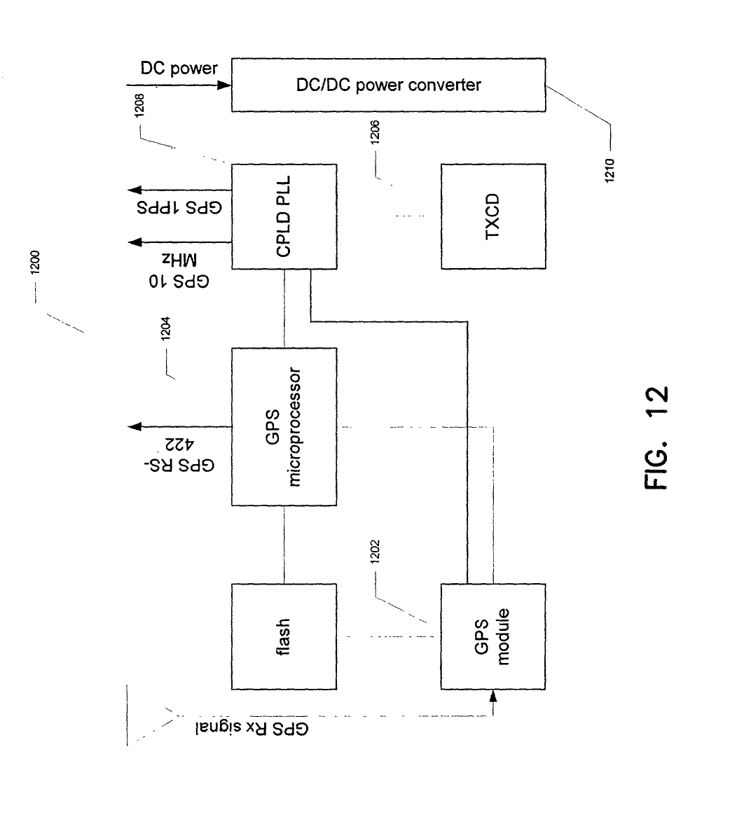

FIG. 12 illustrates an example GPS module 1200, according to an implementation of the present invention. The GPS module 1200 provides a GPS time reference for the BTS appliance or SIU units. The GPS module 1200 is specific for CDMA operations in which an eight hour hold over time must be provided in case of GPS signal or GPS antenna failure.

A GPS signal is received from the GPS antenna via a coaxial interface and processed within a GPS engine 1202 that generates a 1 PPS reference signal precise with the GPS time. The 1 PPS reference signal is used to generate a closely aligned 10 MHz reference signal. A GPS module microprocessor 1204 is used to interface with the GPS engine 1202 to derive time of day and other GPS time-related information. The GPS module microprocessor 1204 is interfaced with the BTS appliance or SIU control processor via an RS-422 interface to receive time of day and other GPS time-related information. A temperature controlled crystal oscillator (TXCO) 1206 is used within the GPS module 1200 to provide a stable reference signal for a GPS CPLD 1208 in case of GPS antenna failure or GPS engine failure.

The GPS module 1200 incorporates a DC-DC power supply 1210 to ensure low noise and is DC powered from the BTS appliance power supply module or SIU power supply module. The GPS antenna contains an LNA that is powered from the GPS module DC-DC power supply 1210 via a coaxial interface.

### GPS Smart Antenna Block and Level

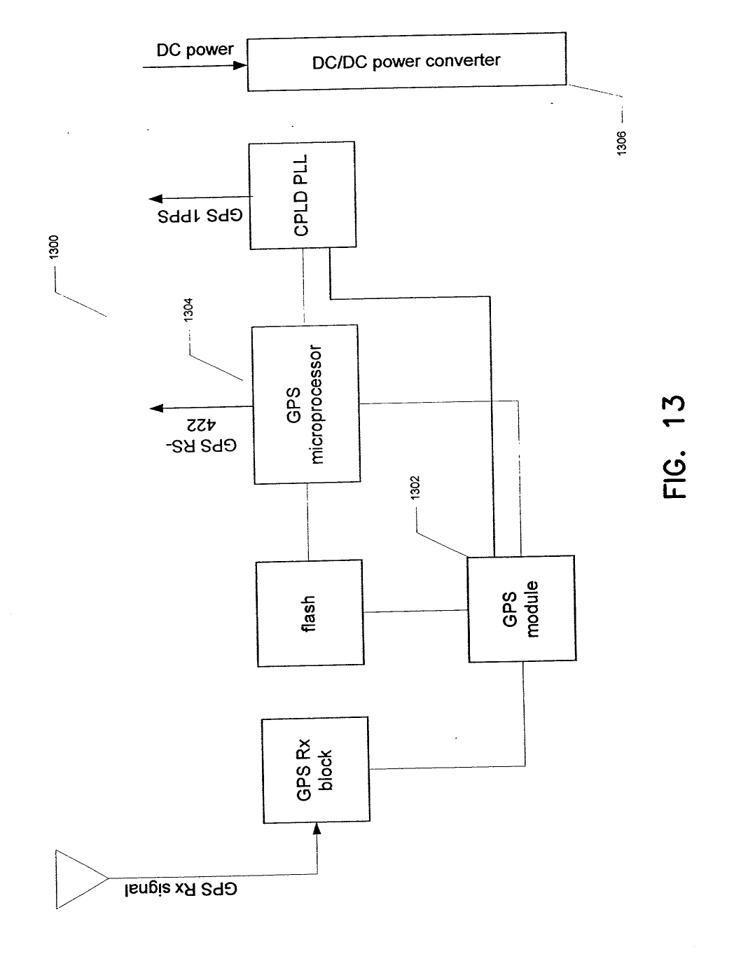

FIG. 13 illustrates an example GPS Smart Antenna 1300, according to another implementation of the present invention. Similar to the GPS module 1200, the GPS Smart Antenna 1300 provides GPS time reference for the BTS appliance or SIU units. The GPS Smart Antenna 1300 is specific for UMTS operation; however, it can also be used for CDMA operations that do not have a hold over time requirement.

Within the GPS Smart Antenna 1300, a GPS signal is received, low noise amplified and processed within a GPS engine 1302 that generates a 1 PPS reference signal precise with the GPS time and further sent to the BTS appliance or SIU. A GPS module microprocessor 1304 is used to interface with the GPS engine 1302 to derive time of day and other GPS time-related information. The GPS module microprocessor 1304 is interfaced with the BTS appliance or SIU control processor via an RS-422 interface to receive time of day and other GPS time-related information.

The GPS Smart Antenna 1300 incorporates a wide range input DC-DC power supply 1306 to ensure low noise and is DC powered from the BTS appliance power supply module or SIU power supply module.

### Power Supply Module Block and Level

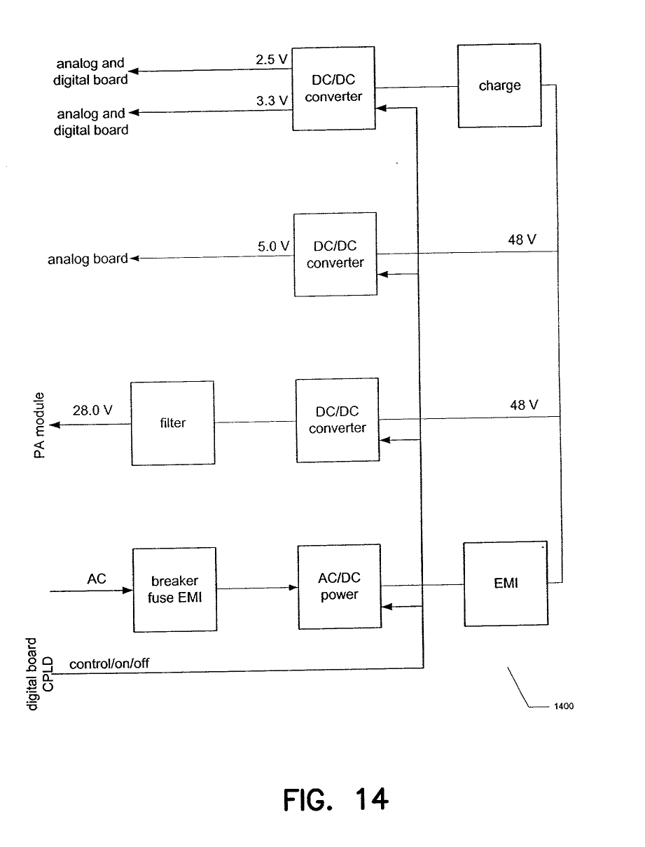

FIG. 14 depicts an example power supply module 1400 for use with the BTS appliance. The power supply module 1400 supports a wide range of AC input power levels and internally rectifies and converts AC power to the DC power levels required within the BTS appliance.

The power supply module 1400 can alternatively incorporate a discrete design instead of a modular PUP design. Cost, reliability, availability and flexibility trade-offs would inform the choice of architecture for the power supply module 1400.

The BTS appliance power supply module 1400 uses a common design for both UMTS and CDMA operation. However, there may be two separate power supply modules 1400 depending on the BTS appliance Tx power level. For lower Tx power levels, the power supply module 1400 needs to generate approximately 200W of DC power, and for higher Tx power levels, the power supply module 1400 needs to generate approximately 350 W of DC power. The DC power delta for the two power supplies is on +28V DC voltage level that is used to power an amplifier based on LDMOS devices.

The power supply module 1400 preferably also incorporates a DC charge and AC fault detection circuitry to provide early detection of transient AC power faults and extended operation of the digital board under AC faults. This function is implemented in order to protect the digital board network processor and microprocessor from resetting or losing configuration data in case of a transient AC power fault. In addition, the power supply module 1400 optionally also incorporates a −48V battery backup.

### Appliance BTS Hardware Interfaces

FIG. 15 illustrates the external interfaces of the BTS appliance. These include an AC power supply and a −48 V DC battery backup, two T1/E1 interfaces, a 100BaseT interface, a 10BaseT interface, two alarm interfaces, a GPS interface, a GPS Smart Antenna interface, two RF antenna interfaces, an Rx0 interface, and an Rx1 interface.

### SIU Software Architecture

The Site Interface Unit (SIU) functionality is divided into the following domains, similar to the BTS appliance:

Platform:

At a high level, the Platform domain is the functionality required by the BTS appliance/SIU software itself to perform the functionality in the other two domains.

OA&M:

The Operations, Administration, and Maintenance software allows control and monitoring by the craftsperson of the software, equipment, and configuration information that supports call processing.

Call Processing:

The application that generates revenue for the customer-software that is directly involved in setting up, maintaining, and tearing down individual cellular calls between the BTS and the mobile station.

### Platform

For the most part, the SIU platform elements are similar to corresponding elements in the BTS appliance platform software.

### Base Operating System

One service provided by the platform is a Base Operating System. The Base Operating System provides the usual Real-Time Operating System (RTOS) services plus other proprietary services. All of these services are abstracted so that the RTOS is not accessed directly by any other software. These services include, for example, multitasking task scheduling, callback timers, watchdog, semaphores, mailboxes, events, delays, memory management, queues, a state machine, hardware interruption management, logical interruption, exception and error handling, and TTY management.

### Board Management

Another service provided by the platform is board management. This function includes a board support package and a bootstrap mechanism. The bootstrap mechanism is responsible for starting the board and executing the built in self-tests (BISTs). One difference between the board management module in the SIU software and the corresponding module in the BTS software is that the SIU board management module supports the memory map and hardware configuration of the SIU. Also, because the SIU uses different BISTs from the BTS, the board management software is also modified to support the SIU's BISTs and slightly different boot sequence.

### Linker

The platform also provides linker services, including incremental (gates) and dynamic linker services.

### Debug suites

The platform also provides debug suites, including operating system (OS) traces of mailboxes, ITL, watchdog messages, queues, robots, and memory. The debug suites also provide free traces, allowing the user to define trace points and to perform ASCII or hexadecimal traces. The user can also perform forced traces and use a 32-bit mask filter. The debug suites are also responsible for trace scheduling, including tracing of the task context switch. The traces are stored into a RAM circular buffer, both on the flight upload and on command upload. The debug suites also provide a post mortem fault log and crash dump in the event of a system crash.

The debug suites include a debug shell and built in self-tests (BISTs). In addition, the debug suites provide logging functions. Logging includes the recording of log entries by the various software functions, as well as the management of the logs by the craftsperson via the HMI. Several log types are supported, including, for example, flight recorder logs, debug logs, and software error logs.

### Non-Volatile Storage (NVS)

The SIU provides non-volatile storage for commissioning parameters, hardware configuration, software loads, and other operational information. This must be managed to prevent loss of data in the event of a fault, and to allow automatic updating of the information at the appropriate times. The commonality of the NVS feature on the SIU and BTS appliance depends on the flash devices selected for each platform.

### Communication Layers

The SIU supports a number of communication layers. For example, a number of communication drivers are supported, including HDLC, UART, QMC, RAW, SPI, ATM, and 12C. A variety of Internet protocols are also supported, including IP, TCP, UDP, MPLS, HTTP, FTP, DHCP, DNS, DiffServ, RSVP, PPP, RTP, BOOTP, and others. The SIU also supports a variety of ATM protocols, such as ATM, AAL2, AAL0, AAL5, SAAL, QSAAL, IPoA, SSCOP, and SSCF. Various CDMA and UMTS protocols are supported, including, for CDMA, #BCN and CAN, and for UMTS, NBAP and SE/PE with ASN. 1 encoding. Application protocols are also supported. These include CMSG, in which a messaging layer hides the protocols used for communication between the different boards. This service provides services in connected mode and datagram mode. Another application protocol that is supported is OK3, which provides a presentation layer for CMSG, TCP/IP, LapD, Ethernet, and Utopia.

### Network Interfaces

In the BTS appliance unit, network interfaces connect the BTS appliance unit to the RNC/OMC-B/BSC/etc. and carry control, voice, and data traffic. Functions related to the network interfaces include T1/E1 timeswitch management functions, including drop and insert, loopback, auto-configuration, and other related functions. Another function related to the network interfaces is T1/E1 link utilization. This feature enables the customer to measure the bandwidth utilization of T1/E1 links terminated by the BTSI as well as the quality of those links. Other network interface-related functions include, for example, switch/router administrative and status monitoring, fault monitoring in the IP Switch, BCN Router, and ATM Switch, BCN Packet Routing, ATM cell switching, ATM AAL2 packet switching, Internet Protocol (IP) packet switching and routing, and ATM packet segmentation and reassembly.

The BTS appliance also supports other types of protocol interfaces, including, for example, interfaces with RNC (Iub) and OMC-B in UMTS applications and interfaces with BSC and BSM in CDMA applications. Radio interfaces are supported in both UMTS and CDMA applications.

For the SIU, T1/E1 timeswitch management and link utilization are common with the BTS appliance. T1/E1 link utilization allows the customer to measure the bandwidth utilization of T1/E1 links terminated by the BTSI as well as the quality of those links. Other network interface-related functions that are similar to those in the BTS appliance include, for example, switch/router administrative and status monitoring, fault monitoring in the IP Switch, BCN router, and ATM switch, BCN packet routing, ATM cell switching, and Internet Protocol (IP) packet switching and routing.

Some of the ATM processing need not be implemented on the SIU, as the SIU can simply switch the cells to the BTS appliance where the protocol will be terminated in both the omni and multi-sectored products. These ATM processing functions include ATM AAL2 Packet Switching and ATM packet segmentation and reassembly.

In addition to the protocol interfaces described above, the SIU optionally also supports certain other protocol interfaces, including, for example, interfaces with RNC (Iub) and OMC-B in UMTS applications and interfaces with BSC and BSM in CDMA applications. Radio interfaces are supported in both UMTS and CDMA applications.

### Operations, Administration, and Maintenance (OA&M)

Most of the OA&M features are similar to those described for the BTS appliance OA&M software.

### System Initialization

One function provided by the OA&M software is system initialization. This function brings the SIU to an initialized state (i.e., application software running). System initialization does not include commissioning done by the craftsperson—only automatic commissioning/configuration steps based on stored commissioning information or default values. The system initialization function is responsible for initializing communications with other network nodes, for example, HSSPC, ATM, IPOA, and CMSG. System initialization also initializes communications with the RNC/OMC-B/BSC, e.g., a set IP address or ATM (Vp, Vc). In addition, system initialization is responsible for FPGA download and starting other tasks in the test server, loader, and/or call processing modules. Alternatively, some of these functions can be done directly in the BSP using a command file.

On the SIU, system initialization is slightly different from system initialization in the BTS OA&M software. In particular, the SIU system initialization takes into account that up to three BTS appliance units can be connected to the SIU, and that these BTS appliance units would need to be initialized as well.

### Link Termination and Management

The OA&M software also provides link termination and management functions for both UMTS and CDMA applications. For UMTS applications, this includes management of the Iub interface and an implementation-specific O&M interface. Link termination and management includes not only initial link establishment, but also the ongoing monitoring of link health, link recovery following a fault, and load sharing and distribution. The OA&M software also monitors layer 1/2/3 link performance and status, which are reported back to the RNC/management system as necessary via the appropriate interface, optionally first being processed by a performance monitoring module.

In connection with link termination and management functionality, the OA&M software controls any ATM switching, i.e., to cascaded equipment, and packetization/de-packetization of the incoming data from the Iub or Implementation Specific O&M logical interfaces. The OA&M software further manages the distribution of data internal to the Node B. The software also manages communications from an external interface management module to report on the status of any external link management equipment that may be used. It is important for the termination and management of the Iub to be supported in such a way as to allow the traffic handling to be optimized according to the link performance.

For CDMA applications, link termination and management includes the termination and management of the links and protocols over all interfaces external to the BTS appliance and SIU: the High Speed Serial Link (HSSL) between the BTS appliance and the SIU, the T1/E1 interface, the RS-485 and timing interfaces to the GPS, and the 10/100 Base-T Ethernet interfaces. Link termination and management includes not only initial link establishment (for synchronous interfaces), but also the ongoing monitoring of link health, link recovery following a fault, and load sharing and distribution. In connection with link termination and management functionality, the OA&M software also monitors layer 1/2/3 (physical, data link, and network layer) performance and status, and reports these back to the management system as necessary via the appropriate interface after being processed by the performance monitoring function. The OA&M software also controls any ATM, BCN, IP, or Ethernet switching within the SIU, and packetization/de-packetization of the incoming data. It is important for the termination and management of these links to be supported in such a way as to allow the traffic handling to be optimized according to the link performance.

### Performance Monitoring

The SIU OA&M software also provides performance monitoring functionality. This OA&M software is responsible for all performance-related data collection and processing. All relevant aspects of the radio sites' performance that are not reported back to the RNC/management system implicitly during normal traffic handling, are incorporated into this functionality. Performance monitoring includes monitoring of interference measurements, local site events, periodic physical channel test results, and derived OM calculations, including, for example, system uptime and availability.

In connection with this function, the OA&M software also interfaces with other functions within the radio site to collate performance-related data, such as, for example, statistics relating to Iub link quality from the link termination and management module. Once processed, the resulting reports are preferably transmitted back to the RNC/management system as applicable via the appropriate logical interface. In other words, Operational Measurement (OM) encompasses data collection, averaging and statistical calculations, thresholding, and fault generation.

The impact of performance statistics can be divided into two categories. First, a number of performance statistics/measurements can enable real time optimization of the traffic environment. These are termed ‘real time’ and include, for example, Node B DL transmission power and uplink interference. Secondly, some performance statistics are not immediately required for traffic optimization, such as those requiring pre-processing or trend analysis to be useful. These are termed ‘non-real time’. The configuration of the real time and non-real time performance measurements and statistics may be different.

In the SIU OA&M software, collection periods are optionally synchronized between the SIU and the BTS appliance units to which the SIU is connected.

### Alarm and Resource Event Management

The SIU OA&M software also provides alarm and resource event management. Each of the individual software modules is responsible for the generation of alarms and event notifications associated with its specific functional area. A centralized function is responsible for collating and processing these alarms and events and issuing them to the RNC/management system as applicable via the appropriate logical interface. The Node B/BTS radio site performs fault collection, fault correlation and filtering, alarm reporting, and fault recovery functions.

All alarms and events raised against logical resource capabilities are termed ‘resource events’. On the other hand, when alarms or events relate to implementation-specific aspects of the Node B/BTS they are known as ‘fault management alarms’. In the case where a fault management alarm also impacts on the logical resources, the Node B/BTS is configured to assess this impact and ensure the appropriate resource event is also issued to the RNC/management system.

### Maintenance and Diagnostics

Maintenance and diagnostic functions are implemented on the OA&M master, namely, the SIU if one is present, or on the BTS appliance if no SIU is present. If these functions are implemented on the SIU, the SIU OA&M software monitors and diagnoses faults in the Node B/BTS hardware. In connection with this functionality, the OA&M software manages the execution of diagnostics on the Node B/BTS hardware, interacting with the Implementation Specific Node B/BTS Configuration function as necessary. The OA&M software is also responsible for the ongoing health monitoring of the Node B/BTS and, via external interface management, its ancillary devices by means such as periodic polling, diagnostics, and automatic calibration of radio hardware.

The results of such diagnostics normally do not need to be reported back to the RNC/management system, unless problems are discovered which result in resource events or fault management alarms being generated. Any form of remote test equipment installed in the node B/BTS site shall be controlled by this function.

Where problems are identified by the maintenance and diagnostics functions, it should coordinate with the Alarm and Resource Management module to ensure the appropriate logical resource impact is notified accordingly. This should also include the circumstances where service capability is not totally lost but suffers reduced performance.

### Audits

The BTS appliance and SIU periodically verify the correct functioning of critical resources, including system software, such as drivers, RTOS task scheduling, OA&M tasks, and call processing tasks. Other resources that are periodically checked for correct functioning include network interfaces and internal interfaces, both of which are monitored using link audits. Other hardware audits are performed as well. The BTS appliance and SIU also periodically monitor the correct functioning of the call processing module, other BTS appliance sectors, and the interfaces between BTS appliances and between a BTS appliance and the SIU. Mastership/duplex resources are also periodically audited.

### Cell Configuration

The OA&M software also performs cell configuration, including managing all the relevant (logical) cell configuration information and coordinating the other controlling blocks, which implement these parameters physically. All the associated RF parameters, system information parameters, and channel configuration data are held and distributed by the OA&M software in connection with its cell configuration function.

In addition, the OA&M software interfaces with the Implementation Specific Node B/BTS Configuration function in order to ensure that high-level Node B/BTS capabilities, such as basic duplexing and antenna configuration information, are available to the management system. A number of Implementation Specific cell configuration parameters may exist in addition to those defined within the generic cell model.

### Dedicated Channel Management

The OA&M software is also responsible for activation and management of dedicated channel resources, including both dedicated traffic and control channels. The software is responsible for other related functionality, including monitoring of channel performance and generation of resource events and fault management alarms as necessary. Dedicated channel management is an integral part of the core traffic-handling function.

### Common Channel Management

The OA&M software is also responsible for activation and management of common channel resources, such as broadcast and paging channels. In connection with this function, it is also responsible for other related functionality, including re-paging (though this may be transparent to the RNC/management system), monitoring of channel performance, and generation of resource events and fault management alarms as necessary. Common channel management is an integral part of the core traffic-handling function.

### Coding And Channelization

These functions will be implemented on either the BTS appliance in sites without an SIU, and in the SIU for other sites. For CDMA, coding and channelization can either be always implemented on the BTS appliance, or, as an alternative, be implemented on the SIU in multi-sectored systems.

If coding and channelization are implemented on the SIU, the SIU OA&M software is responsible for coding and channelization, including physical coding and channelization of the Uu interface. A coding and channelization module of the OA&M software receives all the appropriate logical data from the dedicated channel and common channel management functions and manages all the required encoding and packaging for transmission by the radio hardware.

The coding and channelization module contains sufficient intelligence to identify any conflicts between the realizable physical channels and logical channel data. Any errors detected are preferably reported back to the RNC/management system as applicable via the appropriate interface. Coding and channelization is an integral part of the core traffic-handling function.

### Synchronization and Timing

Synchronization and timing will be implemented wherever the GPS is present for those systems with a GPS configured (either on the SIU or the BTS appliance). If no GPS is present, it will be implemented wherever the T1/E1 backhaul terminates (BTS appliance or SIU).

### Security and Access Control

The Node B/BTS radio site must be capable of controlling local access both physically (i.e., tamper alarms) and through communication interfaces. Password protection and security levels are preferably implemented for local interfaces. Further, the status of these operations can be reported back to the management system, for example, as fault management alarms. These alarms indicate of sessions established, door alarms triggered, operations performed locally, etc.

### Equipment Management

The OA&M software also performs equipment management functions, including managing the individual BTS modules, whether a single BTS appliance at a cell site or, for example, three BTS appliances and an SIU at a trisectored cell site.

The software is responsible for in-service/out-of-service (IS/OOS) and other module state administration and BTS appliance triplex management (mastership selection), if applicable.

### Implementation-Specific Node B/BTS Configuration

Implementation-specific node B/BTS configuration is implemented at the OA&M master—the SIU if present, or the BTS appliance if no SIU is present. If implemented at the SIU, the SIU OA&M software provides an implementation-specific Node B/BTS configuration function. While this function is passive with regard to service provisioning, it is important from an operational perspective to have an accurate record of the physical configuration of the Node B/BTS radio site, combined with the ability to easily configure new hardware.

The implementation-specific Node B/BTS configuration module automatically performs detection and configuration of the Node B/BTS hardware. This is also called an inventory function. The module also manages a database capable of storing the software and hardware configuration information to serial number/version resolution, i.e., at the field replaceable unit level. The database can be queried from the management system.

### Radio System Equipment Management

While most radio system equipment management functions are implemented on the BTS appliance units, some higher level control functions are moved to the SIU in multi-sectored configurations. The SIU OA&M software also incorporates a radio system equipment management module for controlling physical radio system hardware, performing operations such as transmitter tuning and power ramping. The cell configuration module shall perform the mapping of the physical channel information from the logical channels.

The radio system equipment management module also preferably performs other radio-related operations. For example, the module monitors the radio-related performance aspects of the hardware and reports the results to the performance monitoring module. Additionally, this module is preferably responsible for the redundancy of radio equipment, providing automatic reconfiguration as required.

The management of the radio system equipment is dependent on the particular hardware implementation contained in a Node B/BTS. However, the performance of the radio system is critical to traffic handling. The radio system equipment management module is therefore preferably capable of coordinating with the alarm and resource management and performance management modules to ensure the conditions where logical resources may be impacted are notified accordingly.

### Common Equipment Management

The SIU OA&M software also includes a common equipment management module that controls the management of the non-radio hardware within the Node B/BTS. This equipment includes, for example, power supply units and OA&M/support modules. The common equipment management module is also responsible for BTS appliance internal temperature monitoring.

The Node B/BTS is configured to assess the impact on the logical resources of the loss/degradation of any such common equipment, and to generate an indication of such loss as necessary.

### Duplex Management

On the BTS appliance, duplex management handles redundant functions across the different BTS appliance boxes at the site in a multi-sectored configuration. On the SIU, duplex management handles the redundant SIU, if present.

### Download

Download functions are implemented on all nodes, both BTS units and SIUs, although the primary download contact for the rest of the network at the BTS will be the OA&M master, either on the BTS appliance or the SIU. The SIU OA&M software incorporates a download module whose purpose is to download and activate software on the BTS appliance. This can be done during first installation or while upgrading for both CDMA and UMTS software. Requests can come from many entities, including, for example, OMC-B, TIL, and BSM. The download module is also used to internally upgrade a card when software is locally available on the BTS appliance.

### Call Processing

For UMTS applications, the majority of the call processing will be done at the SIU, providing a centralized manager that can coordinate resources across the different sectors in a multi-sectored configuration. In an omni configuration, all call processing will be done on the BTS appliance.

For CDMA applications, call processing can either be distributed on all the BTS appliance boxes or centralized at the SIU in multi-sectored configuration.

### CDMA SIU Hardware Architecture

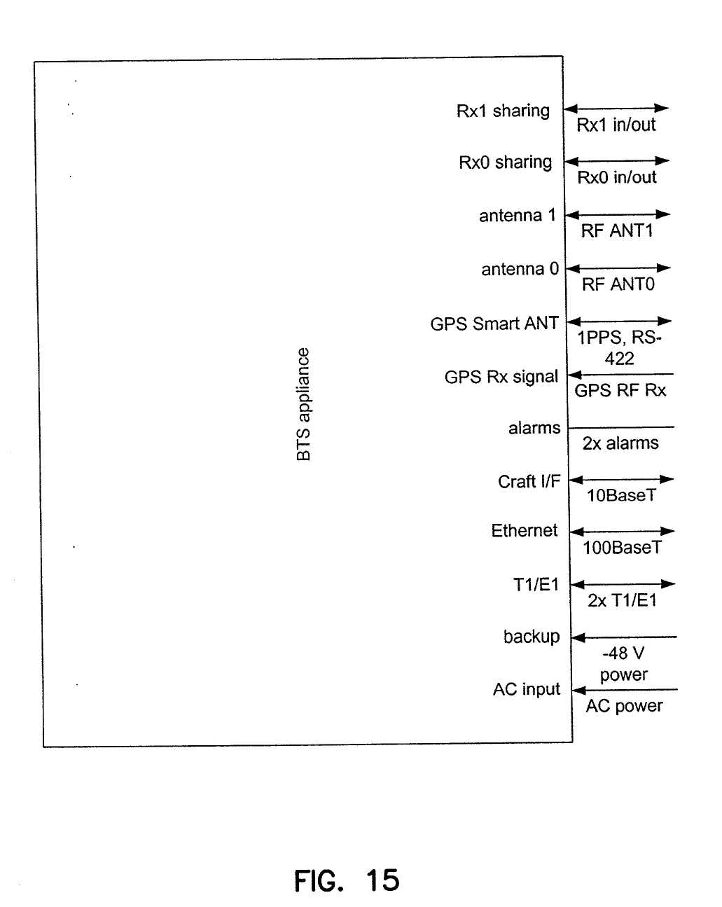

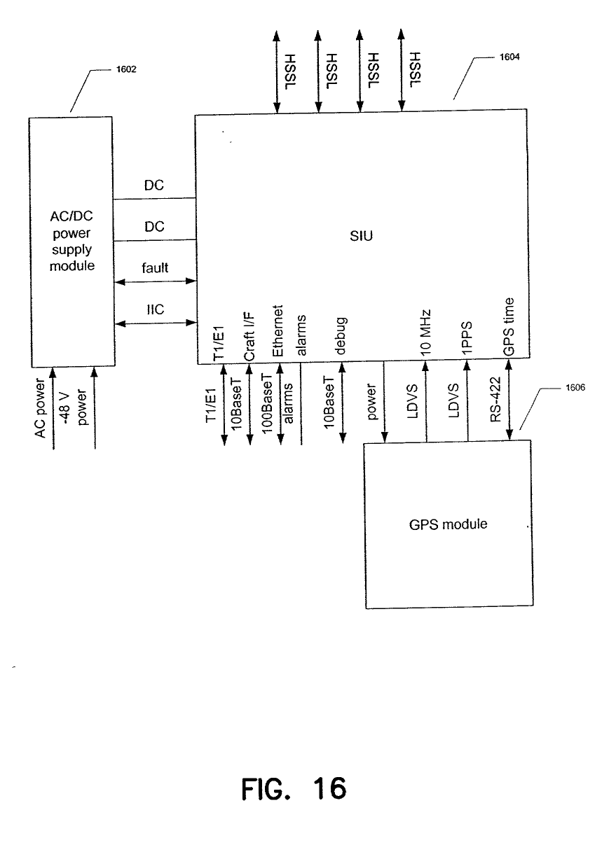

FIG. 16 illustrates the major components of the CDMA SIU hardware architecture. The SIU architecture includes an AC/DC power supply module 1602, a system interface unit (SIU) 1604, and a GPS module 1606. Each of these modules is described in greater detail below.

### SIU Block and Level

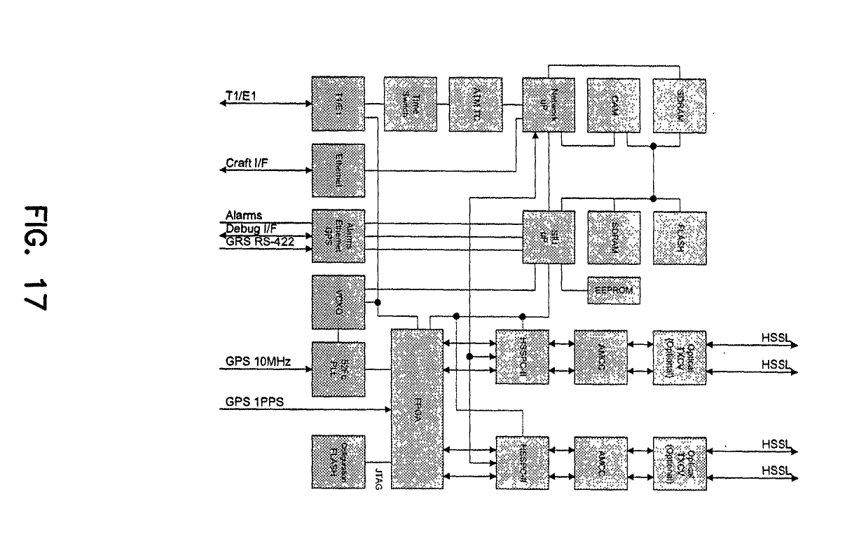

FIG. 17 illustrates an example implementation of the SIU 1604 of FIG. 16.

### Power Supply Module Block and Level

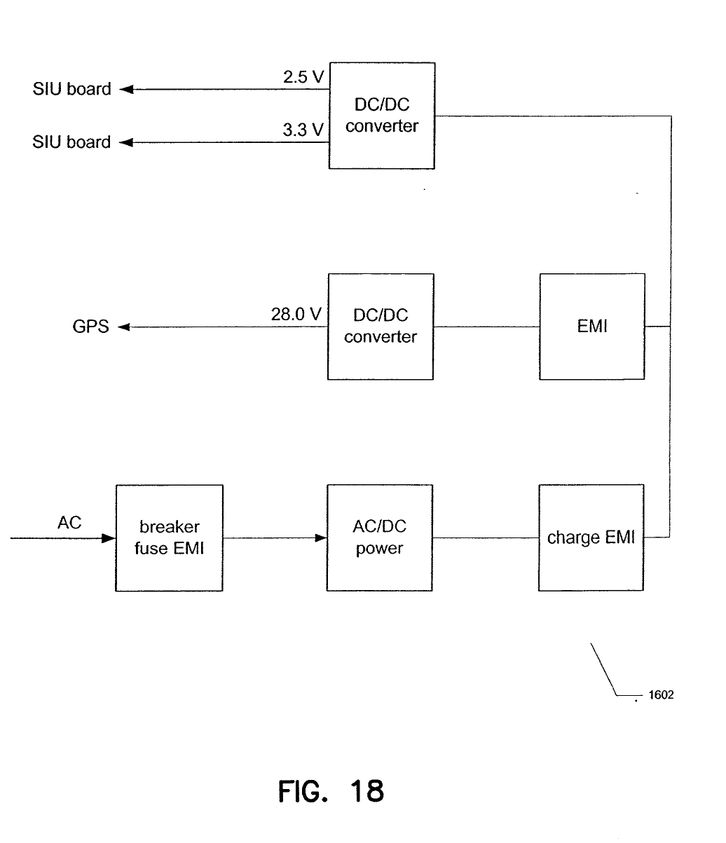

FIG. 18 depicts an example implementation of the power supply module 1602 of FIG. 16. Similar to the BTS appliance power supply module, the SIU power supply module 1602 supports a wide range of AC input power levels and internally rectifies and coverts AC power to DC power levels.

The power supply module 1602 can alternatively incorporate a discrete design instead of a modular PUP design. Cost, reliability, availability and flexibility trade-offs would inform the choice of architecture for the power supply module 1602. Similar to the BTS appliance power supply module, SIU power supply module preferably provides power for GPS module and GPS Smart Antenna. 28V is selected for GPS to allow sufficient drop voltage for GPS Smart Antenna. In addition, power supply module optionally also incorporates a −48V battery backup.

### SIU Hardware Interfaces

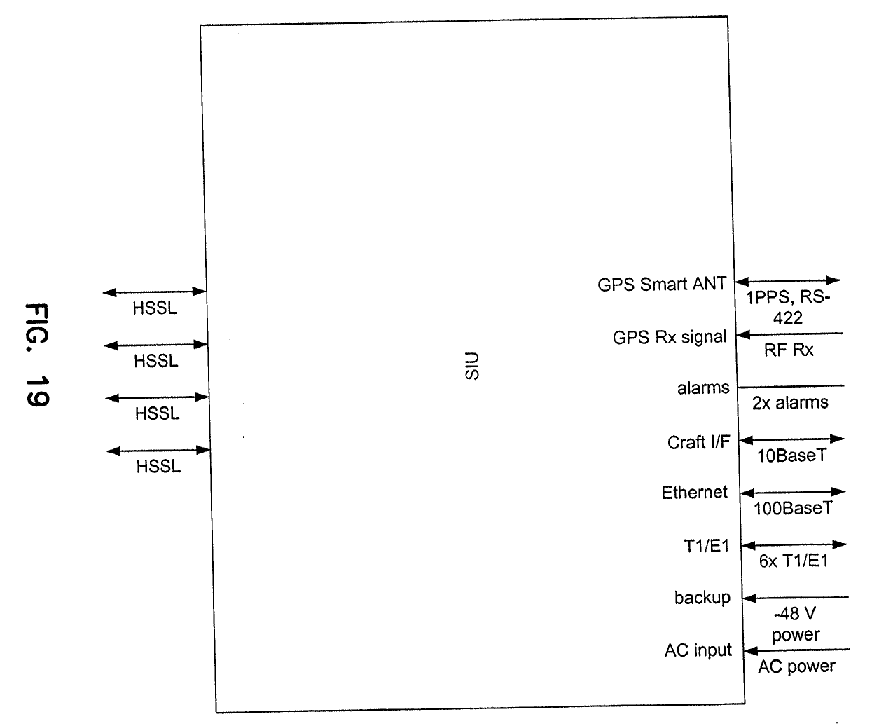

FIG. 19 illustrates the external interfaces of the SIU. These include an AC power supply and a −48 V DC battery backup, six T1/E1 interfaces, a 100BaseT interface, a 10BaseT interface, two alarm interfaces, an RF antenna interface, a GPS Smart Antenna interface, and four HSSL interfaces.

### Multi-BTS Functional Architecture

### Multi-Sector BTS Appliance Without SIU Functional Architecture

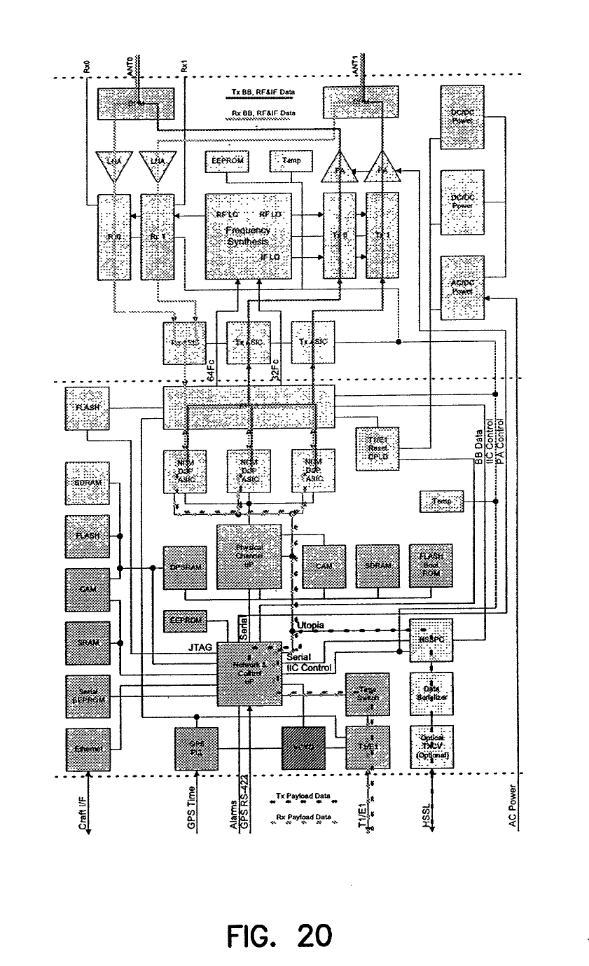

FIG. 20 depicts the data flows for a bi-sector BTS appliance without an SIU. Starting at the bottom of FIG. 20, the packets carrying user data are received via the T1/E1 interfaces on both BTS appliances. For UMTS, it is AAL2-encapsulated ATM data, and for CDMA it is HDLC-framed BCN data.

### UMTS Data Flow—Transmit

Referring to FIG. 20, the T1/E1 links are terminated by the network/control processor and the ATM data passed to the internal UTOPIA-2 bus (AAL2->AAL0). The slave BTS appliance routes the ATM cells to the HSSL link, where it is passed to the master BTS appliance. The master performs the backhaul grooming and routes the ATM cells either to the local modem ASIC or over the HSSL back to the slave BTS appliance modems.

The modems receive the ATM packets and generate the baseband data. This baseband data is sent through the FPGA, which determines whether to transmit the data on the local antenna or forward to the HSSL for the other sector. It is then transmitted to the antenna(s) through the Tx ASIC and RF filters and amplifiers.

### UMTS Data Flow—Receive

If diversity is present, the two RF signals are brought to the Rx ASICs and eventually to the modem. The modem handles the diversity algorithm and generates the user data from the baseband data. The user data is sent out on the UTOPIA-2 bus to the network/control processor, either the local processor or the processor on the other BTS appliance via the HSSL. The network/control processor will format the data for the T1/E1 link and send it out on the appropriate T1/E1 either locally or on the other BTS appliance via the HSSL.

### CDMA Data Flow—Transmit

The T1/E1 links are terminated by the network/control processor and the BCN data is routed via the UTOPIA-2 bus to the local modem ASICs, or via the HDLC serial link to the HSSL and eventually to the modem ASICs on the partner BTS appliance. The modems generate the baseband data and send it to the FPGA which determines whether to transmit the data on the local antenna or forward to the HSSL for the other sector. It is then transmitted to the antenna(s) through the Tx ASIC and RF filters and amplifiers.

### CDMA Data Flow—Receive

If diversity is present, the two RF signals are brought to the Rx ASICs and eventually to the modem. The modem handles the diversity algorithm and generates the user data from the baseband data. The user data is sent out on the UTOPIA-2 bus to the network/control processor, either the local processor or the processor on the other BTS appliance via the HSSL. The network/control processor will format the data for the T1/E1 link and send it out on the appropriate T1/E1 either locally or on the other BTS appliance via the HSSL.

In FIG. 20, only the BTS appliance data flows are shown. The SIU data flow is conceptually much simpler since it just routes user data to the appropriate BTS appliance and performs backhaul grooming.

This description starts at the bottom of the figure at the T1/E1 and HSSL interfaces. Note that UMTS does not plan to use this configuration at this time, but the architecture supports this configuration for UMTS and therefore it is described to preserve it for future consideration.

The packets carrying user data are received via the T1/E1 interfaces on both BTS appliances. For UMTS, it is AAL2 encapsulated ATM data, and for CDMA it is HDLC-framed BCN data.

### UMTS Data Flow—Transmit

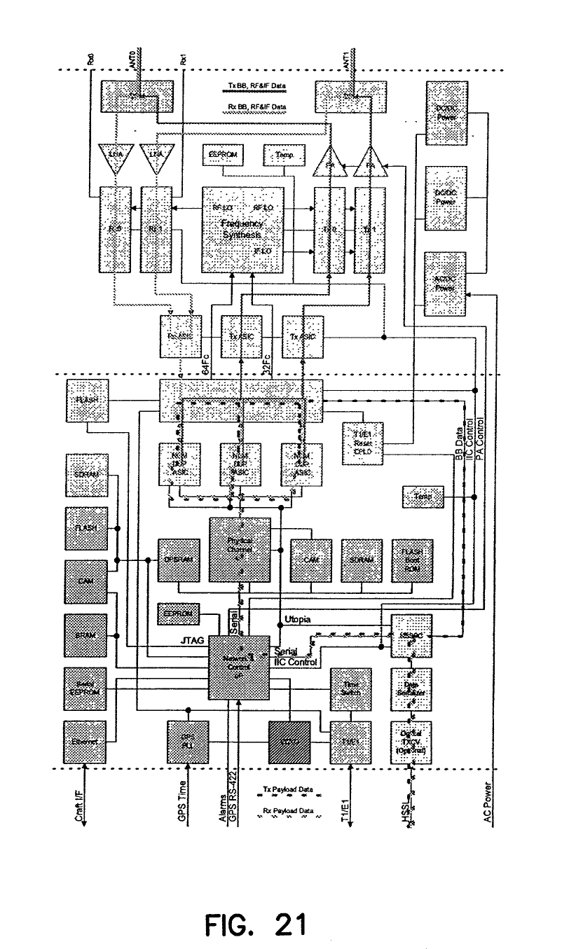

FIG. 21 depicts data flows for a two- or three-sector BTS appliance with a central SIU, according to another embodiment of the present invention. The T1-E1 links are terminated by the network/control processor on the SIU (not shown) and the ATM data passed to the HSSL links to the BTS appliances. The ATM cells are passed directly to the local modem ASIC.

The modem receives the ATM packets and generates the baseband data. This baseband data is sent through the FPGA, which determines whether to transmit the data on the local antenna or forward to the HSSL for another sector. It is then transmitted to the antenna(s) through the Tx ASIC and RF filters and amplifiers.

### UMTS Data Flow—Receive

If diversity is present, the two RF signals are brought to the Rx ASICs and eventually to the modem. The modem handles the diversity algorithm and generates the user data from the baseband data. The user data is sent out on the UTOPIA-2 bus to the HSSL and eventually to the SIU. The SIU network/control processor will format the data for the T1/E1 link and send it out on the appropriate T1/E1.

### CDMA Data Flow—Transmit

The T1/E1 links are terminated by the SIU network/control processor and the BCN data is passed to the HSSL and eventually to the modem ASICs on the appropriate BTS appliance. The modems generate the baseband data and send it to the FPGA which determines whether to transmit the data on the local antenna or forward to the HSSL for another sector. It is then transmitted to the antenna(s) through the Tx ASIC and RF filters and amplifiers.

### CDMA Data Flow—Receive

If diversity is present, the two RF signals are brought to the Rx ASICs and eventually to the modem. The modem handles the diversity algorithm and generates the user data from the baseband data. The user data is sent out on the UTOPIA-2 bus to the HSSL and eventually to the SIU. The SIU network/control processor will format the data for the T1/E1 link and send it out on the appropriate T1/E1.

### Multi-Carrier Functional Architecture

For a multi-carrier BTS, the physical connections between the SIU and the BTS appliance are identical to the multi-sector BTS configuration. The major difference is that both BTS appliance support the same “sector” but are assigned different carriers. No baseband data will be transmitted via the HSSL links to the other BTS appliance. Otherwise, the data flows are similar to those shown for the multi-sector BTS.

### BTS Appliance and SIU User Interfaces

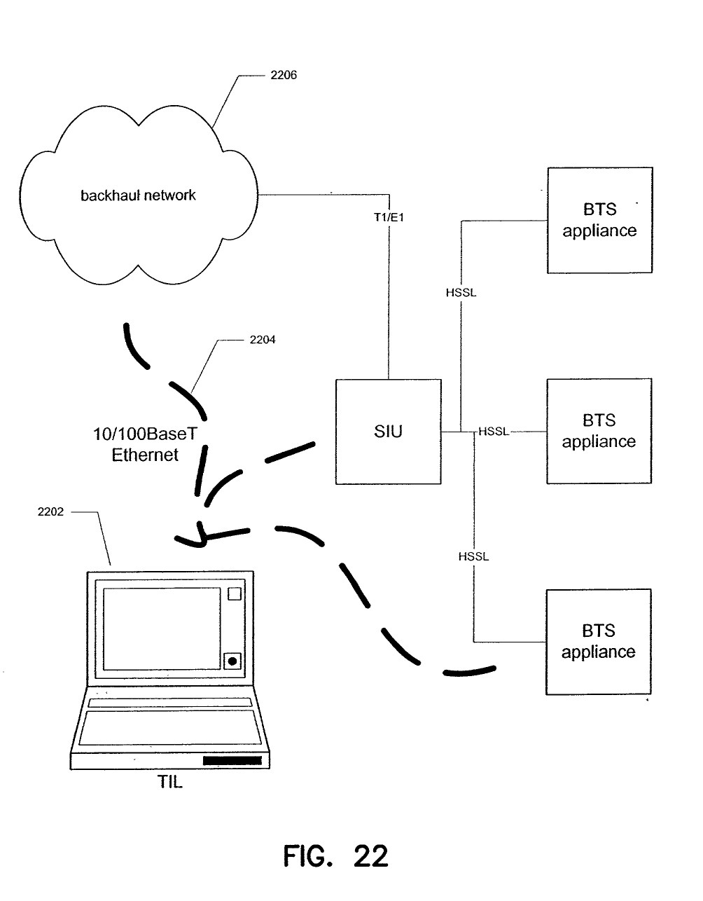

FIG. 22 depicts an example TIL connection strategy for connecting a PC (TIL) 2202 to a network. The PC (TIL) 2202 can be connected via an Ethernet connection 2204 at any point in the network, and has full OA&M capability at the BTS, as well as access to other network services such as the BSSM element manager, MTX MAP screens, customer intranet web pages, and the like.

The craftperson user interface (the BTS appliance human-machine interface, or HMI) is implemented on the PC 2202 by a Web Browser with full Java support. The PC 2202 is connected to the BTS via any of the following Ethernet ports at the BTS:

BTS appliance 10/100 Base-T craft interface port

SIU 10/100 Base-T interface port

The PC 2202 is also connected to the BTS through a UMTS/CDMA backhaul network 2206 via any network connection point, as shown in FIG. 22.

This interface is used for installation, maintenance, and alarm notification. Installation includes minimal commissioning, including parameters to set up the link with the BSC/OMC-B, as well as software downloading when the BTS appliance is not connected to the BSC/OMC-B. Maintenance includes getting status information, e.g., hardware/software configuration and testing results, providing inventory functions, and executing tests on demand. These tests may include site test unit (STU) device control and test call control/monitoring, Markov call generation/monitoring, network interface loopbacks, and internal interface loopbacks.

Connection to a BTS is done by typing in a URL or selecting from a list of URLs either stored in a file on the PC 2202 by the customer, or on a customer's web page stored on their own equipment on their intranet. A domain name server (DNS) may be used to abstract the numerical IP address and provide more meaningful BTS addresses.

The initial connection is to an HTTP server on the SIU (in a multi-sector BTS) or on the BTS appliance (in a single-box BTS). The HTTP server returns a Java applet that implements the HMI graphical user interface (GUI). The applet runs on the TIL 2202 and initiates a separate TCP/IP connection to the STU on another TCP port for queries, commands, and responses. The bulk of the messaging traffic is performed over this second socket link.

The GUI itself is a representation of the services, facilities, and equipment at the cell site, allowing for efficient determination of the health and configuration of the cell site. Alarms and states are presented next to the equipment or facility with which they are associated, and commands are executed by clicking on or next to the equipment or service. This will provide the operator with intuitive context information that helps with understanding the state of the site and makes maintenance actions easier.

The HMI is dynamic. While the TIL is connected to the BTS, any changes in the BTS configuration or state are reflected in the HMI view in near-real time. This provides immediate feedback to the craftsperson about the effect their actions are having at the BTS, allowing for quicker recovery from errors and confirmation that actions have completed successfully. In addition, commands that require more than a moment to execute have their execution status displayed and updated to provide an indication of when the action will complete. For example, during a download a progress bar keeps track of the number of bytes sent in total.

One of the goals for the HMI is to avoid any custom software that must be installed on the TIL 2202. All functionality is preferably provided by the Java applets served from the BTS.

### Software Architecture

### Overall Considerations

The BTS appliance software uses BTS converted DW architecture based on UMTS RTC++, COAM and slave-based SW architecture for UMTS, CDMA and 1XEV applications running on the BTS appliance. Further, BTS appliance platform software commonality is maximized for use by UMTS, CDMA, and 1XEV applications by using the same software platform, drivers and slaves whenever possible. The SIU software is designed with a multiple BTS appliance configuration in mind. The same SIU software is also used in a single BTS appliance configuration.

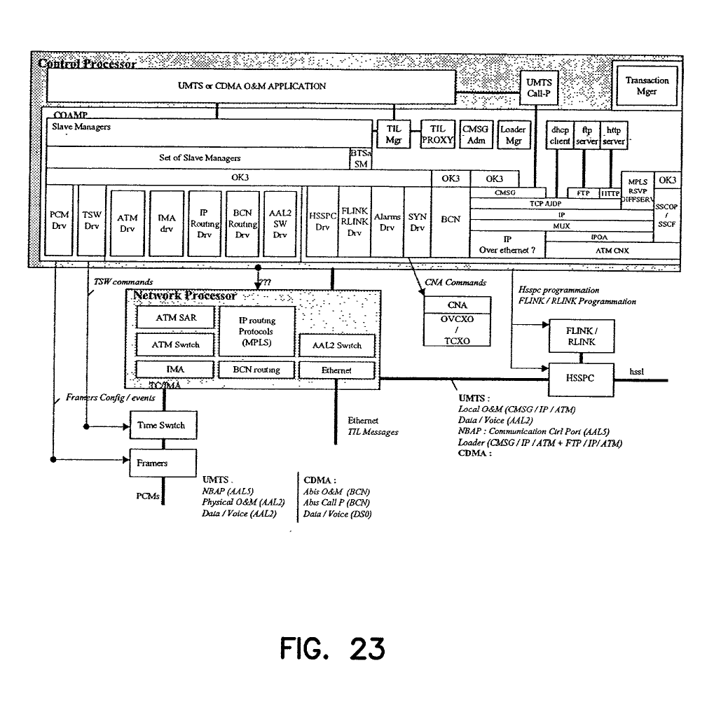

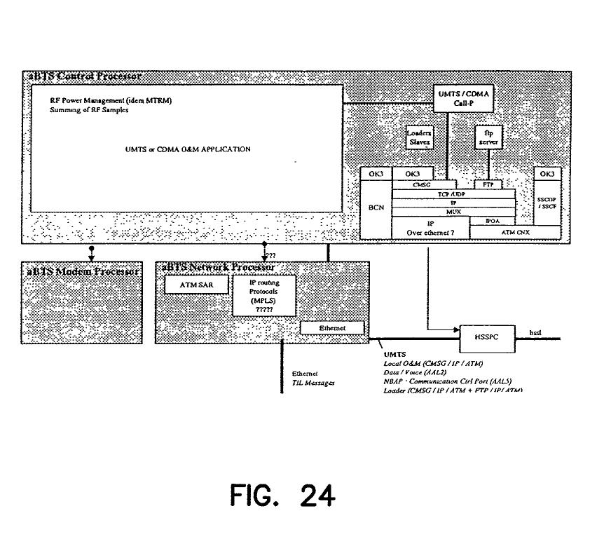

FIGS. 23 and 24 depict example software architectures used in the BTS appliance. FIG. 23 illustrates a platform-centric architecture.

### BTS Appliance Software Architecture

The BTS appliance is divided into the following architectural domains: platform, OA&M (which is further divided into physical and logical OA&M), and call processing (which is further divided into common and technology-specific call processing).

In this description, some blocks are described as running on the SIU and others on the BTS appliance box. This distribution refers to the three-sector configurations made of one SIU and three BTS appliance boxes. For the omni-configuration, where there is only one BTS appliance box, the SIU and BTS appliance software run on the same unique BTS appliance box.

### Software Components and Locations

Some software components run on SIU and BTS appliance control and physical channel processors for all configurations/applications. These components include the basic platform (non-RoseRT), which includes RTC++ with HA extensions, CMSG, logging and debugging utilities, flash management, flight recorder, frameworks for fault, performance (OMs), and test management. Protocol stacks for communications within BTS appliance and between SIU and BTS appliances are also run on SIU and BTS appliance control and physical channel processors for all configurations and applications. These are different by application, e.g., ATM and IP for UMTS, and BCN and IP for CDMA and 1xEV. IP protocol stacks for communicating over craft Ethernet ports are also run on SIU and BTS appliance control and physical channel processors.

Other components are run on the SIU in a multi-configuration, but on the BTS appliance control processor in a standalone configuration. These include:

Self-discovery of hardware and software versions and configurations (common)

Control and access software for EPROMs for commissioning data (common)

COAM base architecture (Transaction, Duplex (for redundant configurations) and Generic Slayer Managers, OK3) using RoseRT (common)

OA&M applications on top of COAM architecture using RoseRT, including MIB/object model management (different for UMTS, CDMA and 1xEV applications)

External OA&M message handling (different by applications, e.g., UMTS NBAP using ASN. 1, CDMA QMIP or equiv over IP)

Terminating/switching protocol stacks for backhaul traffic (OA&M, signaling and bearer) (different by application, e.g., IMA, AAL2 and AAL5 for UMTS99, IP for UMTS2000, BCN for CDMA2000, IP for CDMA Abis, IP for 1xEV)

Backhaul slave for control and status of E1/T1s, configuration, test, fault management (common)

Time switch slave for backhaul drop and insert (common)

Routing signaling and traffic messages to BTS appliance CEs

SYN slave for backhaul synchronization (may be need only in UMTS)

GPS slave for status and control, TOD broadcast and even second signal generation/reference selection for FPGAs (common)

Software download management based on File 0 (common)

Local Installation Terminal based on a web server sending applet to a web browser (common web server, applet may differ)

Still other components are only run on the SIU:

Drivers and device management software (configuration, test and fault management) for all hardware on the SIU (common)

HSSL slave manages HSSPC's including parity fault management and time delay measurement (common)

Baseband switching slave manages FPGA for baseband switching and possibly addition (FLINK/RLINK) (common)

SIU resident customer alarm inputs/control points (common, site configurable)

Duplex slave in the case of redundant SIUs or redundant boards within the SIU.

The following components run on each BTS appliance control processor in both standalone and multi-configurations:

Drivers and device management software (configuration, test and fault management) for all hardware on the BTS appliance (common)

BTS appliance slave manages RF configuration, RF Tx Power Control (PA & AGC), RF monitoring, PA (over RS485), FLINK/RLINK, HSSL (including parity error fault management), temperature, AC/DC power, power supply, customer alarm inputs/control points, monitoring/managing PCP—same slave should be applicable to UMTS, CDMA and 1XEV applications

BTS Test (STU) manages a mobile phone for over-the-air testing of BTS appliance (differ between UMTS and CDMA)

Paging/access channel management (part of UMTS and CDMA application).

Other components can run on the SIU or BTS appliance control or physical channel processors in multi-sector configurations, or on the BTS appliance CP or PCP in a standalone configuration. These include, for example, radio resource management of CE pools, forward power allocation, Walsh codes, carrier selection, transmit diversity, and call processing address assignment (different for UMTS, CDMA and 1xEV), and 1XEV forward control and traffic channel (data burst) scheduling and BSC flow resynchronization after handoff (part of 1XEV application).

The following components run on the BTS appliance physical channel processor in both multi- and standalone configurations, and are specific to UMTS, CDMA or 1xEV applications:

Monitors and reports faults on modem DSPs and ASICs

Controls loading and initialization of DSPs

Relays signaling and traffic streams to and from modems with some transformations

Decoding and execution of signaling messages (uses NBAP over ASN. 1 in UMTS, NOIS or Abis in CDMA)

Schedules and formats messages for overhead channels (e.g., CDMA paging and quick paging channels, UMTS BCCH)

Generates forward power reports

Reverse channel power control

Handoff CE allocation and load balancing

CE to RF link switching and control (already done by RRM?)

Generates Markov call data

### Platform

The platform is a set of software modules on which O&AM and call processing modules rely. The platform is closely linked to card hardware and so is different between BTS appliance box and SIU, even if they share a lot of commonalties. It is common between UMTS and CDMA configurations as long as the hardware is common.

The platform is made of several major subdomains:

Startup/Boot/System Initialization

Real-Time Operating System (RTOS) (VxWorks)

Base Platform

### Startup/Boot/System Initialization

The startup/boot/system initialization module starts the board, executes BISTs (built-in self tests), and brings the BTS appliance to a fully initialized state. It does not include commissioning done by the craftsperson, only automatic commissioning and configuration steps based on stored commissioning information or default values.

Starting the board includes executing a “Boot Boot” (BB) routine that sets the chip select lines, initializes any memory controller, and selects “Boot Level 2” (BL2). It also includes executing “Boot Level 2” (BL2), which runs the minimal BISTs and selects and loads “Boot Level 3” (BL3). Finally, starting the board also includes executing “Boot Level 3” (BL3), which is an applicative boot based on a command file.

System Initialization means includes, once the RTOS has initialized, initializing all of the other domains in the appropriate order, managing startup dependencies, and restoring system configuration information from the Non-Volatile Store (NVS).

### Real-Time Operating System

This module is composed of the VxWorks Real-Time Operating System (RTOS), customized for the BTS appliance/SIU hardware via a Board Support Package (BSP).

The RTOS provides several services, including, but not necessarily limited to:

Multitasking

Callback timers

Watchdog

Semaphores

Mailboxes

Events

Delays

Memory management (VxWorks heap or RTC++ buffer memory space)

Queues

State Machine

Hardware interruption management

Logical interruption

Exception/Error handling

TTY management

Board Management

Board Support Package

Bootstrap mechanism (start board, execute BISTS)

Linker

Incremental (Gates)

Dynamic

Debug suite

OS traces

Mailboxes

ITL

Watchdog messages

Queues

Robots

Memory

Free traces

User-defined trace points

ASCII or hexadecimal traces

32 bits mask filter

forced traces

Scheduling traces

Trace of the task context switch

Traces are stored into a RAM circular buffer

on the flight upload

on command upload

Post mortem fault log/crash dump

Debug shell

Built In Self Tests

Device drivers (AALx, Ethernet, 12C, HDLC, etc.) needed by the communication stacks (TCP/IP, ATM) and the hardware specificity (memory time switch, ATM switch, synchronization management, etc.).

T1/E1 Driver (a.k.a. PCM Driver)

Timeswitch Driver

ATM Driver (UMTS)

IMA Driver (UMTS)—ATM Inverse Multiplexing

IP Routing/Switching Driver

BCN Router Driver (CDMA)

AAL2 Switch Driver (UMTS)

HSSPC-II Driver

FLINK Driver

RLINK Driver

Environmental Driver (Customer Alarms/Control Points)

SYN Driver (T1/E1 Synchronization)

12C Driver

HDLC Driver

DPSRAM Driver

MCC Driver

SMC/Console Driver

10/100 Base-T Driver

RS-485 Driver (for PA)

RS-485 Driver (for GPS)

LED Driver

Data transfer for downloading microcontrollers, DSP, and FPGA

Flash file system (with Unix I/O style access)

Communication Protocols: all the communication stacks needed by the system.

These protocols can be off the shelf S/W included and adapted to the product, or BTS APPLIANCE-specific development. The protocols needed are:

Internet Protocols—IP, TCP, UDP, MPLS, HTTP, FTP, DHCP, DNS, DiffServ, RSVP, PPP, RTP, and others

ATM Protocols—ATM, AAL2, AAL0, AAL5, SAAL, QSAAL, IPoA, SSCOP, SSCF

CDMA Protocols—BCN, ACN

Application Protocols—CMSG, OK3, ASN. 1

Standard Template Library (STL)

### Base Platform

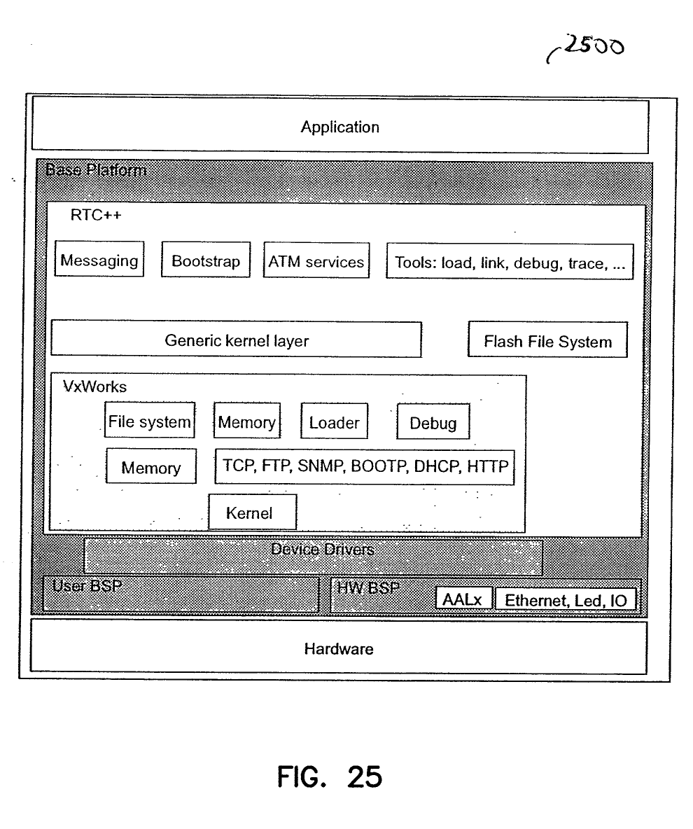

FIG. 25 illustrates an example base platform architecture 2500, according to another embodiment of the present invention.

### OA&M

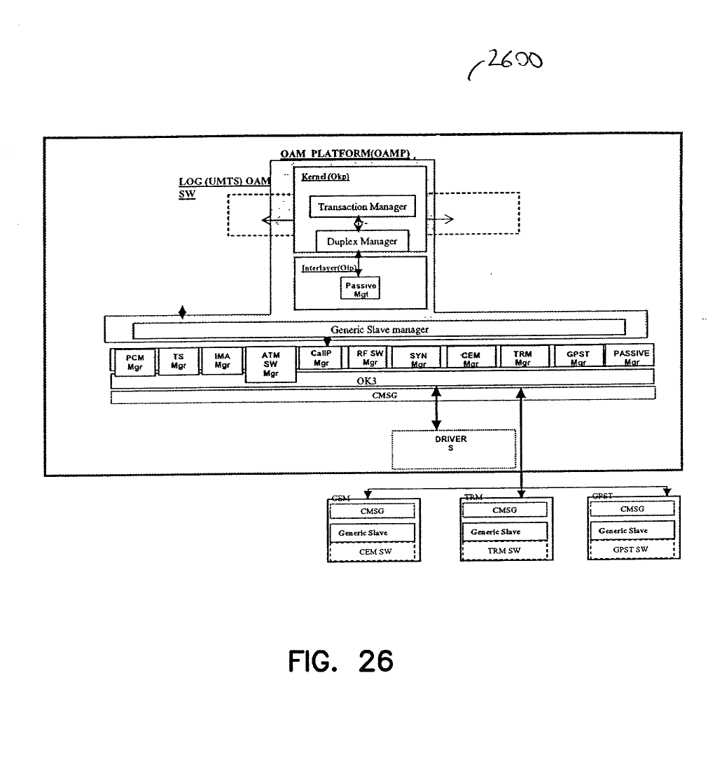

The OA&M architecture is divided into three components. A platform OA&M component is a hardware abstraction layer, and is illustrated in FIG. 26. A physical OA&M component represents a view of the Node-B from an OMC-B point of view, and a logical OA&M component represents a view of the Node-B from an RNC point of view. In a CDMA configuration, there is no distinction between the physical and logical OA&M components; the BSM handles both aspects.

Table 3 below highlights several points of distinction between the physical and logical OA&M components.

TABLE 3
Differences between Physical and Logical OA&M

| Physical OA&M | Logical OA&M |
|---|---|
| Equipment- and Implementation- | Independent of a given |
| Specific Parameters and Status | manufacturer's equipment |
| Changing these parameters does not | Parameters concerned with the |
| directly affect the operation of the | interaction between the mobile |
| air interface | terminal and the base station |
| Affects parameters related to | Affects parameters that define the |
| maintaining the equipment and | service provided by the BTS to the |
| software | mobile user |
| Administered by OMC-B in UMTS | Administered by RNC/OMC-R in |
| | UMTS |

### Platform OA&M

FIG. 26 illustrates an example platform OA&M architecture 2600. The platform OA&M component 2600 includes a set of components that are not “system dependent”:

Fault Management Framework

Performance Monitoring Framework (for Operational Measurement gathering/reporting)

Support of ObjecTime/RoseRT environment (RoseRT microkernel)

Transaction management

Duplex management

Slave managers (dedicated to control of a board or driver)

Slave data management (I&C)

General hardware equipment manager

Trap management

Transport layer abstraction management (OK3)

Download

Interface with TIL GUI

### Download

One of the components of the platform OA&M component 2600 is a download component. This component downloads and activates software on the BTS appliance. It can be done during first installation or upgrade for both CDMA and UMTS software. Requests can come from many entities (OMC-B, TIL). The download component is also used to internally upgrade a card when software is locally available on the BTS appliance, based on plug-and-play principles.

To download a file or files, an external entity first negotiates downloading of the file or files. Negotiation is based on software versions proposed versus hardware and software currently installed, in addition to some configuration parameters. Depending on the result of the negotiation, the download request is either accepted for used files not already available in BTS appliance, or rejected. Next, the files to be downloaded are transferred the passive file system of the card or cards, either through a RAM disk for external files, or from another FFS if the file is available locally to the BTS appliance. The file system is then activated so that it is used during next reboot. Next, the card is usually reset so that the files get loaded into memory.

The iBTS loader makes use of two connections: control (proprietary protocol on TCP) and data (FTP). The general plug-and-play principle is that a card with an invalid software version on any FFS is automatically updated from another card of same type available in the BTS appliance. If a local copy cannot be performed, a file transfer is requested. After the update, the software is automatically activated, and a card reset request is sent by the download component to the OA&M component.

FIG. 27 depicts an example download component architecture 2700. The download component is made of a hierarchy of cooperating agents (registry slaves or duplicator slaves). Each agent provides a base function and registers to its parent (download controller) when started. Thus, the top agent dynamically receives the status of the iBTS, including the number of cards with their HwRef and SwRef and list of slaves with proposed services.

This architecture 2700 offers a number of advantages. For example, the whole system can be dynamically configured. Changing components is easily performed, and fault tolerance is enhanced. Registry slaves and duplicator slaves are generic. They can run on any type of card, such as a BTS appliance or SIU. They regularly send an ‘IAmAlive’ message to the download controller so that it keeps track of their availability. The download controller, which is the central managing entity, runs only on the SIU.

Accordingly, the download component implements only two levels of agent: slave and master. In the case of extra requirements, however, it is easy to enhance this system by adding new features, such as service registration, an extra level of agents, configurable agent presentation, and a grammar-based protocol.

### Local Installation Terminal (TIL)

FIG. 28 depicts an example TIL communication architecture 2800 for interfacing between a BTS appliance and a TIL. The 3G TIL is the new generation of Local Installation Terminal. The TIL includes a number of human-machine interface (HMI) display-related functions stored in an HMI library, including, for example, data entry templates, graphing routines, data display routines, HTML generation, progress bar routines, and the like.

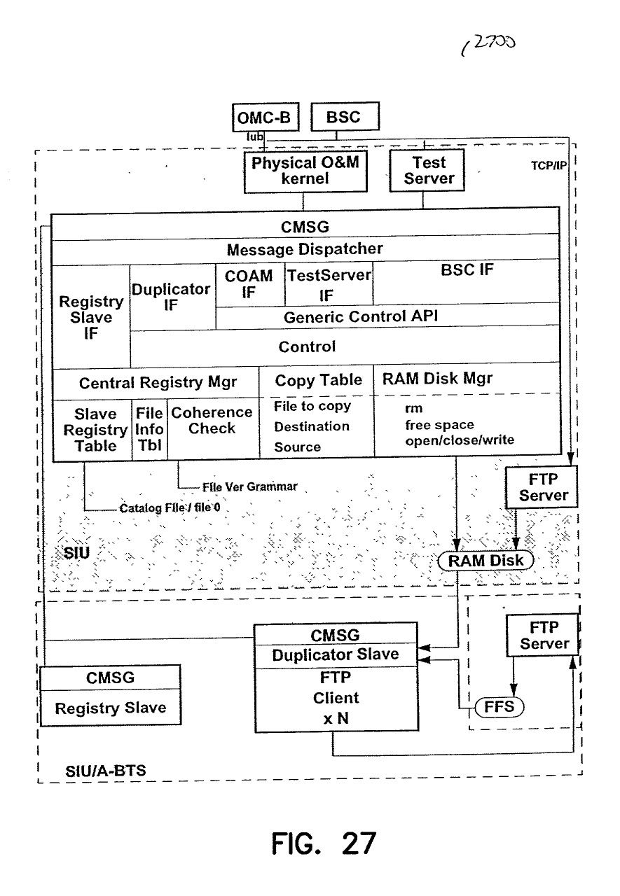

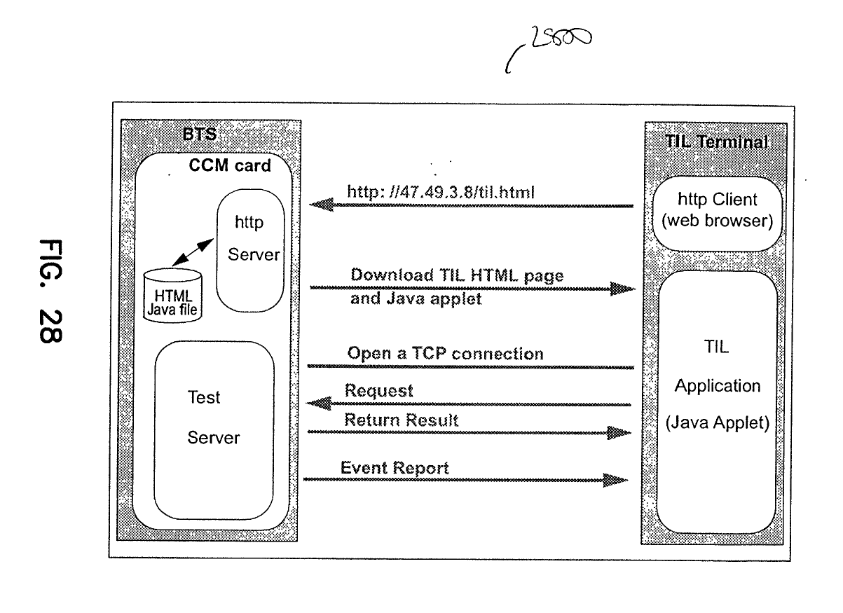

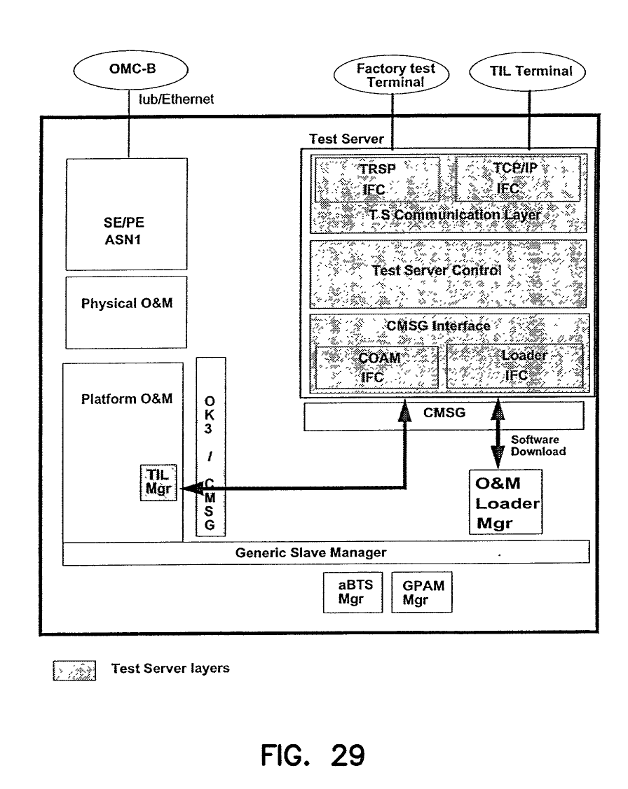

Preferably, the TIL GUI is implemented as a Java applet embedded on the SIU Flash. An HTTP server running on the BTS appliance is used to download an applet onto a PC. A test server (proxy between OA&M and TIL GUI) runs also on the SIU and implements a TCP/CMSG adaptation layer, in addition to some routing between the OA&M and download components. An example test server 2900 is depicted in FIG. 29.

A part of this tool runs on the SIU/BTS appliance and provides a proxy between the OA&M and TIL GUI components. It is made of an HTTP/Java applet server, a test server (TCP/CMSG proxy), and a TIL manager (OA&M proxy).

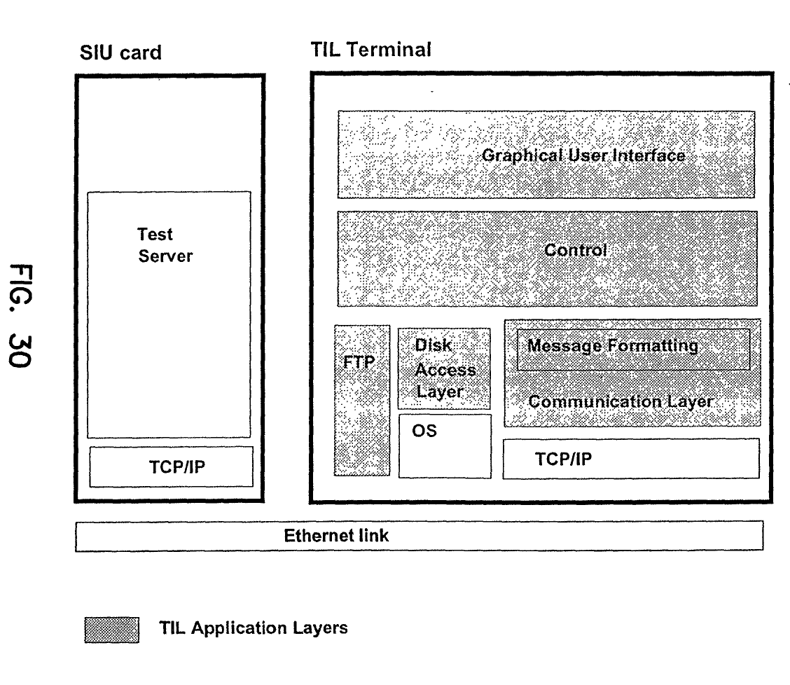

FIG. 30 depicts an example arrangement of TIL application layers.

### Physical OA&M

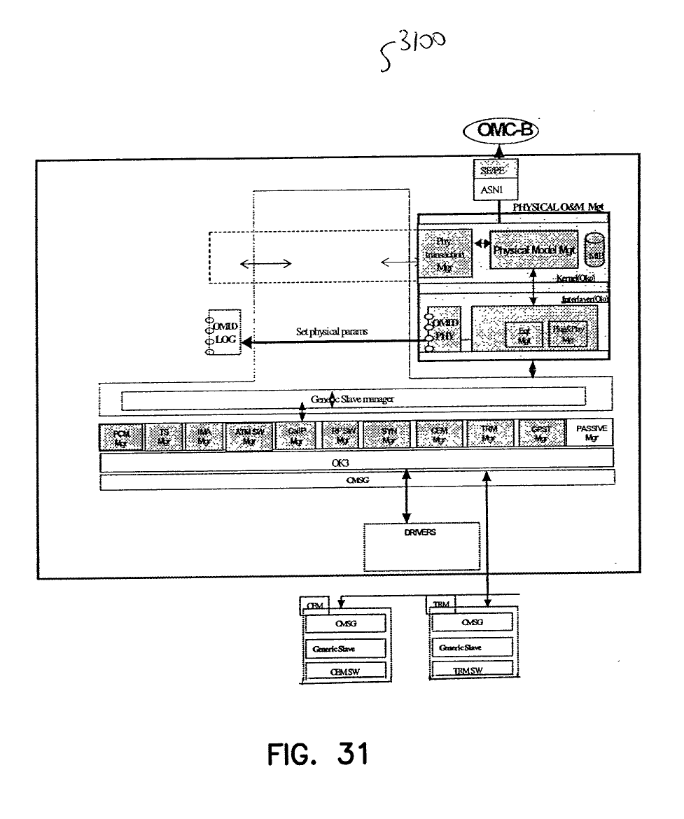

FIG. 31 illustrates an example physical OA&M module 3100, which is responsible for initialization, control, and fault/status monitoring of the physical hardware and equipment-dependent software. The physical OA&M module is responsible for a number of functions, including:

Physical Equipment Inventory & Status Display

Hardware configuration report from:

RX channelizer

TX channelizer

HSSPC

Card Status Display: Alarm/Active/Enabled

Fault Monitoring Framework

RF Equipment Administration, Status and Fault Monitoring

Including RF clock synthesis block, Tx and Rx RF paths, interfaces with the digital board, and the internal/external PA.

Transmit Parity Error Detection and Reporting

PA and RF equipment Management

Digital Equipment Administration, Status and Fault Monitoring

FLINK/RLINK ASIC Management

Including receive baseband data parity error fault detection and reporting.

FPGA fault management

Even Second Signal Generation from Pulse-Per-Second Signal to FPGA.

FPGA Reference Frequency Selection

Synchronization Algorithm for T1/E1 Clock Regeneration

other digital devices/functions

Internal BTS Interface Equipment Admin/Status, Fault Monitoring

Baseband interface fault

Optical interface fault

HSSL Management

Including serial data receive parity error fault detection and reporting. Also includes the delay measurement between HSSL transceivers to properly schedule baseband data packets.

Network Interface Equipment Admin/Status, Fault Monitoring

Network self-configuration, flexibility, and accessibility are considerations here.

T1/E1 Operations, Administration, & Maintenance (line buildout, superframes, T1/E1 selection, etc.)

T1/E1 Timeswitch Management (Drop & Insert, Loopback, Auto-Configuration, etc.)

Switch/Router Admin/Status, Fault Monitoring (IP Switch, BCN Router, ATM Switch)

Network Address Determination (DHCP, etc.)

Network Operations—QoS, protocol translations and packet relays, network robustness, etc. are considerations here.

BCN Packet Routing

ATM Cell Switching

ATM AAL2 Packet Switching

Internet Protocol (IP) Packet Switching/Routing

ATM Packet Segmentation and Reassembly

Power System Admin/Status, Fault Monitoring

System Time Of Day Maintenance, Time-Of-Day Broadcast

Built In Test (BIT) Support (Operator-initiated, background, and fault recovery automatically initiated)

In-Service

Out-of-Service

CDMA Frequency Control

Application software management (storage, start/stop download, etc.)

SIU Duplex Management

BTS appliance Triplex Management (Mastership Selection) (if applicable)

Physical Operational Measurements (collection and control/display)

Operational Measurement Graphing/Trending

Audits

Link (T1/E1, HSSL, RS485, 12C, etc.)

Call processing (or No Call processing. . .)

Software Sanity

Peer (other BTS appliance sectors) or BTS appliance<>BTS appliance

SIU<>BTS appliance

Mastership/Duplex

Log Management for Physical OA&M (clear/upload/filter/summarize logs)

BTS appliance Internal Temperature Monitoring

Customer Alarm Inputs

Customer Control Outputs

GPS Status and Control

BTS appliance Human-Machine Interface (HMI) (a.k.a. “TIL”)

Load Management

System/Module Reset

Performance Monitoring

Including CPU load, link utilization on HSSL, T1/E1, and all other packet-based links, call processing metrics, and other system health indicators such as uptime, availability, etc. This includes all Operational Measurements (OMs).

Commissioning Data Management & Storage

MIB Management

Duplex Management

### Logical OA&M

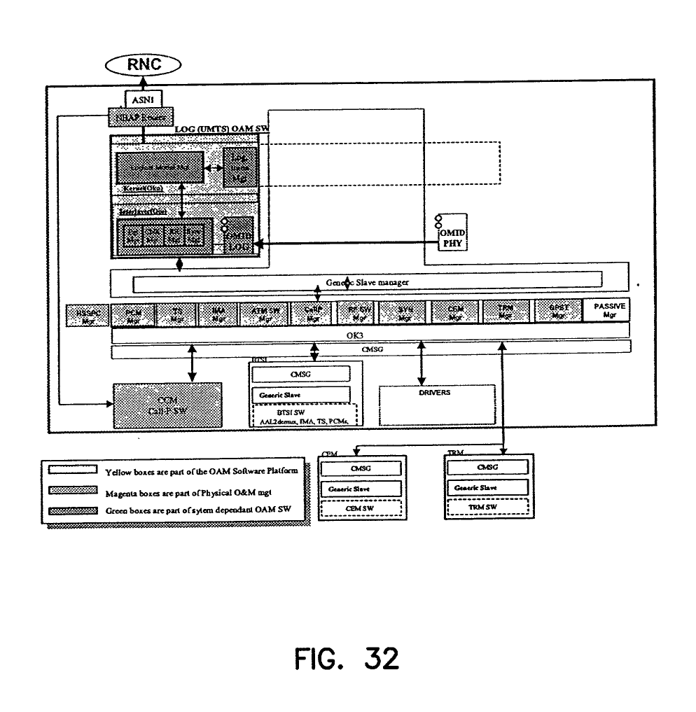

FIG. 32 illustrates an example logical OA&M module 3200, which deals with the logical model as seen by the RNC through the Iub Interface in UMTS applications only. It analyzes the sequence and syntax of the incoming configuration messages. If everything is correct, messages are routed to the Interlayer, which executes the command on the hardware platform.

The logical OA&M module 3200 is also notified by the interlayer when an hardware event occurs. In turn, it notifies the RNC of the impact onto the logical Node B objects. The difference between the logical OA&M and call processing components is that the logical OA&M component deals with air interface settings that do not change from call to call, while the call processing component handles parameters that must be determined and controlled on a per-call basis.

The logical OA&M module 3200 includes an RF configuration component that provides the RF parameters required for the BTS to operate within the overall cellular network, such as channel settings, maximum power levels, cell ID, etc., to the BTS software during commissioning of the BTS at the cell site. These parameters are stored by both other BTS appliance units at the same cell site (in a multi-sector configuration) and by the BSC/OMCR. These parameters are preferably only entered by the customer once, preferably at a central location and for all BTSs at once. Thereafter, during initialization the BTS appliance should restore the RF configuration by querying other BTS appliances at the cell site or the network management entity.

To the extent possible, the BTS appliance determines these settings automatically by, for example, querying the cell site inventory and deducing the sectorization, or provides reasonable defaults. The operator will have the ability to change these default or automatic settings.

The logical OA&M module 3200 also performs ASN. 1 encoding and decoding, including use of an abstract symbolic notation to encode/decode messages. The logical OA&M module 3200 also provides a logical cell site functional status display, log management for logical OA&M (clear/upload/filter/summarize logs), BTS self testing for testing proper operation of the call processing module, and Markov call data generation.

### Call Processing (UMTS)

In UMTS applications, the call processing module is mapped on SIE and BTS appliance boards of the Node-B. Since the NPAP-c procedure is global to the Node-B whereas NBAP-d is dedicated to a UE context, the SIU is the terminating point for NBAP-c, and the BTS appliance box is the terminating point for NBAP-d. An ATM switch inside the Node-B is used to route these message flows. The call processing component on the SIU is responsible for NBAP management, including setting up and deleting cell contexts and common transport channel contexts, load balancing, IuB ASN1 coding and decoding, measurement management, and ALCAP management.

The call processing software on the BTS appliance is responsible for NBAP protocol management, including management of cell protocols, UE for DCHs, and protocols for common channels (BCCH, RACH, FACH, PCH) and dedicated channels (DCH, DSCH). The call processing software on the BTS appliance is also responsible for Iub ASN1 encoding and decoding, measurement reports, and power management, as well as interfacing with the OA&M component.

The call processing software on the BTS appliance also performs AR1 concatenation and deconcatenation of L3 messages, and provides a low level (read/write) interface to DSP clusters. Finally, the call processing software on the BTS appliance provides a radio/channelizer/ASIC interface.

### Call processing (CDMA)

CDMA call processing takes place almost entirely on the BTS appliance itself, rather than the SIU, and includes a call processing work distribution function, which distributes the handling of incoming radio resource requests from the BSC/RNC evenly across the individual appliance modules in a multi-sector BTS. CDMA call processing also includes radio resource management, channel element pool allocation and management, forward power allocation, Walsh code allocation and management, carrier selection, paging channel management, and access channel management. It also includes traffic frame layer 2 sequence number management, implementing a user traffic relay to the modem from a network interface, paging channel scheduling, and quick paging channel management. RF transmit power monitoring and control includes management of power amplifier coarse power settings and automatic gain control dynamic gain adjustments. Forward power reporting allows per-call forward power allocation.

The call processing module also provides load balancing BCCH generation in UMTS applications, channel element/RF link switching and control, and softer handoff channel element allocation in CDMA applications. The call processing module also provides 1XRTT per-call signaling relay to mobile functions, reverse channel power control, 1XEV forward rate scheduling and packet consolidation, and BSC 1XEV flow resynchronization after soft handoff.

### Protocol Interfaces

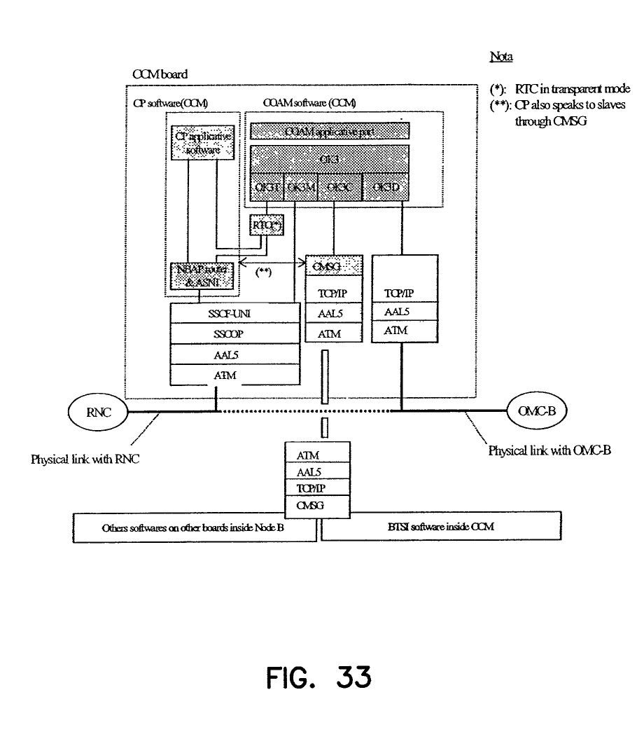

The software supports various kinds of protocol interfaces, including interfaces with RNC (Iub) and OMC-B, UMTS and CDMA radio interfaces, and internal interfaces, including CMSG and OK3. FIG. 33 depicts an example Node-B protocol stack architecture 3300.

### Data Transport

This section discusses how various types of data in the radio access network are transported between the Node B and RNC (for UMTS), and the BTS and BSC (for CDMA). The network between these nodes is referred to as the “backhaul network”. This section also discusses how data is switched between the SIU and BTS appliance, and within each of these boxes.

### Backhaul Network

The BTS appliance and SIU support a variety of backhaul network types for carrying data between the RNC/BSC and the Node B/BTS.

In one embodiment, the initial backhaul network for UMTS is defined by UMTS'99 standards to use ATM as the switching layer. Some of the data flows, namely, NBAP and user plane traffic, are transported directly over ATM adaptation layers AAL5 and AAL2, respectively. Other data flows, e.g., OMC-B, are transported using IP over AAL5 over ATM. In this latter case, the IP layer is not used for switching decisions.

In another embodiment, the initial backhaul network for IS-2000 uses BCN as the switching layer in order to allow backward compatibility with legacy BSCs and BCN networks. BCN is a proprietary, variable-length frame based protocol that uses bit-oriented HDLC for framing.

In another embodiment, the initial backhaul network for 1xEV-DO uses IP as the switching layer. The IP layer can be transported over a variety of data link layers (layer 2) and physical layers (layer 1).

As the standards evolve, it is expected that both the UMTS 2000 and IS-2000 backhaul networks will evolve to using IP as the switching mechanism over the backhaul network, at least as an option. Both the UMTS 2000 Iub and IS-2000 A.bis standards are currently investigating this path.

The following table summarizes the types of backhaul switching networks and underlying link and physical layers that are supported by the SIU and BTS appliance. While the SIU is intended to support all interface types, the BTS appliance supports only a subset.

TABLE 15
Backhaul Switching Network Types

| | | | | User-Plane | |
|---|---|---|---|---|---|
| | | | | Compression/ | |
| Backhaul | Switching | | | Mux | Supported |
| Standard | Network | Link | Physical | Method | at |
| UMTS’99 Iub | ATM | IMA | n x E1/T1 or | AAL2/SSAR | BTS |
| | | | FE1/FT1 | | appliance |
| | | STM- | OC-3 | AAL2/SSAR | BTS |
| | | 1/STS-3c? | | | appliance |
| IS-2000 | BCN | Multilink | n x E1/T1 or | None | BTS |
| Legacy | | BCN | FE1/FT1 | | appliance |
| | | | | | SIU |
| UMTS’00 Iub | ATM | IMA | n x E1/T1 or | AAL2/SSAR | BTS |
| IS-2000 A.bis | | | FE1/FT1 | | appliance |
| 1xEV-DO | | | | | SIU |
| A.bis | | | | | |
| | | STM- | OC-3 | AAL2/SSAR | BTS |
| | | 1/STS-3c | | | appliance |
| | | | | | SIU |
| | IP | ATM | n x E1/T1 or | TBD | BTS |
| | | | FE1/FT1 | | appliance |
| | | | | | SIU |
| | | Multilink | n x E1/T1 or | TBD | BTS |
| | | PPP | FE1/FT1 | | appliance |
| | | | | | SIU |
| | | PPP | STM- | TBD | SIU |
| | | | 1/STS-3c | | |
| | | | over OC-3 | | |
| | | Ethernet | 10/100Base | TBD | BTS |
| | | | TX | | appliance |
| | | | | | SIU |
| | | OPTera | OC-3 | TBD | BTS |
| | | Packet | | | appliance |
| | | Edge (TBD) | | | SIU |
| | IP over | ATM | n x E1/T1 or | TBD | BTS |
| | MPLS | | FE1/FT1 | | appliance |
| | | | | | SIU |
| | | Multilink | n x E1/T1 or | TBD | BTS |
| | | PPP | FE1/FT1 | | appliance |
| | | | | | SIU |
| | | PPP | STM- | TBD | SIU |
| | | | 1/STS-3c | | |
| | | Ethernet | 10/100Base | TBD | BTS |
| | | | TX | | appliance |
| | | | | | SIU |
| | IP over | OPTera | OC-3 | TBD | SIU |
| | Ethernet | Packet | | | |
| | | Edge | | | |

### Cell Site Switching

This section discusses the types of switching that are performed locally at the cell site, both between the SIU and the BTS appliance, and within a standalone BTS appliance. The type of switching network used over the wide area largely determines the type of switching used at the cell site. However, since local bandwidth is more abundant than wide area bandwidth, some simplifications are possible at the cost of reduced bandwidth efficiency.

Several types of local switching are supported, including ATM, BCN, IP, and Ethernet switching. These types are described more fully below.

### ATM Switching

ATM switching is used for the UMTS'99 standard. This allows some of the ATM-based software to be re-used from the iBTS.

Switching Topology

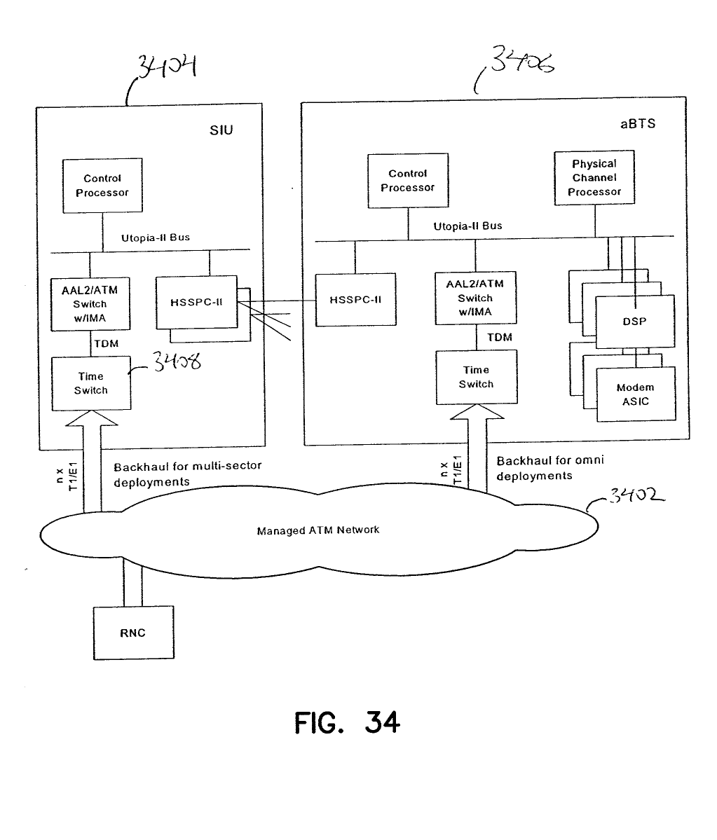

The topology of the ATM switching elements at the cell site is shown in FIG. 34. For a single-box deployment, the backhaul network is attached at the BTS appliance via one or more E1/T1 circuits. For a multi-box deployment, a backhaul network 3402 is attached at an SIU 3404. A similar set of switching elements is used in the SIU 3404 and BTS appliance 3406, although the switching element in the SIU 3404 is sized to support the traffic for up to four connected BTS appliances.

The E1/T1 circuits are first passed to a time switch 3408 that is capable of performing drop-and-insert functionality. Drop-and-insert allows the SIU/BTS appliance to use a subset of the E1/T1 bandwidth in 64 Kbps increments.

This is used when one or more E1/T1 circuits need to be daisy-chained with a static partitioning of bandwidth between the units in the chain. A typical arrangement would be a daisy-chain of multiple single-box BTS appliances. At the first BTS appliance in the chain, one E1/T1 port is to the backhaul network, and a second E1/T1 port is used to connect to the next BTS appliance in the chain. The time switch selects a fraction of the E1/T1's total bandwidth (in multiples of 64 Kbps DS-0's) for local consumption, and passes the remainder of the time slots to the next device in the chain. In multi-box deployments, SIUs can be similarly daisy-chained.

The locally consumed DS-0's are passed to the Inverse Multiplexing for ATM (IMA) function of the Network Processor. The IMA function multiplexes ATM cells over multiple DS-0 channels by fragmenting each cell into several chunks that are transported in parallel over the multiple channels, and then re-combining the chunks back into cells at the far end of the backhaul link. The recombined ATM cells received from the IMA function are then passed to the ATM switching function of the network processor. The backhaul traffic is segregated onto several separate ATM Permanent Virtual Connections (PVCs). These PVCs are provisioned and configured according to the expected traffic flows. As an example of the types of PVC's, UMTS'99 defines two PVCs for the Node B Application Part (NBAP), one PVC for OMC-B traffic, and one PVC for user-plane traffic with multiple AAL2 flows within it. The ATM switching function switches each of the PVCs to the appropriate local devices over the local Utopia bus.

For a multi-box deployment with an SIU, the SIU's ATM switch switches cells on the incoming PVCs either to the SIU's control processor, or to one of the four HSSPC-II devices that connect to BTS appliances, or to the AAL2 switching function of the network processor. The PVCs that get switched to an HSSPC-II arrive at a peer HSSPC-II in the BTS appliance. Within the BTS appliance, another ATM switching function performs a second stage of ATM switching to forward cells either to the BTS appliance control processor, to the physical channel processor, or to one of the channel element DSPs. For a single-box deployment, only a single ATM switch in the BTS appliance is involved in switching PVCs.

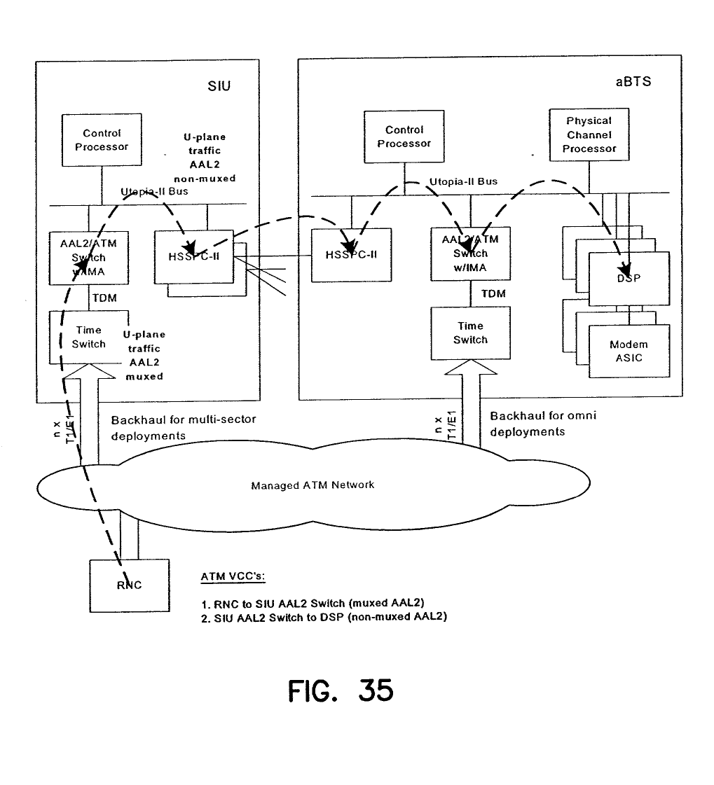

FIG. 35 shows the flow of user-plane traffic when an SIU is used. The user-plane PVC from the backhaul carries multiple AAL2 channels. Each AAL2 channel carries a flow for a single User Equipment (UE). With AAL2, chunks of traffic from each channel are multiplexed over a single ATM layer PVC in a way that minimizes the need for padding. A single chunk is allowed to extend over the boundary between contiguous ATM cells belonging to the same PVC. An AAL2 chunk is limited in length to 45 bytes or, optionally, 64 bytes. To overcome this limitation, a Signaling Segmentation and Reassembly (SSAR) function is included to segment long payloads into chunks that are 45 bytes or less.

The AAL2 switch in the SIU's network processor demultiplexes the AAL2 channels from the backhaul network onto separate local ATM PVCs, one per AAL2 channel. On the demultiplexed PVC's, only one AAL2 CPS-PDU is transported per ATM cell resulting in frequent padding of cells. Although this reduces the local bandwidth efficiency, it also reduces the amount of processing needed at the endpoints. The demultiplexed PVC's are switched by the SIU's ATM switch onto the Utopia bus to one of the four ATM links on the HSSPC-II's. These links connect to separate BTS appliances. At the BTS appliance, the ATM cells are received over the Utopia bus by the BTS appliance's ATM switch and switched onwards to the appropriate DSP for that flow.

In a single-box deployment, the user-plane traffic arrives at the BTS appliance directly over its E1/T1 links. In this case, the BTS appliance's network processor switches the backhaul PVC with user-plane traffic to the AAL2 switching function and performs AAL2 demultiplexing onto separate ATM PVC's, one per AAL2 channel. The network then switches the demultiplexed local PVC's at the ATM level to the appropriate DSP channel element. User-plane traffic in the reverse direction follows the same sequence of switching, but in reverse order.

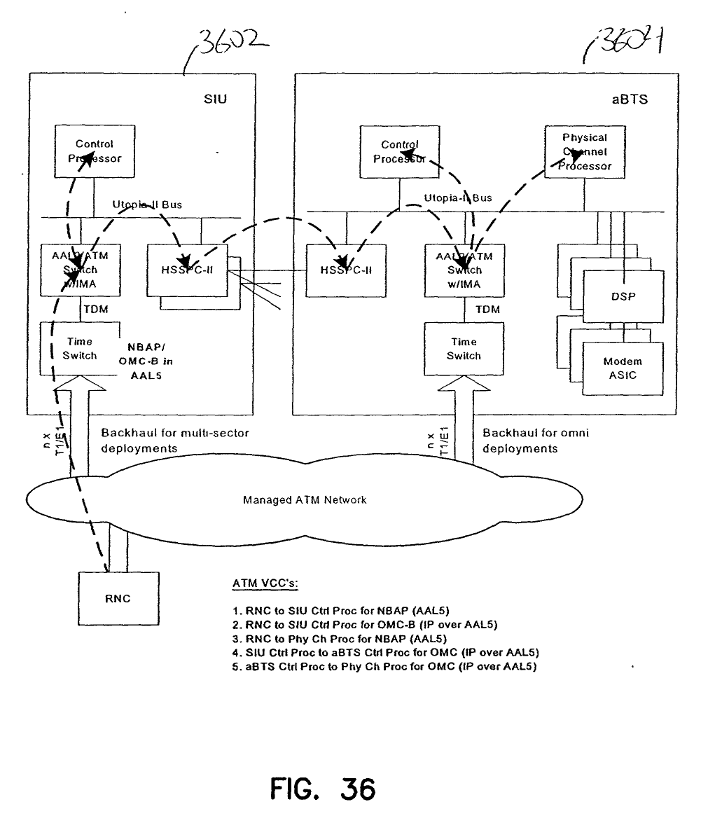

FIG. 36 shows the flows of NBAP and OMC-B flows with an SIU 3602 and multiple BTS appliances 3604. The flows are all switched at the ATM layer only. AAL5 is used as the SAR and is implemented at the destination processor, either the control processor or the physical channel processor.

ATM Protocol Stack

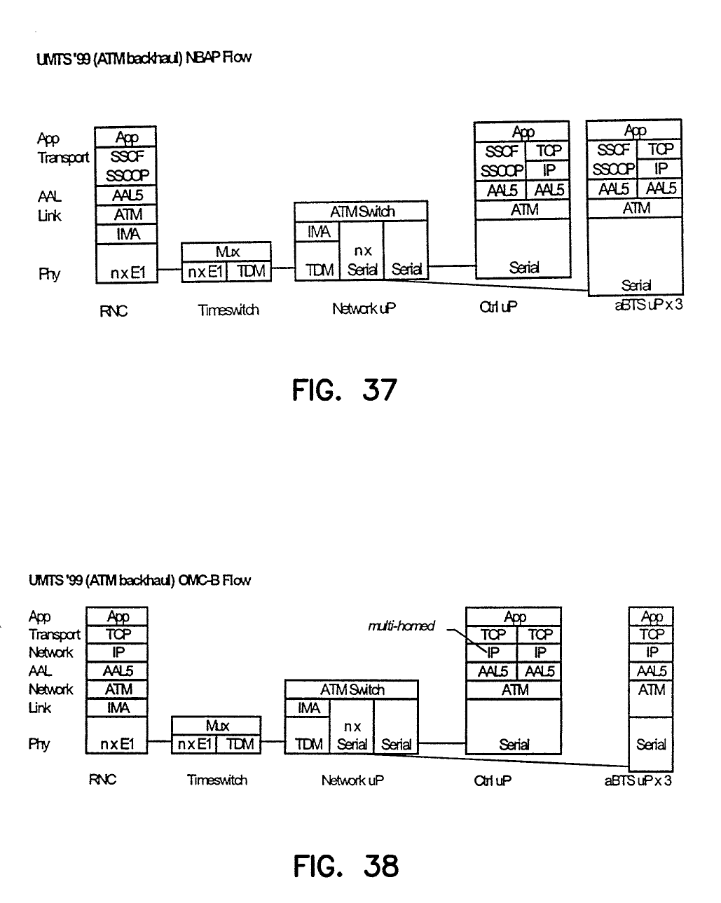

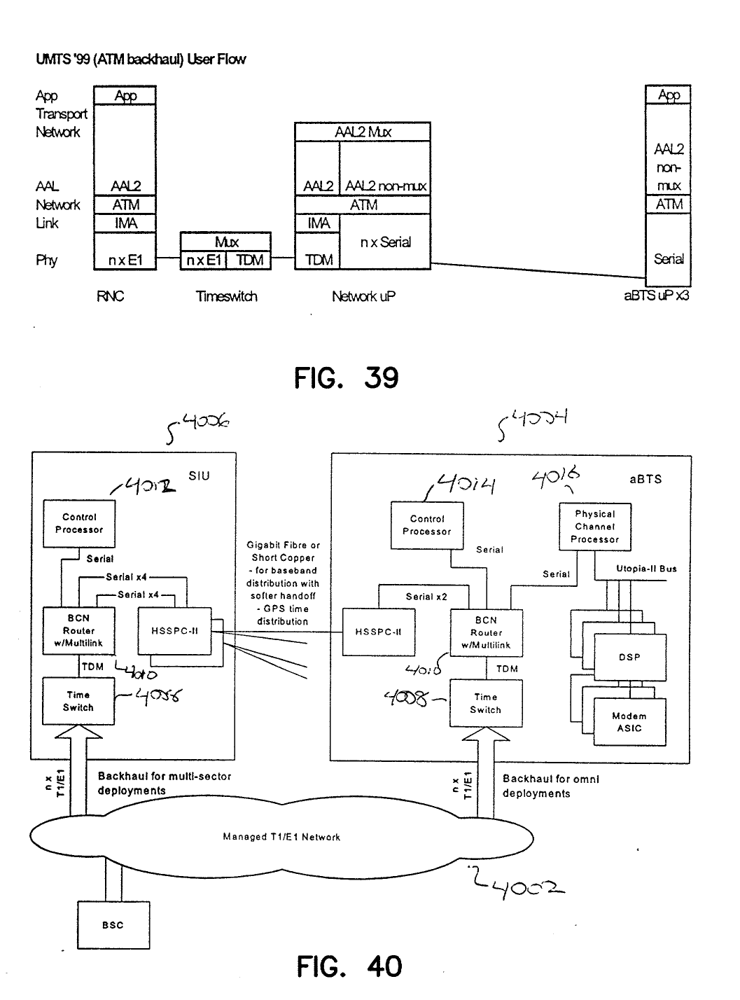

FIGS. 37, 38, and 39 illustrate protocol stacks for the ATM backhaul network. FIG. 37 depicts the NBAP protocol stack. FIG. 38 illustrates the OMC-B protocol stack. FIG. 39 shows the user plane protocol stack. These protocol stacks are used to transport data over the backhaul and within the SIU and BTS appliance.

### BCN Routing

BCN routing is used for the legacy IS-2000 BTS. This allows BCN-based software to be re-used from the Metrocell BTS.

Routing Topology

The topology of the BCN routing elements at the cell site is shown in FIG. 40. For single-box deployments, the backhaul network 4002 is attached at the BTS appliance 4004 via one or more E1/T1 circuits. For multi-box deployments, the backhaul network is attached at the SIU 4006. A similar set of routing elements is used in the SIU 4006 and BTS appliance 4004.

The E1/T1 circuits are first passed to a time switch 4008 that is capable of performing drop and insert functionality. This is used when one or more E1/T1 circuits need to be daisy-chained with a static partitioning of bandwidth between the units in the chain. A typical arrangement would be a daisy-chain of multiple single-box BTS appliances. At the first BTS appliance in the chain, one E1/T1 port is connected to the backhaul network, and a second E1/T1 port is used to connect to the next BTS appliance in the chain. The time switch 4008 selects a fraction of the E1/T1's total bandwidth (in multiples of 64 Kbps DS-0's) for local consumption, and passes the remainder of the time slots to the next device in the chain. In multi-box deployments, SIUs can be similarly daisy-chained.

The locally consumed DS-0's are passed to the BCN routing function 4010 of the network processor. If multiple blocks of DS-0's are taken from two or more circuits, the BCN router 4010 spreads the individual BCN flows over the set of blocks. This reduces the delay over the backhaul and reduces the number of flows that are disrupted if one of the T1/E1 circuits fails.

The BCN routing function 4010 makes a routing decision based on the destination address contained in each BCN frame. The SIU's BCN router 4010 can route frames onto the SIU control processor 4012 or one of the four HSSPC-II serial links.

Frames that are forwarded over the HSSPC-II serial links travel to the BTS appliance's BCN router 4010 in the network processor. The BTS appliance's network processor then makes another routing decision based on the destination BCN address in each frame. It can route frames onto the HSSPC-II serial link, the BTS appliance control processor 4014, or the physical channel processor 4016.

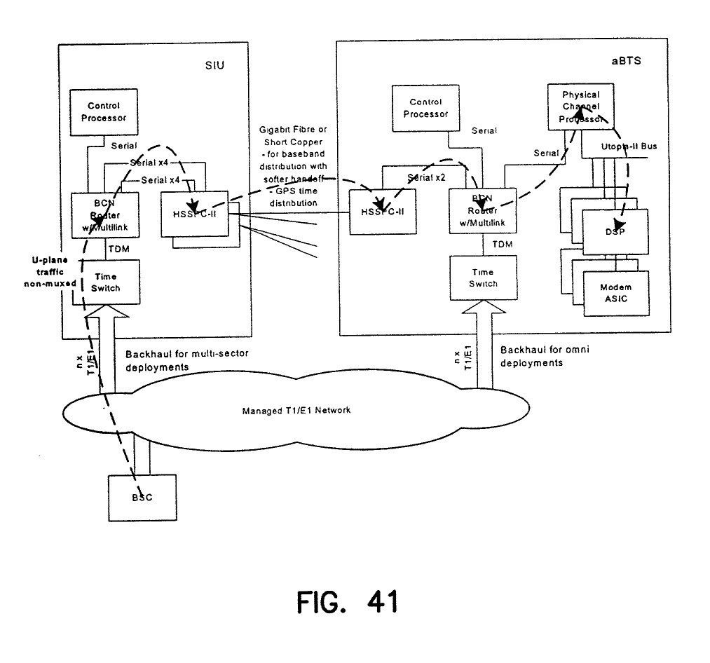

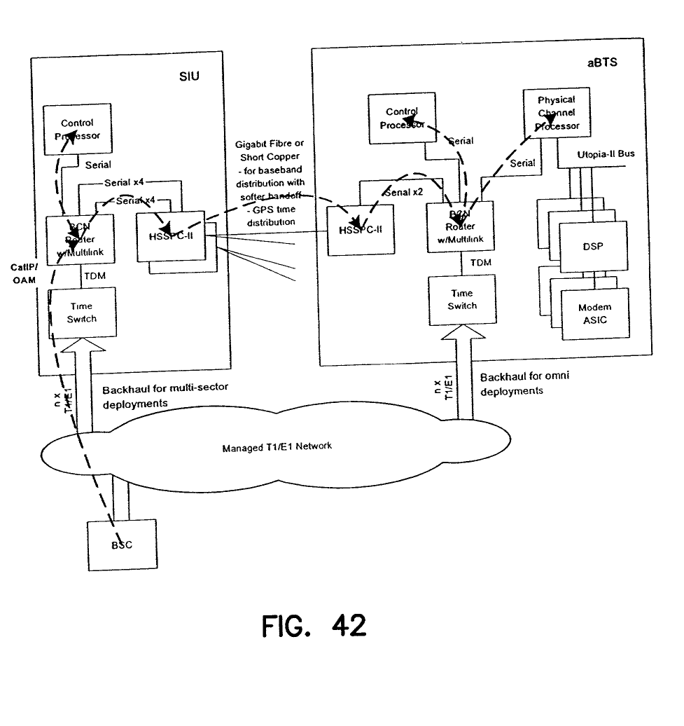

FIG. 41 shows the flow of user plane BCN frames. FIG. 42 shows the flow of OA&M and Control BCN frames.

### IP Routing

Routing Topology

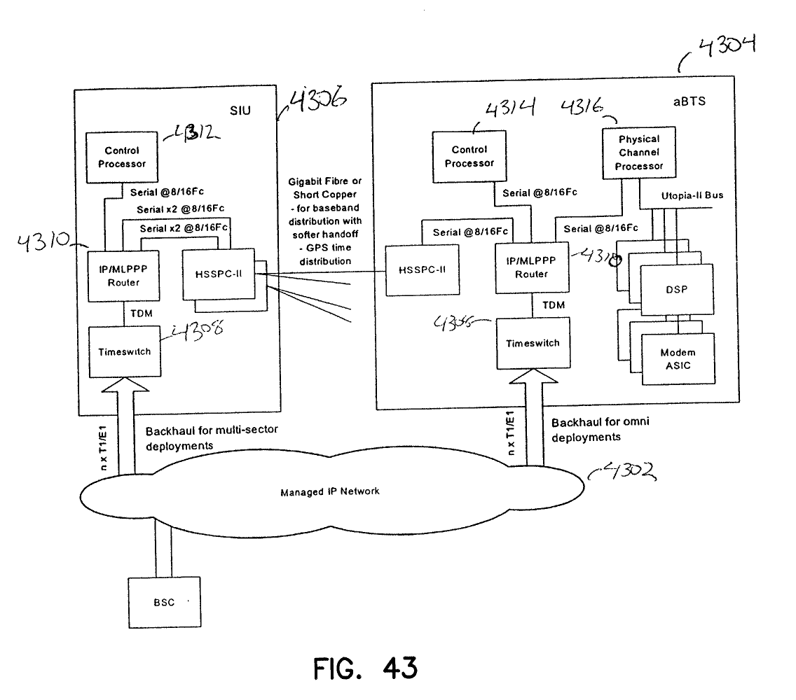

FIG. 43 depicts the topology of IP routing elements at the cell site. For single-box deployments, the backhaul network 4302 is attached at the BTS appliance 4304 via one or more E1/T1 circuits. For multi-box deployments, the backhaul network is attached at the SIU 4306. A similar set of routing elements is used in the SIU 4306 and BTS appliance 4304.

The E1/T1 circuits are first passed to a time switch 4308 that is capable of performing drop and insert functionality. This is used when one or more E1/T1 circuits need to be daisy-chained with a static partitioning of bandwidth between the units in the chain. A typical arrangement would be a daisy-chain of multiple single-box BTS appliances. At the first BTS appliance in the chain, one E1/T1 port is connected to the backhaul network, and a second E1/T1 port is used to connect to the next BTS appliance in the chain. The time switch 4308 selects a fraction of the E1/T1's total bandwidth (in multiples of 64 Kbps DS-0's) for local consumption, and passes the remainder of the time slots to the next device in the chain. In multi-box deployments, SIUs can be similarly daisy-chained.

The locally consumed DS-O's are passed to the IP/MLPPP routing function 4310 of the network processor. If multiple blocks of DS-O's are taken from two or more circuits, the IP/MLPPP router 4310 spreads the individual IP flows over the set of blocks. This reduces the delay over the backhaul and reduces the number of flows that are disrupted if one of the T1/E1 circuits fails.

The IP/MLPPP routing function 4310 makes a routing decision based on the destination address contained in each IP frame. The SIU's IP/MLPPP router 4310 can route frames onto the SIU control processor 4312 or one of the four HSSPC-II serial links.

Frames that are forwarded over the HSSPC-II serial links travel to the BTS appliance's IP/MLPPP router 4310 in the network processor. The BTS appliance's network processor then makes another routing decision based on the destination IP address in each frame. It can route frames onto the HSSPC-II serial link, the BTS appliance control processor 4314, or the physical channel processor 4316.

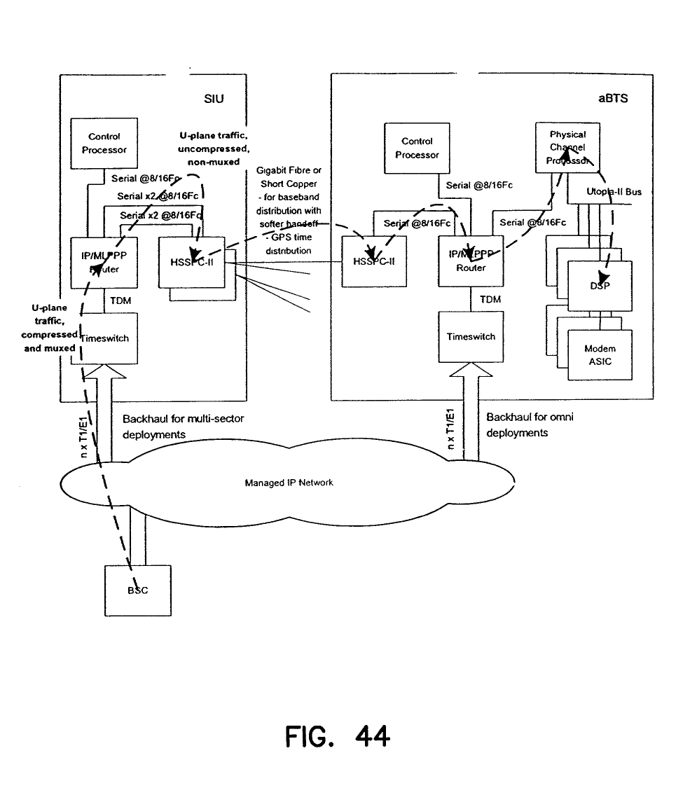

FIG. 44 shows the flow of user plane IP frames. FIG. 45 shows the flow of OA&M and Control IP frames.

IP Protocol Stack

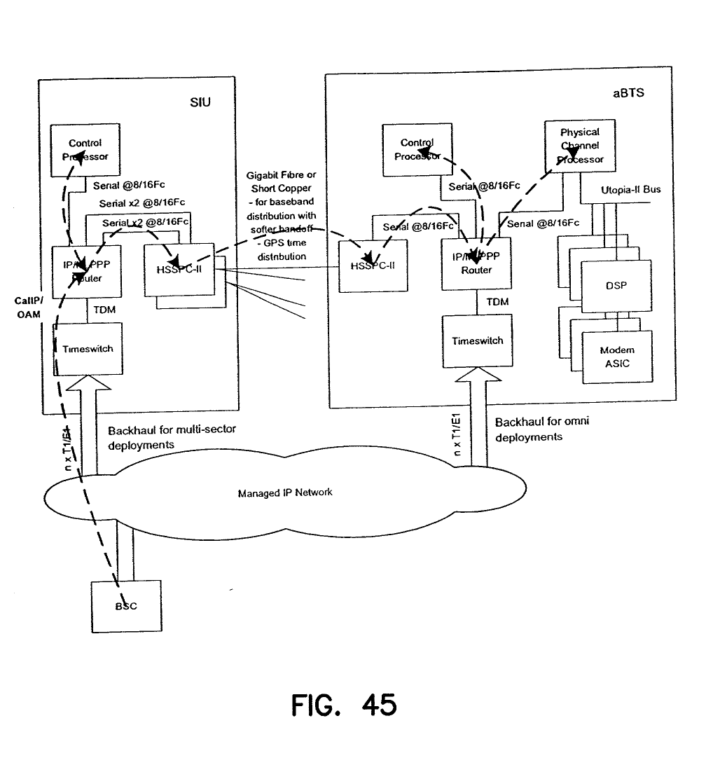

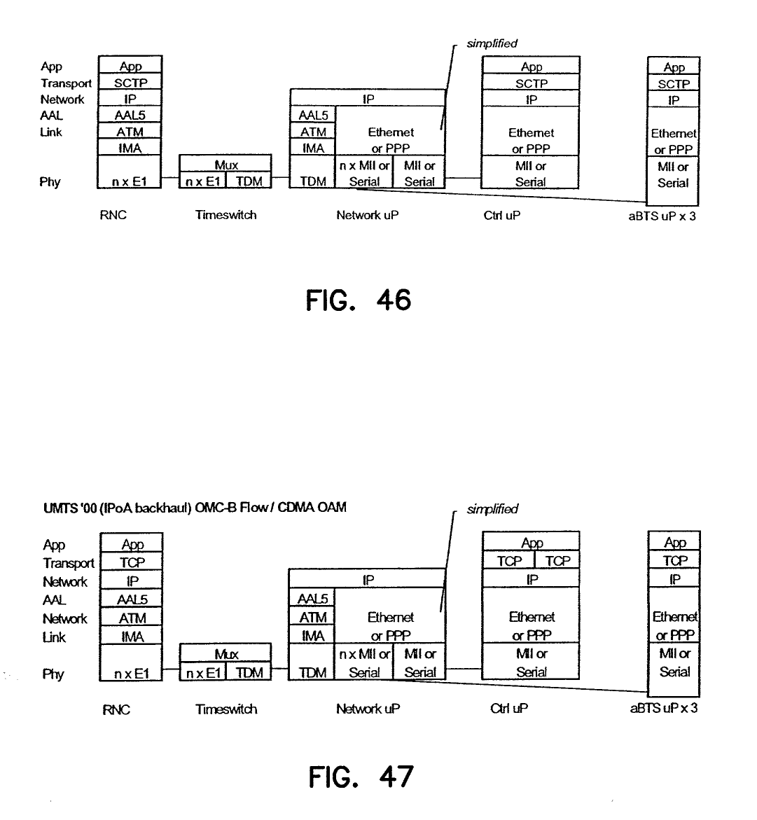

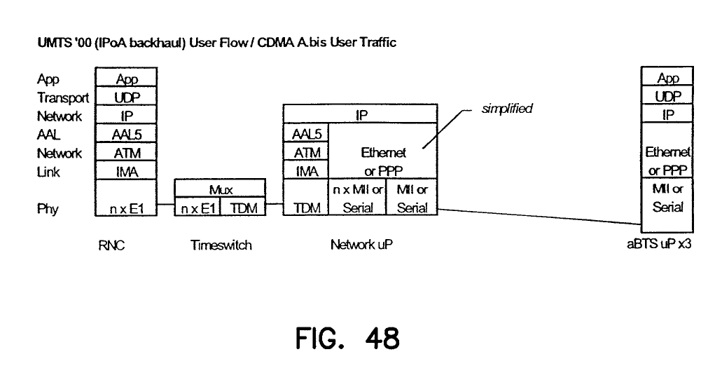

FIGS. 46, 47, and 48 illustrate protocol stacks for the IP backhaul network. FIG. 46 depicts the IP protocol stack for call processing traffic. FIG. 47 illustrates the IP protocol stack for OA&M traffic. FIG. 48 shows the user plane IP protocol stack. These protocol stacks are used to transport data over the backhaul and within the SIU and BTS appliance.

### Ethernet Switching

Routing Topology

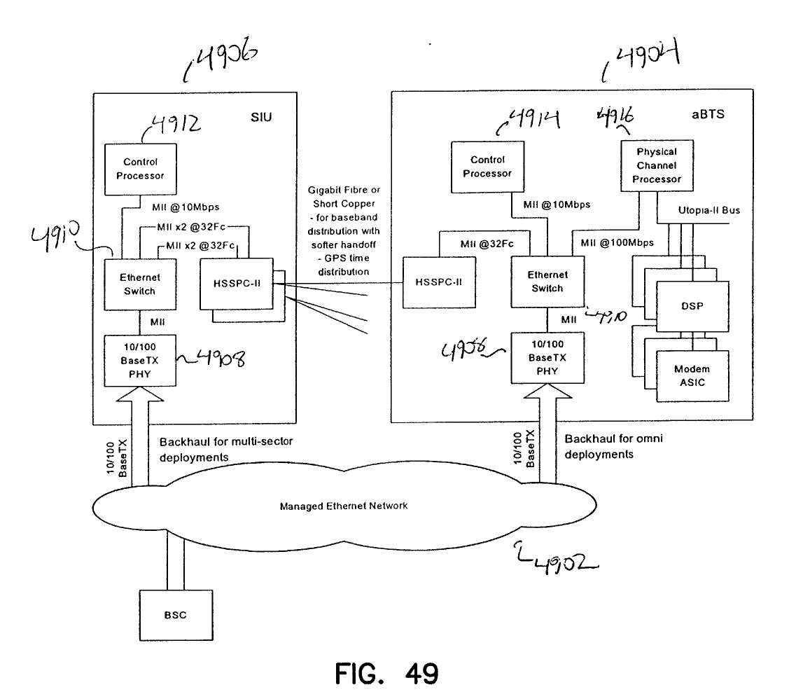

FIG. 49 depicts the topology of Ethernet routing elements at the cell site. For single-box deployments, the backhaul network 4902 is attached at the BTS appliance 4904 via a 10/100BaseTX circuit. For multi-box deployments, the backhaul network is attached at the SIU 4906. A similar set of routing elements is used in the SIU 4906 and BTS appliance 4904.

The 10/100BaseTX circuit is first passed to a 10/100BaseTX PHY 4908 that is capable of performing drop and insert functionality. This is used when one or more 10/100BaseTX circuits need to be daisy-chained with a static partitioning of bandwidth between the units in the chain. A typical arrangement would be a daisy-chain of multiple single-box BTS appliances. At the first BTS appliance in the chain, one 10/100BaseTX port is connected to the backhaul network, and a second 10/100BaseTX port is used to connect to the next BTS appliance in the chain. The 10/100BaseTX PHY 4308 selects a fraction of the total bandwidth (in multiples of 64 Kbps DS-O's) for local consumption, and passes the remainder of the time slots to the next device in the chain. In multi-box deployments, SIUs can be similarly daisy-chained.

The locally consumed DS-0's are passed to an Ethernet switch 4910 of the network processor. If multiple blocks of DS-0's are taken from two or more circuits, the Ethernet switch 4910 spreads the individual flows over the set of blocks. This reduces the delay over the backhaul and reduces the number of flows that are disrupted if one of the 10/100BaseTX circuits fails.

The Ethernet switch 4910 makes a routing decision based on the destination address contained in each frame. The SIU's Ethernet switch 4910 can route frames onto the SIU control processor 4912 or one of the four HSSPC-II serial links.

Frames that are forwarded over the HSSPC-II serial links travel to the BTS appliance's Ethernet switch 4910 in the network processor. The BTS appliance's network processor then makes another routing decision based on the destination address in each frame. It can route frames onto the HSSPC-II serial link, the BTS appliance control processor 4914, or the physical channel processor 4916.

Ethernet Protocol Stack

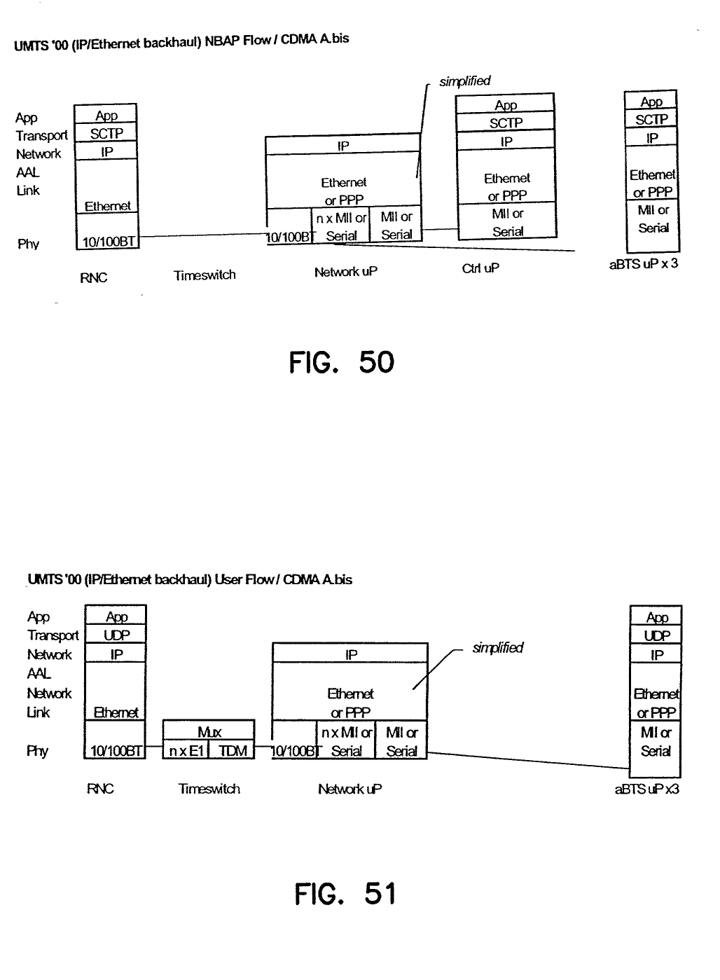

FIGS. 50 and 51 illustrate protocol stacks for the Ethernet backhaul network. FIG. 50 depicts the Ethernet protocol stack for OA&M and call processing traffic. FIG. 51 illustrates the Ethernet protocol stack for user plane traffic. These protocol stacks are used to transport data over the backhaul and within the SIU and BTS appliance.

### Operation Modes

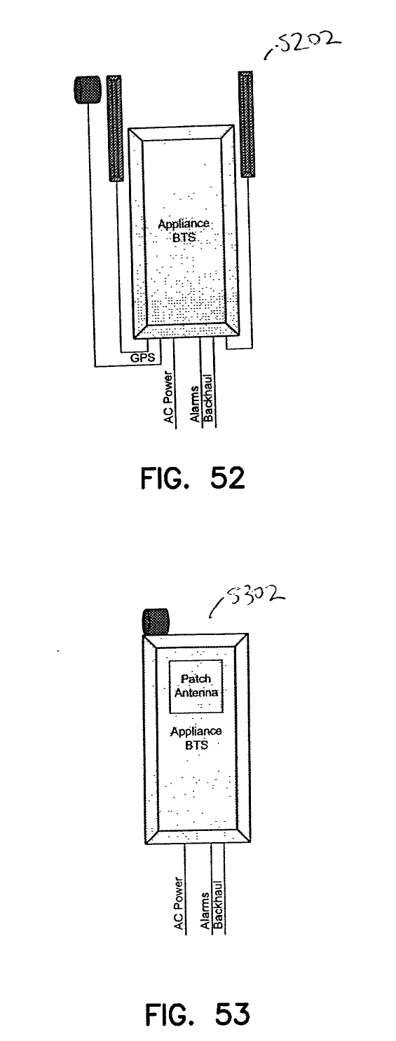

Advantageously, the BTS appliance architecture supports a variety of configurations. FIGS. 52-72 illustrate a number of such configurations. The intent of this section is to provide a general overview of how BTS appliances can be used and what interfaces are required for each configuration. Not all configurations are illustrated or described, but the ones that are illustrated and described should give one of average skill in the art an appreciation of the variety of configurations that are possible, thereby demonstrating the flexibility of the BTS appliance architecture of the present invention.

FIG. 52 depicts a standalone BTS appliance 5202, as in FIG. 1, arranged in a UMTS one-sector, one-carrier configuration.

FIG. 53 illustrates a standalone BTS appliance 5302, as in FIG. 2, arranged in a UMTS one-sector, one-carrier configuration. The BTS appliance 5302 uses a patch antenna.

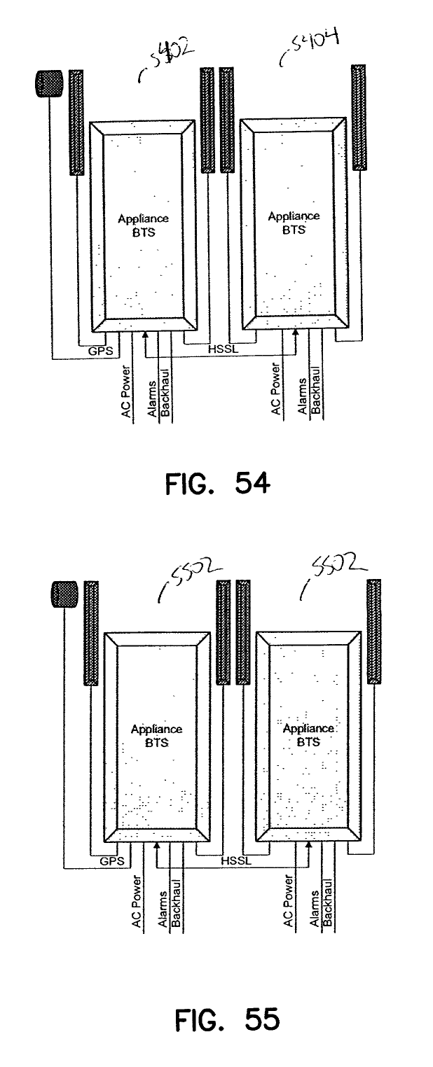

FIG. 54 shows two BTS appliances 5402, each as in FIG. 1, arranged in a UMTS two-sector, one-carrier configuration. The BTS appliances 5402 are connected to each other through an HSSL connection.

FIG. 55 shows two BTS appliances 5502, each as in FIG. 1, arranged in a UMTS one-sector, two-carrier configuration. The BTS appliances 5502 are connected to each other through an HSSL connection.

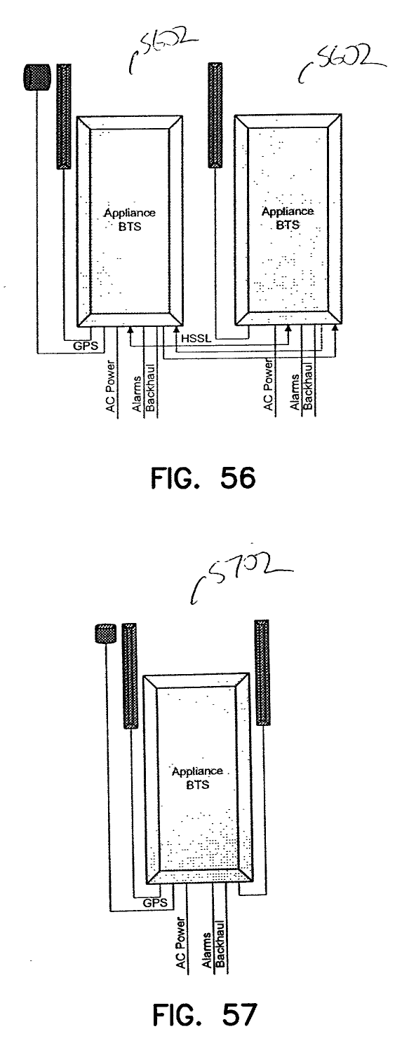

FIG. 56 depicts two BTS appliances 5602, each as in FIG. 1, arranged in a UMTS one-sector, two-carrier configuration without Tx diversity. The BTS appliances 5602 are connected to each other through an HSSL connection.

FIG. 57 illustrates a standalone BTS appliance 5702, as in FIG. 1, arranged in a CDMA one-sector, three-carrier configuration.

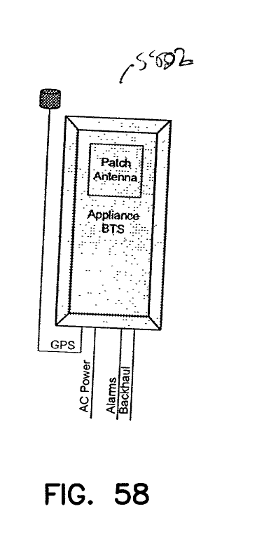

FIG. 58 illustrates a standalone BTS appliance 5802, as in FIG. 2, arranged in a CDMA one-sector, three-carrier configuration. The BTS appliance 5802 uses a patch antenna.

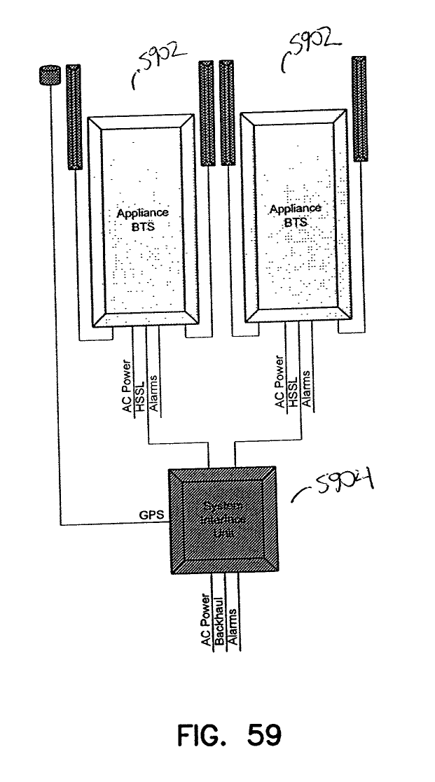

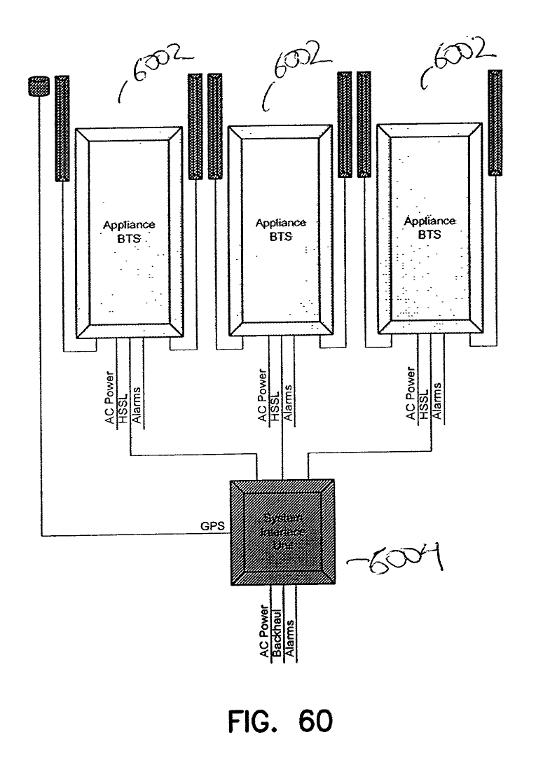

FIG. 59 shows two BTS appliances 5902, as in FIG. 1, and an SIU 5904 arranged in a CDMA two-sector, three-carrier configuration. In FIG. 59, the BTS appliances 5902 are connected to the SIU 5904 through an HSSL connection.

FIG. 60 shows three BTS appliances 6002, as in FIG. 1, and an SIU 6004 arranged in a CDMA three-sector, three-carrier configuration. In FIG. 60, the BTS appliances 6002 are connected to the SIU 6004 through an HSSL connection.

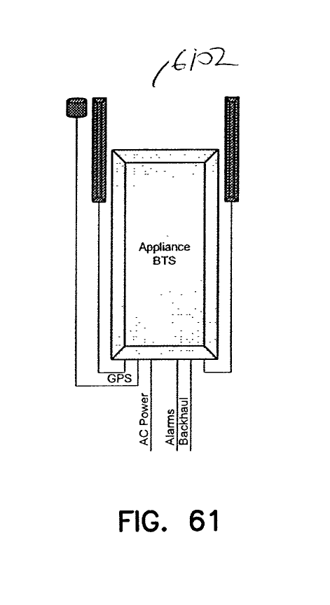

FIG. 61 shows a standalone BTS appliance 6102, as in FIG. 1, arranged in a CDMA one-sector, three-carrier configuration.

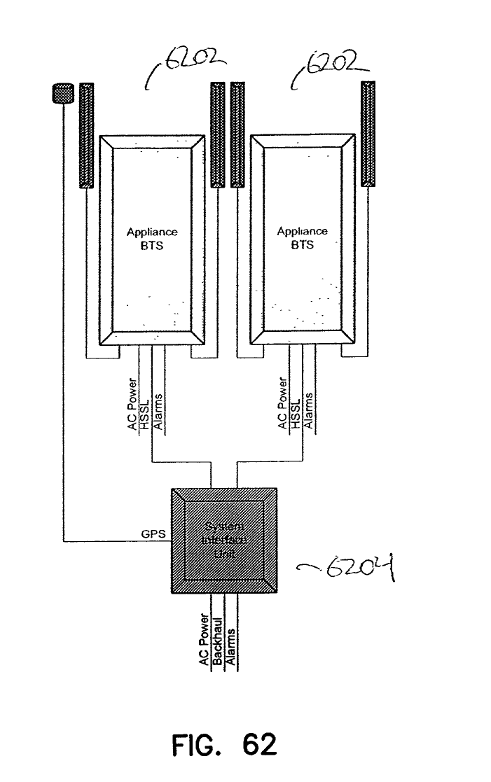

FIG. 62 depicts two BTS appliances 6202, as in FIG. 1, and an SIU 6204 arranged in a CDMA one-sector, six-carrier configuration. The BTS appliances 6202 are connected to the SIU 6204 through an HSSL connection.

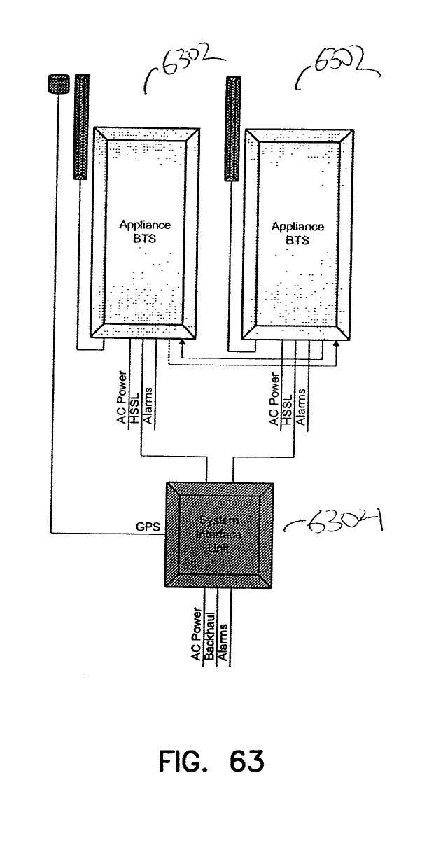

FIG. 63 illustrates two BTS appliances 6302, as in FIG. 1, and an SIU 6304 arranged in a CDMA one-sector, six-carrier configuration without Tx diversity. The BTS appliances 6302 are connected to each other. They are also connected to the SIU 6304 through an HSSL connection.

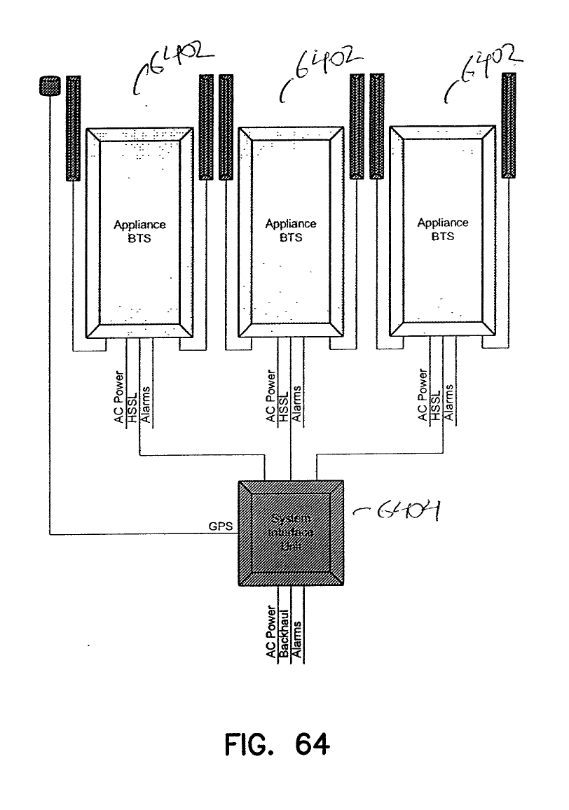

FIG. 64 shows three BTS appliances 6402, as in FIG. 1, and an SIU 6404 arranged in a CDMA one-sector, nine-carrier configuration. The BTS appliances 6402 are connected to the SIU 6404 through an HSSL connection.

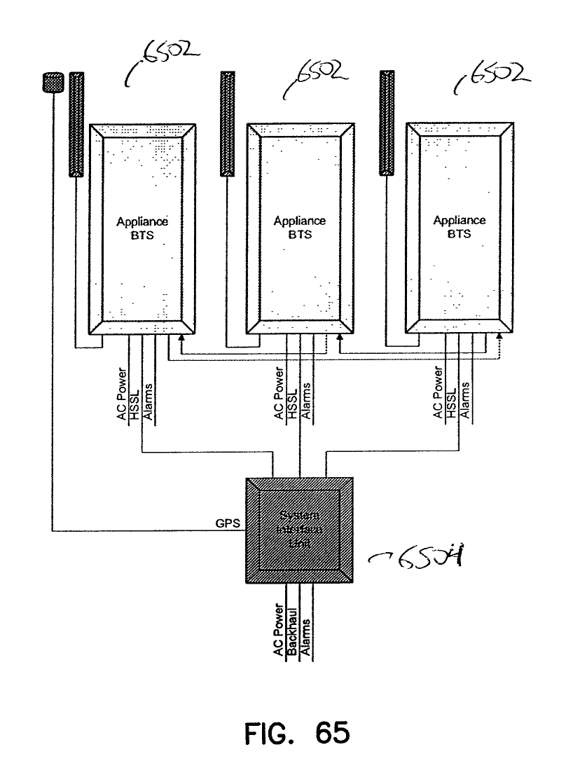

FIG. 65 depicts three BTS appliances 6502, as in FIG. 1, and an SIU 6504 arranged in a CDMA one-sector, nine-carrier configuration without Tx diversity. The BTS appliances 6502 are connected to each other. They are also connected to the SIU 6504 through an HSSL connection.

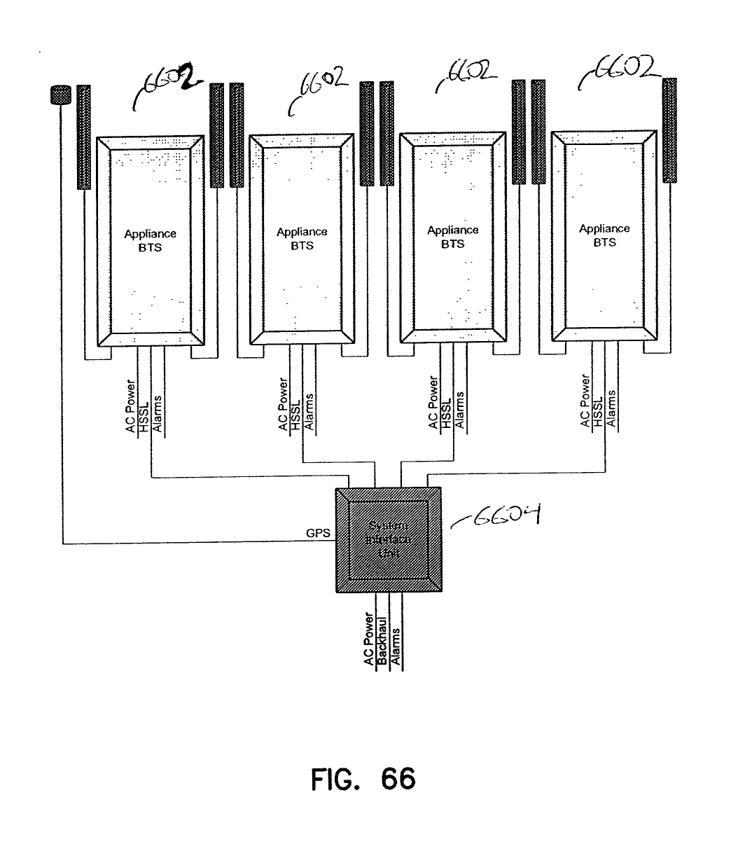

FIG. 66 illustrates four BTS appliances 6602, as in FIG. 1, and an SIU 6604 arranged in a CDMA one-sector, twelve-carrier configuration. The BTS appliances 6602 are connected to the SIU 6604 through an HSSL connection.

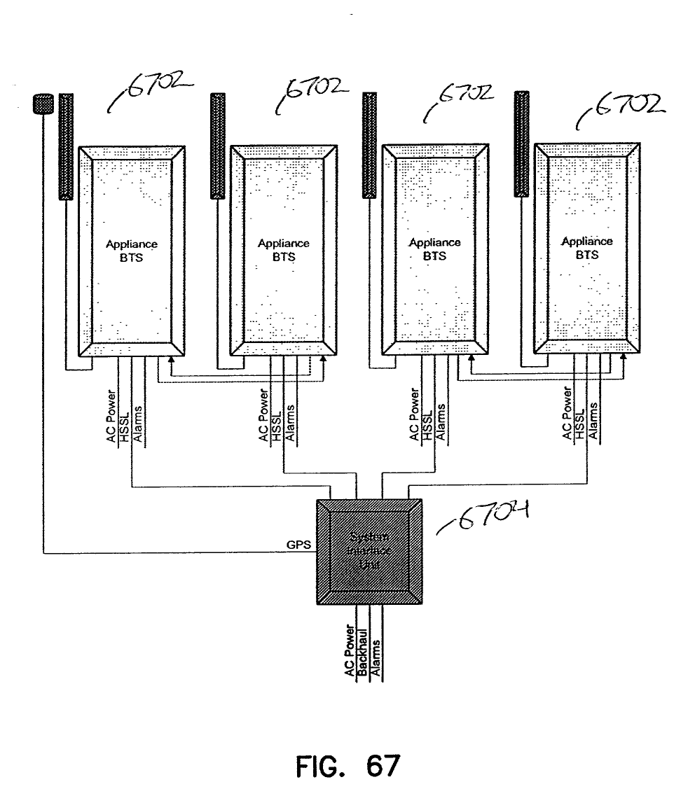

FIG. 67 illustrates four BTS appliances 6702, as in FIG. 1, and an SIU 6704 arranged in a CDMA one-sector, twelve-carrier configuration without Tx diversity. The BTS appliances 6702 are connected pairwise to each other, and are also connected to the SIU 6704 through an HSSL connection.

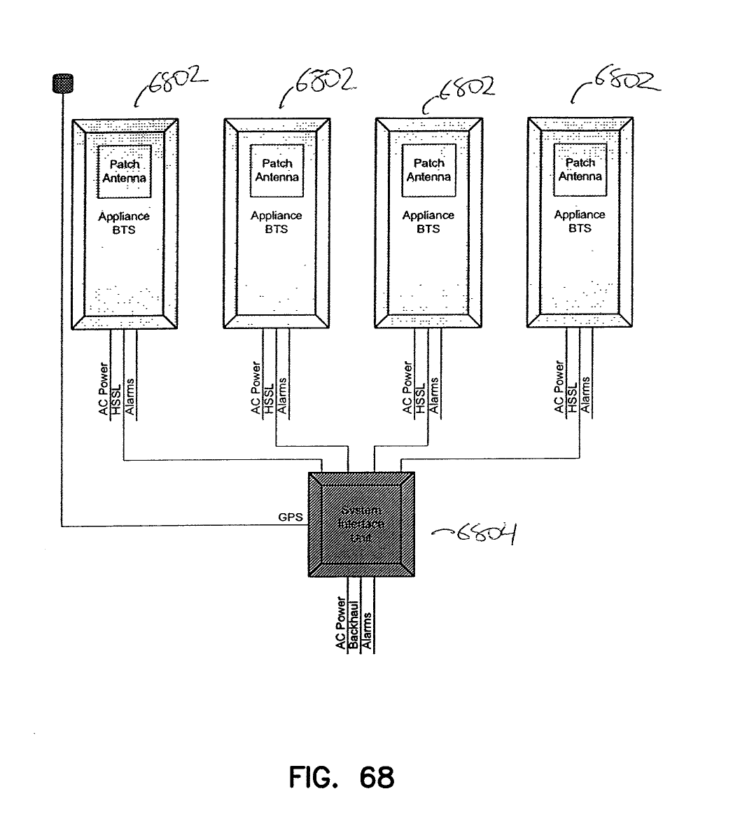

FIG. 68 shows four BTS appliances 6802, as in FIG. 2, and an SIU 6804 arranged in a CDMA one-sector, twelve-carrier configuration. The BTS appliances 6802 use patch antennas and are connected to the SIU 6804 through an HSSL connection.

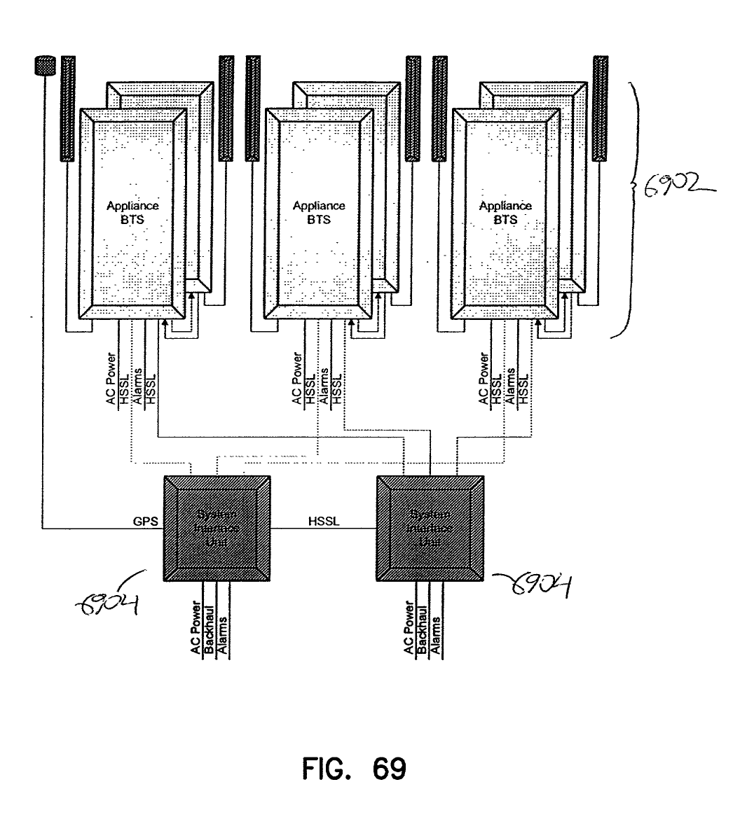

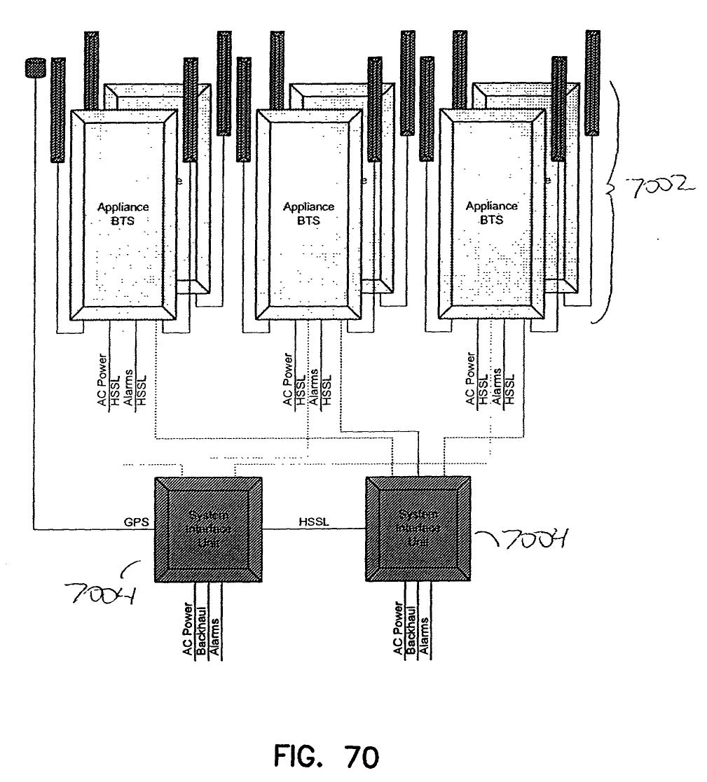

FIG. 69 shows six BTS appliances 6902, as in FIG. 1, and two SIUs 6904 arranged in a CDMA three-sector, six-carrier configuration without Tx diversity. The BTS appliances 6902 are connected to each other, and are also connected to the SIUs 6904 through an HSSL connection.

FIG. 70 shows six BTS appliances 7002, as in FIG. 1, and two SIUs 7004 arranged in a CDMA three-sector, six-carrier configuration. The BTS appliances 7002 are connected to the SIUs 7004 through an HSSL connection.

As mentioned above, the configurations depicted in and described in connection with FIGS. 52-70 are intended as merely illustrative and should not be construed as an exhaustive list of configurations. It will be readily appreciated by those skilled in the art that other configurations can be implemented consistent with the scope of the present invention.

### Conclusion

In this detailed description of various embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

What is claimed is:

1. A wireless communication system, comprising:
a plurality of base station transceiver modules communicatively coupled to one another via a high speed serial link (HSSL), each base station transceiver module configurable to operate as a standalone single-sector base station transceiver; and
a backhaul interface module in communication with the base station transceiver modules and configured to distribute received data to the plurality of base station transceiver modules.

2. The wireless communication system of claim 1, wherein the HSSL comprises controlled impedance media.

3. The wireless communication system of claim 1, wherein the HSSL comprises an optical interface.

4. The wireless communication system of claim 1, wherein the backhaul interface module comprises a T1/E1 interface.

5. The wireless communication system of claim 1, wherein the backhaul interface module comprises a 10/100BaseTX interface.

6. The wireless communication system of claim 1, wherein the backhaul interface module is incorporated in the base station transceiver modules.

7. The wireless communication system of claim 1, further comprising a system interface unit (SIU) operatively coupled to at least one base station transceiver module via the HSSL.

8. The wireless communication system of claim 1, wherein the base station transceiver modules are arranged in a UMTS two-sector, one-carrier configuration.

9. The wireless communication system of claim 1, wherein the base station transceiver modules are arranged in a UMTS one-sector, two-carrier configuration.

10. The wireless communication system of claim 1, wherein the base station transceiver modules are arranged in a UMTS one-sector, two-carrier configuration without Tx diversity.

11. The wireless communication system of claim 1, wherein the base station transceiver modules are arranged in a CDMA two-sector, three-carrier configuration, and wherein the base station transceiver modules are operatively coupled to a system interface unit (SIU).

12. The wireless communication system of claim 1, wherein the base station transceiver modules are arranged in a CDMA three-sector, three-carrier configuration, and wherein the base station transceiver modules are operatively coupled to a system interface unit (SIU).

13. The wireless communication system of claim 1, wherein the base station transceiver modules are arranged in a CDMA one-sector, six-carrier configuration, and wherein the base station transceiver modules are operatively coupled to a system interface unit (SIU).

14. The wireless communication system of claim 1, wherein the base station transceiver modules are arranged in a CDMA one-sector, six-carrier configuration without Tx diversity, and wherein the base station transceiver modules are operatively coupled to a system interface unit (SIU).

15. The wireless communication system of claim 1, wherein the base station transceiver modules are arranged in a CDMA one-sector, nine-carrier configuration, and wherein the base station transceiver modules are operatively coupled to a system interface unit (SIU).

16. The wireless communication system of claim 1, wherein the base station transceiver modules are arranged in a CDMA one-sector, nine-carrier configuration without Tx diversity, and wherein the base station transceiver modules are operatively coupled to a system interface unit (SIU).

17. The wireless communication system of claim 1, wherein the base station transceiver modules are arranged in a CDMA one-sector, twelve-carrier configuration, and wherein the base station transceiver modules are operatively coupled to a system interface unit (SIU).

18. The wireless communication system of claim 1, wherein the base station transceiver modules are arranged in a CDMA one-sector, twelve-carrier configuration without Tx diversity, and wherein the base station transceiver modules are operatively coupled to a system interface unit (SIU).

19. The wireless communication system of claim 1, wherein the base station transceiver modules are arranged in a CDMA three-sector, six-carrier configuration, and wherein the base station transceiver modules are operatively coupled to a system interface unit (SIU).

20. The wireless communication system of claim 1, wherein the base station transceiver modules are arranged in a CDMA three-sector, six-carrier configuration without Tx diversity, and wherein the base station transceiver modules are operatively coupled to a system interface unit (SIU).

21. A base station transceiver module, comprising:
a digital module, configured to interface with a network;
an analog module, operatively coupled to the digital module and configured to perform RF signal processing;
a duplex arrangement;
a power amplifier arrangement; and
a power supply arrangement, operatively coupled to the power amplifier.

22. The base station transceiver module of claim 21, further comprising a GPS module configured to generate at least one reference signal.

23. The base station transceiver module of claim 21, wherein the digital module is compatible with the UMTS, 1xRTT, and 1xEV standards.

24. The base station transceiver module of claim 21, wherein the analog module is compatible with the UMTS, 1xRTT, and 1xEV standards.

25. The base station transceiver module of claim 21, wherein the digital and analog modules are integrated in a single module.

26. The base station transceiver module of claim 21, wherein the power amplifier arrangement is configured to support a UMTS carrier.

27. The base station transceiver module of claim 21, wherein the power amplifier arrangement is configured to support a plurality of CDMA carriers.

28. The base station transceiver module of claim 21, wherein the power amplifier arrangement is configured to support an 1xRTT carrier.

29. The base station transceiver module of claim 21, wherein the power amplifier arrangement is configured to support a plurality of 1xEV carriers.

30. The base station transceiver module of claim 21, wherein the duplex arrangement is configured to support at least one of the UMTS, CDMA, 1xRTT, and 1xEV air interface standards.

31. The base station transceiver module of claim 21, wherein the power supply arrangement is coupled to an AC power source.

32. The base station transceiver module of claim 21, wherein the power supply arrangement is coupled to an uninterrupted power supply (UPS).

33. The base station transceiver module of claim 21, wherein the power supply arrangement is coupled to a short-term battery backup arrangement.

34. The base station transceiver module of claim 21, further comprising a GPS antenna interface.

35. The base station transceiver module of claim 21, further comprising a Smart GPS antenna interface.

36. The base station transceiver module of claim 21, further comprising a high speed serial link (HSSL).

37. The base station transceiver module of claim 36, wherein the HSSL is operatively coupled to another base station transceiver module.

38. The base station transceiver module of claim 36, wherein the HSSL is operatively coupled to a system interface unit (SIU).

39. The base station transceiver module of claim 21, further comprising a backhaul interface module.

40. The base station transceiver module of claim 39, wherein the backhaul interface module comprises a T1/E1 interface.

41. The base station transceiver module of claim 39, wherein the backhaul interface module comprises a 10/100BaseTX interface.

42. The base station transceiver module of claim 21, further comprising a cross-polarized patch antenna.

43. The base station transceiver module of claim 21, further comprising a spatial diversity antenna.

44. The base station transceiver module of claim 21, wherein the digital module comprises:
a network processor module;
a control processor module; and
a physical channel processor module.

45. The base station transceiver module of claim 44, wherein the digital module further comprises an MSM DSP-type call processing verification module.

46. The base station transceiver module of claim 21, wherein the analog module comprises a Tx application specific integrated circuit (ASIC) and an Rx ASIC.

47. The base station transceiver module of claim 21, wherein the analog module is configured to support adaptive pre-distortion.

48. The base station transceiver module of claim 21, wherein the analog module is configured to receive baseband data from the digital module.

49. The base station transceiver module of claim 21, wherein the power supply arrangement incorporates a modular PUP design.

50. The base station transceiver module of claim 21, wherein the power supply arrangement incorporates a discrete design.

51. The base station transceiver module of claim 21, wherein the base station transceiver module is arranged in a UMTS one-sector, one-carrier configuration.

52. The base station transceiver module of claim 21, wherein the base station transceiver module is arranged in a CDMA one-sector, three-carrier configuration.

53. A method for conducting wireless communications, comprising:
communicatively coupling a plurality of base station transceiver modules to one another via a high speed serial link (HSSL), each base station transceiver module configurable to operate as a standalone single-sector base station transceiver;
coupling the base station transceiver modules to a backhaul interface module; and
distributing received data to the base station transceiver modules via the backhaul interface module.

54. The method of claim 53, wherein the HSSL comprises controlled impedance media.

55. The method of claim 53, wherein the HSSL comprises an optical interface.

56. The method of claim 53, wherein the backhaul interface module comprises a T1/E1 interface.

57. The method of claim 53, wherein the backhaul interface module comprises a 10/100BaseTX interface.

58. The method of claim 53, wherein the backhaul interface module is incorporated in the base station transceiver modules.

59. The method of claim 53, further comprising operatively coupling a system interface unit (SIU) to at least one base station transceiver module via the HSSL.

60. The method of claim 53, wherein the base station transceiver modules are arranged in a UMTS two-sector, one-carrier configuration.

61. The method of claim 53, wherein the base station transceiver modules are arranged in a UMTS one-sector, two-carrier configuration.

62. The method of claim 53, wherein the base station transceiver modules are arranged in a UMTS one-sector, two-carrier configuration without Tx diversity.

63. The method of claim 53, wherein the base station transceiver modules are arranged in a CDMA two-sector, three-carrier configuration, and wherein the base station transceiver modules are operatively coupled to a system interface unit (SIU).

64. The method of claim 53, wherein the base station transceiver modules are arranged in a CDMA three-sector, three-carrier configuration, and wherein the base station transceiver modules are operatively coupled to a system interface unit (SIU).

65. The method of claim 53, wherein the base station transceiver modules are arranged in a CDMA one-sector, six-carrier configuration, and wherein the base station transceiver modules are operatively coupled to a system interface unit (SIU).

66. The method of claim 53, wherein the base station transceiver modules are arranged in a CDMA one-sector, six-carrier configuration without Tx diversity, and wherein the base station transceiver modules are operatively coupled to a system interface unit (SIU).

67. The method of claim 53, wherein the base station transceiver modules are arranged in a CDMA one-sector, nine-carrier configuration, and wherein the base station transceiver modules are operatively coupled to a system interface unit (SIU).

68. The method of claim 53, wherein the base station transceiver modules are arranged in a CDMA one-sector, nine-carrier configuration without Tx diversity, and wherein the base station transceiver modules are operatively coupled to a system interface unit (SIU).

69. The method of claim 53, wherein the base station transceiver modules are arranged in a CDMA one-sector, twelve-carrier configuration, and wherein the base station transceiver modules are operatively coupled to a system interface unit (SIU).

70. The method of claim 53, wherein the base station transceiver modules are arranged in a CDMA one-sector, twelve-carrier configuration without Tx diversity, and wherein the base station transceiver modules are operatively coupled to a system interface unit (SIU).

71. The method of claim 53, wherein the base station transceiver modules are arranged in a CDMA three-sector, six-carrier configuration, and wherein the base station transceiver modules are operatively coupled to a system interface unit (SIU).

72. The method of claim 53, wherein the base station transceiver modules are arranged in a CDMA three-sector, six-carrier configuration without Tx diversity, and wherein the base station transceiver modules are operatively coupled to a system interface unit (SIU).
